(19) United States
(12) Patent Application Publication
(10) Pub. No.: US 2025/0301500 A1
(43) Pub. Date: Sep. 25, 2025

(54) WIRELESS COMMUNICATION CONTROL DEVICE, METHOD, AND PROGRAM

(71) Applicant: Sony Group Corporation, Tokyo (JP)

(72) Inventors: Shigeru SUGAYA, Tokyo (JP); Yusuke TANAKA, Tokyo (JP); Kosuke AIO, Tokyo (JP); Ryuichi HIRATA, Tokyo (JP)

(73) Assignee: Sony Group Corporation, Tokyo (JP)

(21) Appl. No.: 18/861,601

(22) PCT Filed: Apr. 24, 2023
(86) PCT No.: PCT/JP2023/016042

§ 371 Date: Oct. 30, 2024

(30) Foreign Application Priority Data
May 11, 2022 (JP) 2022-078389

(51) Int. Cl. H04W 74/0816; H04W 74/00; H04W 74/04

(52) U.S. Cl. CPC H04W 74/0816; H04W 74/002; H04W 74/04

(57) ABSTRACT

The present technology relates to a wireless communication control device, method, and program that make it possible to more reliably perform data transmission.

The wireless communication control device performs control of receiving first information from a wireless communication device via one of a plurality of links set in advance with the wireless communication device and transmitting use reservation information indicating that a use opportunity for at least one of the plurality of links is to be secured in advance. The present technology can be applied to a wireless communication system.

### TECHNICAL FIELD

The present technology relates to a wireless communication control device, a method, and a program, and more particularly, to a wireless communication control device, a method, and a program enabled to more reliably perform data transmission.

### BACKGROUND ART

Currently, in the IEEE working group, technical discussion is being advanced toward the IEEE802.11be standard as a successor to the IEEE802.11ax standard, and the operation of Extended Multi-Link Single Radio (EMLSR) is being defined therein.

The EMLSR is a method for simplifying Multi-Link Multi Radio operation in which operation is performed independently in all links set in advance (Pre-Configure Links).

That is, in the EMLSR, an exchange of control frames is performed on a Link of Multi Radio, and operation related to actual data transmission and reception is performed on a Link of Single Radio. Note that the EMLSR is described in Patent Document 1.

By adopting the EMLSR as Release1, which is an initial version of the IEEE802.11be standard, it is recognized that there are an advantage that a circuit can be implemented on a reduced scale from an original plan, and an advantage that a product equipped with these technologies can be put on a market at an early stage.

However, in a case where the EMLSR is adopted, since there are more newly defined portions that operate with Single Radio than a Multi Radio configuration originally assumed at the beginning of IEEE802.11be standardization, there are restrictions on an access control method and transmission and reception of data.

### CITATION LIST

### Patent Document

Patent Document 1: Japanese Patent Application Laid-Open No. 2021-150786

### SUMMARY OF THE INVENTION

### Problems to be Solved by the Invention

When a communication terminal (EMLSR STA) compatible with the EMLSR once ends reception of data, it has been necessary for the EMLSR STA to wait for a control frame (Multi-STA RTS) transmitted from an access point (AP) or the like in all Pre-Configure Links. Thereafter, the EMLSR STA returns a responding control frame (CTS) with a link on which the Multi-STA RTS is received, specifies Single Radio that operates next, and transitions to the specified Single Radio.

That is, in a case where the EMLSR STA cannot detect the Multi-STA RTS in any link of the Pre-Configure Links, it has been difficult for the EMLSR STA to specify a Single Radio link that operates next.

The present technology has been made in view of such a situation, and makes it possible to more reliably perform data transmission.

### Solutions to Problems

A wireless communication control device of one aspect of the present technology includes a communication control unit that performs control of receiving first information from a wireless communication device via one of a plurality of links set in advance with the wireless communication device and transmitting use reservation information indicating that a use opportunity for at least one of the plurality of links is to be secured in advance.

A wireless communication control device of another aspect of the present technology includes a communication control unit that performs control of transmitting first information to a wireless communication device via one of a plurality of links set in advance with the wireless communication device and receiving use reservation information indicating that a use opportunity for at least one of the plurality of links is to be secured in advance.

In one aspect of the present technology, control is performed of receiving first information from a wireless communication device via one of a plurality of links set in advance with the wireless communication device and transmitting use reservation information indicating that a use opportunity for at least one of the plurality of links is to be secured in advance.

In another aspect of the present technology, control is performed of transmitting first information to a wireless communication device via one of a plurality of links set in advance with the wireless communication device and receiving use reservation information indicating that a use opportunity for at least one of the plurality of links is to be secured in advance.

### BRIEF DESCRIPTION OF DRAWINGS

FIG. 1 is a diagram illustrating a configuration example of a wireless communication system according to a first embodiment of the present technology.

FIG. 2 is a diagram illustrating an operation example for each block of a device compatible with EMLSR.

FIG. 3 is a diagram illustrating a conventional operation sequence of an AP and an EMLSR STA.

FIG. 4 is a diagram illustrating an operation sequence of the AP and the EMLSR STA in a first embodiment of the present technology.

FIG. 5 is a block diagram illustrating a configuration example of a wireless communication device.

FIG. 6 is a block diagram illustrating a configuration example of a wireless communication module in FIG. 5.

FIG. 7 is a block diagram illustrating another configuration example of the wireless communication module in FIG. 5.

FIG. 8 is a diagram illustrating a configuration example of a frame of the first embodiment of the present technology.

FIG. 9 is a diagram illustrating a first configuration example of a Single Radio Block ACK Frame.

FIG. 10 is a diagram illustrating a second configuration example of the Single Radio Block ACK Frame.

FIG. 11 is a diagram illustrating a configuration of capability information including a link identifier (Link ID) that needs to be exchanged in a case where information in Bitmap format is described.

FIG. 12 is a diagram illustrating a third configuration example of the Single Radio Block ACK Frame.

FIG. 13 is a flowchart illustrating data transmission processing in the first embodiment.

FIG. 14 is a flowchart illustrating the data transmission processing, following FIG. 13.

FIG. 15 is a flowchart illustrating data reception processing by the EMLSR STA in the first embodiment.

FIG. 16 is a flowchart illustrating the data reception processing by the EMLSR STA, following FIG. 15.

FIG. 17 is a diagram illustrating another operation sequence of a communication device (AP) on the data transmission side and the EMLSR STA in the first embodiment of the present technology.

FIG. 18 is a diagram illustrating an operation sequence of the communication device (AP) on the data transmission side and the EMLSR STA in a second embodiment of the present technology.

FIG. 19 is a diagram illustrating a configuration example of a frame of the second embodiment of the present technology.

FIG. 20 is a diagram illustrating a first configuration example of an A-MPDU frame of the second embodiment of the present technology.

FIG. 21 is a diagram illustrating a second configuration example of the A-MPDU frame of the second embodiment of the present technology.

FIG. 22 is a diagram illustrating a first configuration example of an A-Control field of any frame.

FIG. 23 is a diagram illustrating a second configuration example of the A-Control field of any frame.

FIG. 24 is a diagram illustrating a configuration example of an aggregation frame.

FIG. 25 is a flowchart illustrating data transmission processing by the communication device (AP) on the data transmission side in the second embodiment of the present technology.

FIG. 26 is a flowchart illustrating the data transmission processing by the communication device (AP) on the data transmission side, following FIG. 25.

FIG. 27 is a flowchart illustrating data reception processing by the EMLSR STA in the second embodiment of the present technology.

FIG. 28 is a flowchart illustrating the data reception processing by the EMLSR STA, following FIG. 27.

FIG. 29 is a diagram illustrating an operation sequence of the AP and the EMLSR STA in a third embodiment of the present technology.

FIG. 30 is a diagram illustrating a fourth configuration example of the Single Radio Block ACK Frame.

FIG. 31 is a flowchart illustrating data reception processing by the EMLSR STA in the third embodiment of the present technology.

FIG. 32 is a flowchart illustrating the data reception processing by the EMLSR STA, following FIG. 31.

FIG. 33 is a diagram illustrating an operation sequence of the EMLSR STA in a fourth embodiment of the present technology.

FIG. 34 is a diagram illustrating an operation sequence of the AP in the fourth embodiment of the present technology.

FIG. 35 is a diagram illustrating a configuration example of a Quick Reserve Single Radio Control Frame.

FIG. 36 is a diagram illustrating a configuration example of an Open Reserve Single Radio Control Frame.

FIG. 37 is a diagram illustrating a configuration example of a frame of the fourth embodiment of the present technology.

FIG. 38 is a diagram illustrating a fourth configuration example of the Single Radio Block ACK

FIG. 39 is a diagram illustrating a configuration example of the A-MPDU frame of the fourth embodiment of the present technology.

FIG. 40 is a flowchart illustrating data transmission processing by the communication device (AP) on the data transmission side in the fourth embodiment of the present technology.

FIG. 41 is a flowchart illustrating the data transmission processing by the communication device (AP) on the data transmission side, following FIG. 40.

FIG. 42 is a flowchart illustrating data reception processing by the EMLSR STA in the fourth embodiment of the present technology.

FIG. 43 is a flowchart illustrating the data reception processing by the EMLSR STA, following FIG. 42.

FIG. 44 is a flowchart illustrating the data reception processing by the EMLSR STA, following FIG. 42.

FIG. 45 is a block diagram illustrating a configuration example of a computer.

FIG. 46 is a block diagram illustrating a schematic configuration example of a smartphone to which the present technology is applied.

FIG. 47 is a block diagram illustrating a schematic configuration example of an in-vehicle device to which the present technology is applied.

FIG. 48 is a block diagram illustrating a schematic configuration example of a wireless AP to which the present technology is applied.

### MODE FOR CARRYING OUT THE INVENTION

Hereinafter, a mode for carrying out the present technology will be described. The description is given in the following order.
1. First Embodiment (Available Single Radio Link Information)
2. Second Embodiment (Next Single Radio Link Information)
3. Third Embodiment (Combination of First Embodiment and Second Embodiment)
4. Fourth Embodiment (Quick Reserve Single Radio Control Frame)
5. Others

### 1. First Embodiment (Available Single Radio Link Information)

### <Configuration of Wireless LAN System>

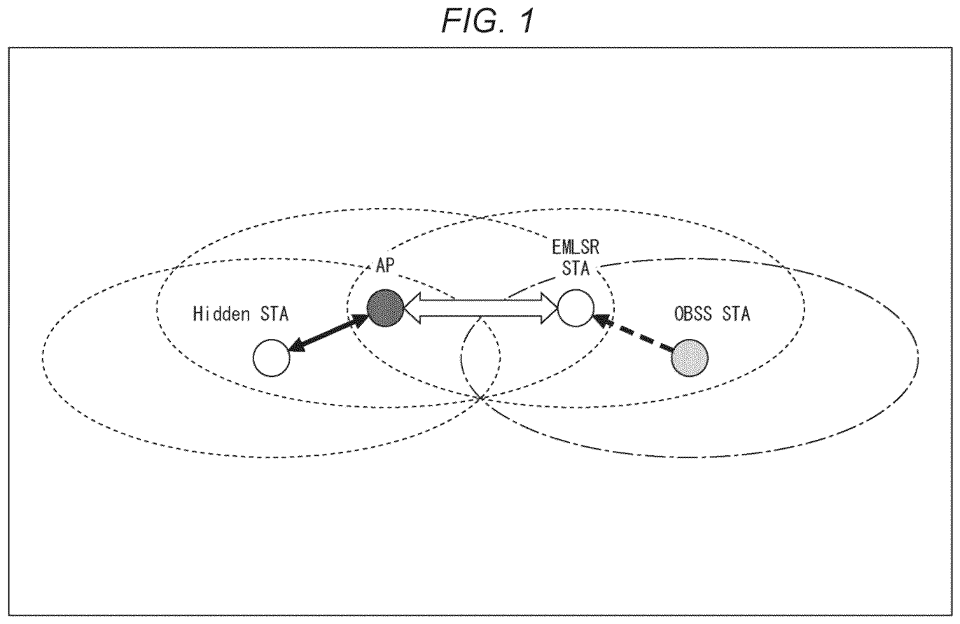

FIG. 1 is a diagram illustrating a configuration example of a wireless communication system according to a first embodiment of the present technology.

The wireless communication system in FIG. 1 includes an AP, an EMLSR STA, and a hidden terminal (Hidden STA) that form one network of wireless local area network (LAN) as a basic service set (BSS).

In FIG. 1, the AP, the EMLSR STA, and the Hidden STA are in a state of being able to communicate with a communication device present within a radio wave coverage. The radio wave coverage is indicated by a broken line ellipse centered on each of marks representing the AP, the EMLSR STA, and the Hidden STA.

The AP is a device that operates as an access point. The EMLSR STA is a device that operates as a terminal compatible with EMLSR. The AP and the EMLSR STA perform data transmission as indicated by a white arrow.

The Hidden STA is a device that operates as a terminal, and is present at a position hidden from the EMLSR STA. The Hidden STA performs data transmission with the AP as indicated by a black arrow.

Around the EMLSR STA, there is an Overlap (O) BSS STA that is an STA forming another communication network (OBSS). The OBSS STA is a device that operates as a terminal, and can communicate with a communication device (the EMLSR STA in the case of FIG. 1) present within a radio wave coverage indicated by an ellipse of a one-dot chain line.

Thus, as indicated by a dashed arrow, in a case where the EMLSR STA detects a signal from the OBSS STA, the EMLSR STA cannot correctly detect a control frame such as an RTS from the AP.

<Operation of Device Compatible with EMLSR>

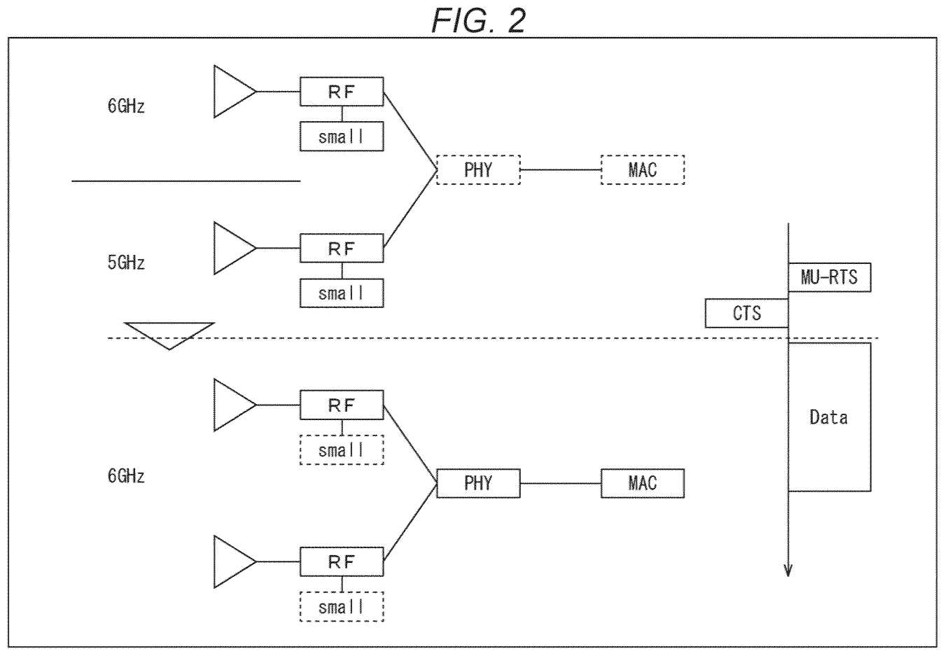

FIG. 2 is a diagram illustrating an operation example for each of blocks of a device compatible with the EMLSR.

In the upper part of FIG. 2, blocks that operate in a case where control frames are exchanged such as an MU RTS and a CTS illustrated on the right side are indicated by solid lines. Note that blocks that do not operate in FIG. 2 are indicated by broken lines.

An exchange of the control frames is performed on a plurality of pieces of Radio. In a case where operation is performed by using Multi Radio, for example, a 5 GHZ band and a 6 GHz band, a radio frequency processing unit (RF) that operates using a link (Radio) of the 5 GHz band and a block (Small) capable of processing the control frames for the RF are configured. Similarly, an RF that operates using a link (Radio) of the 6 GHz band and a Small that can process the control frames for the RF are configured. Thus, the plurality of pieces of Radio is in a state of being able to receive the control frame.

In the lower part of FIG. 2, blocks that operate in a case where a Data frame illustrated on the right side is transmitted and received are indicated by solid lines.

In the transmission and reception of the Data frame, it becomes possible to perform only the operation using Single Radio, for example, Radio of the 6 GHz band. In a case where the two RFs operate using the Radio of the 6 GHz band, the two RFs operate with the Radio of the 6 GHz band, and transmission and reception of data via the two RFs are performed by a physical layer block (PHY) and a medium control block (MAC).

Note that, in FIG. 2, a simple block configuration is illustrated to describe minimum EMLSR operation, and a block configuration of a wireless communication device according to the present technology is not limited to the simple block configuration.

### <Conventional Operation of AP and EMLSR STA>

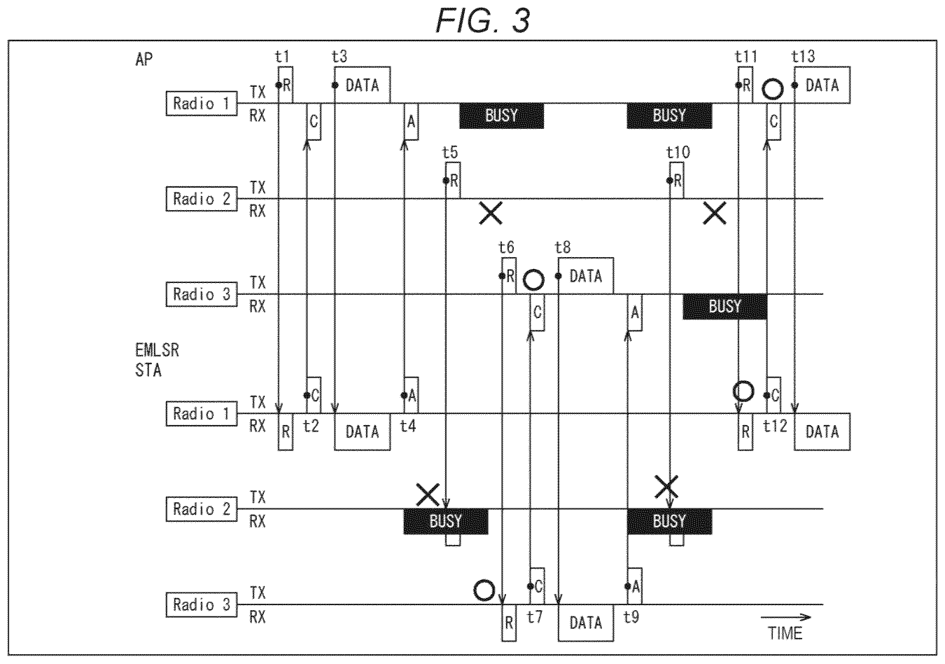

FIG. 3 is a diagram illustrating a conventional operation sequence of the AP and the EMLSR STA.

Note that the EMLSR STA performs the EMLSR operation in which the EMLSR STA operates using Multi Radio when exchanging control frames, and operates using Single Radio after exchanging the control frames.

In FIG. 3, it is assumed that the AP or a communication device (indicated as AP in the figure) that performs Multi-Link Multi-Radio operation and the EMLSR STA that performs Multi-Link Single Radio operation are in a state where predetermined data is exchanged and operation is performed using Pre-Configure Links (Radio1 to Radio3) that are links set in advance.

Furthermore, in FIG. 3, a solid arrow represents transmission of a signal, a rectangle on the horizontal axis represents a signal being transmitted (TX), and a rectangle under the horizontal axis represents a signal being received (RX).

At a timing t1, the AP transmits a Multi-User RTS frame (hereinafter, referred to as an RTS frame (R in the figure)) as a control frame, for example, by using Radio1, and notifies the EMLSR STA of a start of data transmission. The EMLSR STA receives the RTS frame.

At a timing t2, the EMLSR STA returns a CTS frame (C in the figure) to the AP in the case of responding to the RTS frame. The AP receives the CTS frame.

At a timing t3, the AP starts data (DATA in the figure) transmission. The EMLSR STA starts data reception.

After the data transmission ends, at a timing t4, the EMLSR STA transmits, as necessary, an ACK frame (A in the figure) that is a reception confirmation response frame for data. The AP receives the ACK Frame. As a result, the data transmission in Radio1 ends.

Note that since the communication device can occupy each piece of Radio only for a predetermined time, the communication device cannot use the same Radio for a period based on a predetermined backoff. Thus, in a case where the data transmission is not completed within a predetermined time or in a case where there is undelivered data, the communication device needs to continue the data transmission.

Here, in order to continue the data transmission by the AP, the AP transmits an RTS frame by using, for example, Radio2 at a timing t5. However, since a signal is transmitted to the EMLSR STA from another communication device by using Radio2, the EMLSR STA is in a BUSY state, receives signal interference, and cannot correctly receive the RTS frame.

In this case, a CTS frame responding to this RTS is not returned from the EMLSR STA to the AP. Since the CTS frame from the STA does not arrive, the AP selects another link among Pre-Configure links and retransmits the RTS frame.

In FIG. 3, at a timing t6, the AP transmits the RTS frame to the EMLSR STA by using Radio3.

In a case where the RTS frame can be correctly received by using Radio3, the EMLSR STA returns a CTS frame to the AP at a timing t7.

The AP can perform data transmission at a timing t8 by receiving the CTS frame transmitted from the STA by using Radio3. Furthermore, the EMLSR STA also performs data reception by using Radio3.

After the data transmission ends, at a timing t9, the EMLSR STA transmits an ACK Frame, as necessary. The AP receives the ACK Frame. As a result, the data transmission using Radio3 ends.

Similarly, after the data transmission using Radio3, in a case where the AP desires to perform data transmission to the EMLSR STA, the AP transmits an RTS frame to the EMLSR STA by using Radio2 that is an available link at a timing t10.

Here, since the EMLSR STA is in the BUSY state due to a signal from another communication device or the like and cannot correctly decode the RTS frame by using Radio2, the EMLSR STA cannot return a CTS frame.

Since there is no return of the CTS frame from the EMLSR STA, the AP transmits an RTS frame by using Radio1 at a timing t11 in order to use another Pre-Configure Link (Radio1).

In a case where the RTS frame can be correctly received by using Radio1, at a timing t12, the EMLSR STA returns a CTS frame to the AP.

By detecting the CTS frame from the STA by using Radio1, the AP can perform data transmission by using Radio1 at a timing t13, and the EMLSR STA can also perform data reception by using Radio1.

As described above, if the EMLSR STA cannot detect an RTS frame by using a Pre-Configure Link, it is difficult for the EMLSR STA to specify a Single Radio link that operates next.

Furthermore, if there is no response of a CTS frame in a certain Pre-Configure Link, it is difficult to use a channel thereof, and thus the AP needs to transmit the RTS frame again by using another Pre-Configure Link. For this reason, an access control delay occurs for transmitting the RTS frame again, and it takes time to perform data transmission.

### <Operation of AP and EMLSR STA in First Embodiment of Present Technology>

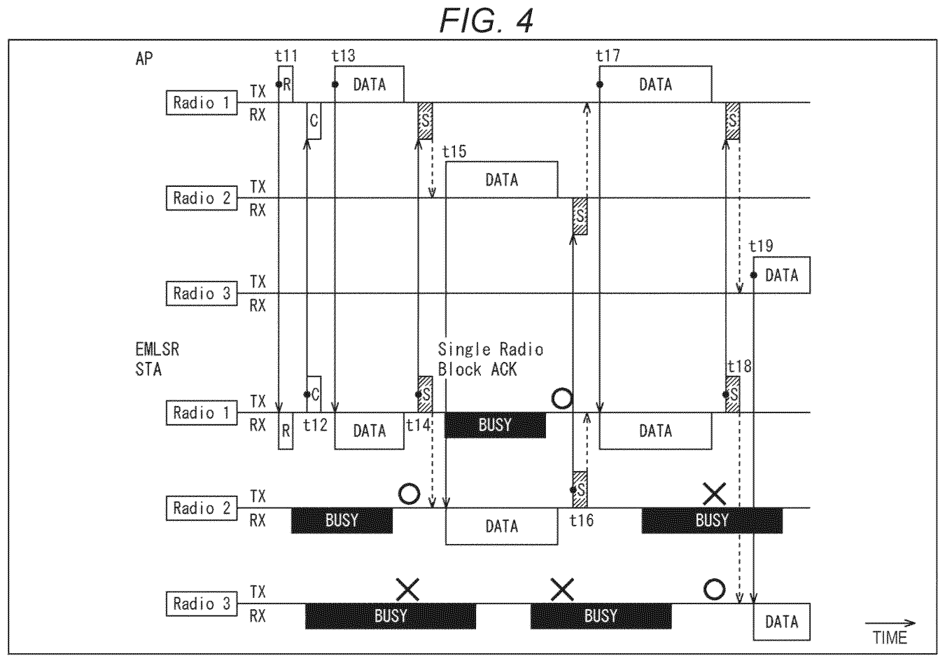

FIG. 4 is a diagram illustrating an operation sequence of the AP or a communication device on a data transmission side (indicated as AP in the figure) and the EMLSR STA in the first embodiment of the present technology.

At timings t11 to t13 in FIG. 4, the same processing is performed as that at the timings t1 to t3 in FIG. 3, and thus the description thereof will be omitted.

Note that, in FIG. 4, a solid arrow represents transmission of a signal, and a dashed arrow represents transmission of a control signal between links.

In the case of FIG. 4, after the data transmission from the timing t13 ends, at a timing t14, the EMLSR STA detects a usage status of the Pre-Configure Links, generates information regarding an available link (Available Single Radio Link information) among the Pre-Configure Links, includes the information in an ACK Frame (S in the figure), and transmits the frame to the AP. An ACK frame including Available Single Radio Link information is hereinafter referred to as a Single Radio Block ACK Frame.

Specifically, at a timing when the data transmission using Radio1 ends, the EMLSR STA refrains from using Radio3 that receives interference from another OBSS STA due to presence of a predetermined noise level or the like, and determines that Radio2 is available whose noise level is less than or equal to a predetermined level.

At the timing t14 immediately after the data transmission, the EMLSR STA can notify the AP of the information on the available link by transmitting a Single Radio Block ACK Frame including the Available Single Radio Link information to the AP.

On the other hand, for example, in a case where the Single Radio Block ACK Frame including the Available Single Radio Link information is received, the AP can grasp that the EMLSR STA is currently in a state where Radio2 is available.

At a timing t15, in a case where the AP is also capable of using Radio2 and has transmission data addressed to the EMLSR STA, the AP can perform data transmission to the EMLSR STA again by using Radio2.

Similarly, in a case where the data transmission using Radio2 ends, at a timing t16, the EMLSR STA determines that it is difficult to use Radio3 and it is possible to use Radio1 at the next transmission timing (timing t17), and includes the Available Single Radio Link information in the Single Radio Block ACK Frame to transmit the frame to the AP.

The AP receives the Single Radio Block ACK Frame including the Available Single Radio Link information, and grasps that the EMLSR STA is in a state where Radio1 is available.

At the timing t17, in a case where the AP itself can use Radio1 and has transmission data addressed to the EMLSR STA, the AP performs data transmission to the EMLSR STA again using Radio1.

Similarly, in a case where the data transmission using Radio1 ends, at a timing t18, the EMLSR STA determines that it is difficult to use Radio2 and it is possible to use Radio3 at the next transmission timing (timing t19), and includes the Available Single Radio Link information in the Single Radio Block ACK Frame to transmit the frame to the AP.

The AP receives the Single Radio Block ACK Frame including the Available Single Radio Link information, and grasps that the EMLSR STA is in a state where Radio3 is available.

At the timing t19, in a case where the AP itself can use Radio3 and has transmission data addressed to the EMLSR STA, the AP performs data transmission to the EMLSR STA again by using Radio3.

As described above, since a frame including Available Single Radio Link information based on the latest usage status of the Pre-Configure Links is transmitted from a device on the data reception side, a device on the data reception side can specify a link on which waiting is performed for next data transmission, and redundant information exchange can be reduced. Here, in the present technology, to be performed next means to be performed after transmission of the Available Single Radio Link information in terms of time, and the timing may be immediately after the transmission of the Available Single Radio Link information or may not be immediately after as long as the timing is after the transmission in terms of time.

Specifically, the Available Single Radio Link information that is information on an available link among the Pre-Configure Links is transmitted by using a Block ACK frame that is one of control frames. Note that a frame to be used is not limited to a control frame, and may be a data frame or another frame.

Furthermore, the EMLSR STA may construct a new frame, include the Available Single Radio Link information in the constructed frame, and transmit the constructed frame immediately before or immediately after a return timing of the Block ACK Frame.

In the Available Single Radio Link information, information is expressed by about 4 bits indicating a link that is selected from Pre-Configure links set in advance and has the lowest noise level at which interference is received.

Alternatively, the Available Single Radio Link information may include, by using a bitmap format, information indicating a link that is determined to be available from the Pre-Configure links set in advance and has a noise level at which interference is received is less than or equal to a predetermined threshold.

On the basis of the above description, details of the first embodiment of the present technology will be described below.

### <Configuration of Wireless Communication Device>

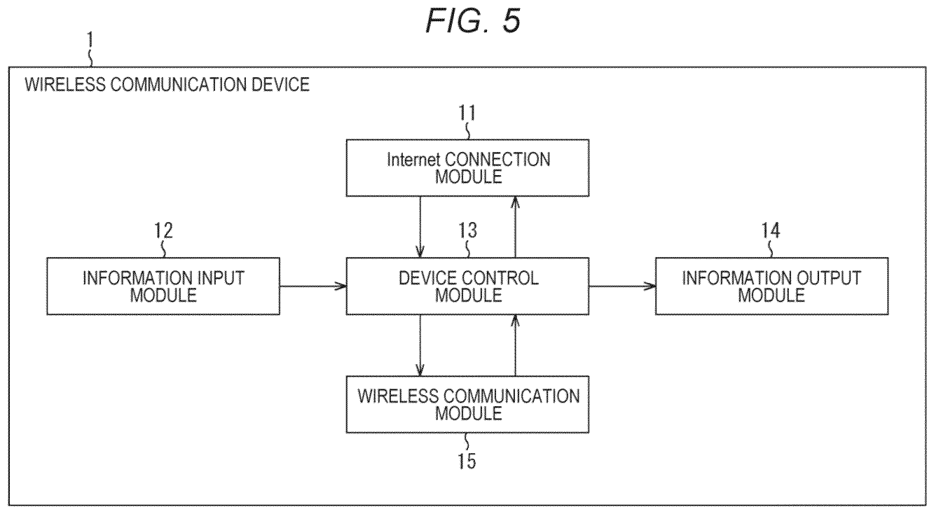

FIG. 5 is a block diagram illustrating a configuration example of the wireless communication device of the present technology.

A wireless communication device 1 in FIG. 5 is a wireless communication device that operates as an AP or an STA.

The wireless communication device 1 includes an Internet connection module 11, an information input module 12, a device control module 13, an information output module 14, and a wireless communication module 15.

Note that the wireless communication device may include only required modules.

The Internet connection module 11 is configured to implement a function of a communication modem for connecting to the Internet network, or the like in the case of operating as the AP according to control of the device control module 13. The Internet connection module 11 performs connection to the Internet via a public communication line and an Internet service provider.

The information input module 12 outputs information indicating an instruction input by a user to the device control module 13. The information input module 12 includes a push button, a keyboard, a touch panel, and the like.

The device control module 13 includes a central processing unit (CPU), a read only memory (ROM), a random access memory (RAM), and the like. The device control module 13 executes a program stored in the ROM or the like, causes an application to function in a higher layer, and performs control to operate the device as the AP or the STA.

The information output module 14 outputs information regarding an operation state of the wireless communication device 1 or information obtained via the Internet, which is supplied from the device control module 13. The information output module 14 includes a display element such as a light emitting diode (LED), a liquid crystal panel, or an organic display, a speaker that outputs sound and music, and the like. The information output module 14 performs display and notification of required information for the user.

The wireless communication module 15 transmits data supplied from the device control module 13 to another wireless communication device 1 by performing wireless communication. The wireless communication module 15 receives data transmitted from the other wireless communication device 1 by performing wireless communication, and outputs the received data to the device control module 13.

### <Configuration of Wireless Communication Module>

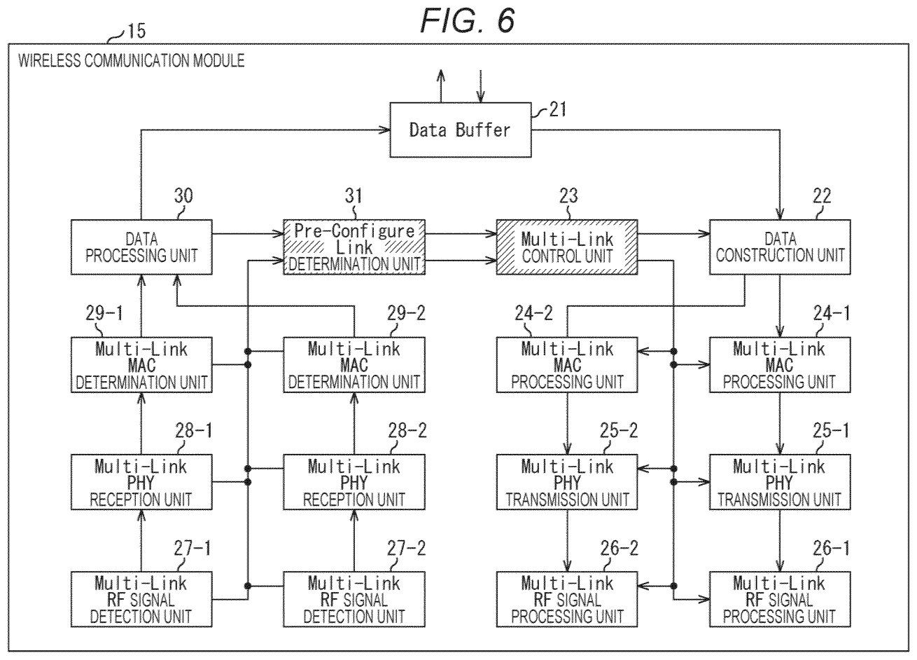

FIG. 6 is a block diagram illustrating a configuration example of the wireless communication module 15 in the case of operating as the AP.

The configuration of the wireless communication module 15 in FIG. 6 is, for example, a configuration of the AP in a network in which an EMLSR STA is present or a configuration of the STA of a multi-link device compatible with Extended Multi-Link Multi Radio (EMLMR).

The wireless communication module 15 includes a Data Buffer 21, a data construction unit 22, a Multi-Link control unit 23, Multi-Link MAC processing units 24-1 and 24-2, Multi-Link PHY processing units 25-1 and 25-2, and Multi-Link RF signal processing units 26-1 and 26-2. Each of these blocks includes a number of those, the number corresponding to the number of pieces of Radio capable of having a multi-link configuration, but here, in order to simplify the description, each block is described as including the minimum number, two, of blocks.

Furthermore, the wireless communication module 15 includes Multi-Link RF detection units 27-1 and 27-2, Multi-Link PHY reception units 28-1 and 28-2, Multi-Link MAC determination units 29-1 and 29-2, a data processing unit 30, and a Pre-Configure Link determination unit 31.

The Data Buffer 21 receives transmission data from the device control module 13 and temporarily stores the transmission data.

The data construction unit 22 constructs data to be processed at the time of data transmission. That is, the wireless communication module 15 in FIG. 6 is configured to be able to perform multi-link operation by the data construction unit 22 delivering data to be transmitted to a data transmission block of each piece of Radio.

The Multi-Link control unit 23 performs communication control using each piece of Radio at the time of data transmission by the wireless communication module 15 compatible with multi-link.

The Multi-Link MAC processing unit 24-1, the Multi-Link PHY processing unit 25-1, and the Multi-Link RF signal processing unit 26-1 are configured as a first data transmission block that performs processing by using Radio1. The Multi-Link MAC processing unit 24-2, the Multi-Link PHY processing unit 25-2, and the Multi-Link RF signal processing unit 26-2 are configured as a second data transmission block that performs processing by using Radio2.

Hereinafter, the Multi-Link MAC processing units 24-1 and 24-2, the Multi-Link PHY processing units 25-1 and 25-2, and the Multi-Link RF signal processing units 26-1 and 26-2 will be referred to as Multi-Link MAC processing units 24, Multi-Link PHY processing units 25, and Multi-Link RF signal processing units 26, respectively, in a case where it is not necessary to particularly distinguish them from each other.

The Multi-Link MAC processing unit 24 performs access control on the data to be transmitted.

The Multi-Link PHY processing unit 25 converts the transmission data into a baseband signal.

The Multi-Link RF signal processing unit 26 performs radio frequency processing on the baseband signal converted by the Multi-Link PHY processing unit 25 and transmits the processed baseband signal from an antenna.

The Multi-Link RF detection unit 27-1, the Multi-Link PHY reception unit 28-1, and the Multi-Link MAC determination unit 29-1 are configured as a first data reception block that performs processing on Radio1. The Multi-Link RF detection unit 27-2, the Multi-Link PHY reception unit 28-2, and the Multi-Link MAC determination unit 29-2 are configured as a second data reception block that performs processing on Radio2.

Hereinafter, the Multi-Link RF detection units 27-1 and 27-2, the Multi-Link PHY reception units 28-1 and 28-2, and the Multi-Link MAC determination units 29-1 and 29-2 will be referred to as Multi-Link RF detection units 27, Multi-Link PHY reception units 28, and Multi-Link MAC determination units 29, respectively, in a case where it is not necessary to particularly distinguish them from each other.

The Multi-Link RF detection unit 27 detects a waveform of a received data portion from a signal received by the antenna.

The Multi-Link PHY reception unit 28 extracts a baseband signal from the waveform detected by the Multi-Link RF detection unit 27.

The Multi-Link MAC determination unit 29 detects a predetermined frame in a channel from the baseband signal extracted by the Multi-Link PHY reception unit 28, and performs access control.

The data processing unit 30 processes data received by the data reception block for each piece of Radio in a centralized manner.

In a case where communication is performed with the EMLSR STA, the Pre-Configure Link determination unit 31 controls a setting of Radio used for the communication. The Pre-Configure Link determination unit 31 collects, for example, information on received field strength, a value of a noise level of each link, and the like in each Radio link to determine whether or not the link can be used. The Pre-Configure Link determination unit 31 outputs a result of the determination whether or not the link can be used to the Multi-Link control unit 23.

Note that, in the first embodiment of the present technology, the processing of receiving the Single Radio Block ACK Frame is performed by the first data reception block, for example, in a case where the Single Radio Block ACK Frame is received on a Radio1 link.

In this case, the waveform of the signal is detected by the Multi-Link RF detection unit 27-1, the baseband signal is extracted from the detected waveform by the Multi-Link PHY reception unit 28-1, and the predetermined frame in the channel of the baseband signal is detected by the Multi-Link MAC determination unit 29-1. Through the above processing, the Multi-Link control unit 23 recognizes that the Single Radio Block ACK Frame is received as one of the control frames.

Furthermore, in a case where the Available Single Radio Link information is included in the Single Radio Block ACK Frame, the Multi-Link control unit 23 is notified of the fact via the Pre-Configure Link determination unit 31. The Multi-Link control unit 23 specifies a link (Radio) available to the EMLSR STA, and controls communication on the link (Radio).

### <Another Configuration of Wireless Communication Module>

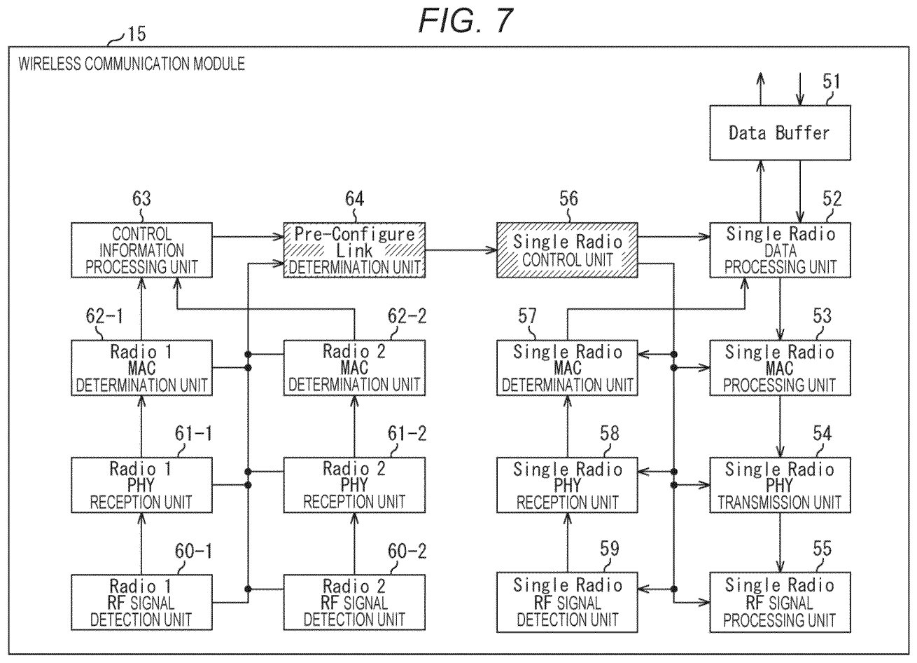

FIG. 7 is a block diagram illustrating another configuration example of the wireless communication module 15.

The wireless communication module 15 in FIG. 7 is, for example, a wireless communication module of the wireless communication device 1 compatible with the EMLSR.

The wireless communication module 15 includes a Data Buffer 51, a Single Radio data processing unit 52, a Single Radio MAC processing unit 53, a Single Radio PHY transmission unit 54, a Single Radio RF signal processing unit 55, a Single Radio control unit 56, a Single Radio MAC determination unit 57, a Single Radio PHY reception unit 58, and a Single Radio RF detection unit 59.

Furthermore, the wireless communication module 15 includes Radio RF detection units 60-1 and 60-2, Radio PHY reception units 61-1 and 61-2, and Radio MAC determination units 62-1 and 62-2. In the wireless communication module 15, each block includes a number of those, the number corresponding to the number of pieces of Radio capable of having a multi-link configuration, but, here, in order to simplify the description, each block is described as including the minimum number, two, of blocks. Moreover, the wireless communication module 15 includes a control information processing unit 63 and a Pre-Configure Link determination unit 64.

The Data Buffer 51 receives data to be transmitted from the device control module 13 and temporarily stores the data.

The Single Radio data processing unit 52 processes the data at the time of data transmission.

The Single Radio MAC processing unit 53, the Single Radio PHY transmission unit 54, and the Single Radio RF signal processing unit 55 are configured as a data transmission block.

The Single Radio MAC processing unit 53 performs access control of the data to be transmitted.

The Single Radio PHY transmission unit 54 converts the transmission data into a baseband signal.

The Single Radio RF signal processing unit 55 performs radio frequency processing on the baseband signal converted by the Single Radio PHY transmission unit 54 and transmits the processed baseband signal from an antenna.

The Single Radio control unit 56 performs communication control using each piece of Radio at the time of data transmission in the wireless communication module 15.

The Single Radio MAC determination unit 57, the Single Radio PHY reception unit 58, and the Single Radio RF detection unit 59 are configured as a data reception block.

The Single Radio MAC determination unit 57 detects a predetermined frame in a channel of a baseband signal extracted by the Single Radio PHY reception unit 58 and performs access control.

The Single Radio PHY reception unit 58 extracts the baseband signal from a waveform detected by the Single Radio RF detection unit 59.

The Single Radio RF detection unit 59 detects the waveform of a received data portion from a signal received by the antenna.

The Radio RF detection unit 60-1, the Radio PHY reception unit 61-1, and the Radio MAC determination unit 62-1 are configured as a first control information reception block that processes control information such as an RTS frame on Radio1. The Radio RF detection unit 60-2, the Radio PHY reception unit 61-2, and the Radio MAC determination unit 62-2 are configured as a second control information reception block that processes the control information on Radio2.

Hereinafter, the Radio RF detection units 60-1 and 60-2, the Radio PHY reception units 61-1 and 61-2, and the Radio MAC determination units 62-1 and 62-2 will be referred to as Radio RF detection units 60, Radio PHY reception units 61, and Radio MAC determination units 62, respectively, in a case where it is not necessary to particularly distinguish them from each other.

The Radio RF detection unit 60 detects a waveform of an RF signal.

The Radio PHY reception unit 61 extracts a baseband signal from the detected waveform.

The Radio MAC determination unit 62 detects a predetermined control frame from the extracted baseband signal and performs access control.

The control information processing unit 63 collects control information on control frames detected in a plurality of pieces of Radio, and sequentially determines in which radio link, for example, a control frame addressed to the device itself is received. The control information processing unit 63 outputs the control information of the control frame addressed to the device itself to the Pre-Configure Link determination unit 64.

The Pre-Configure Link determination unit 64 collects, for example, information on received field strength, a value of a noise level of each link, and the like in each Radio link to determine whether or not the link can be used. The Pre-Configure Link determination unit 64 outputs a result of the determination whether or not the link can be used to the Single Radio control unit 56.

Note that, in the first embodiment of the present technology, processing of transmitting the Single Radio Block ACK Frame is executed by the data transmission block under the control of the Single Radio control unit 56.

That is, the transmission data is constructed as a Control Frame by the Single Radio MAC processing unit 53, converted into a baseband signal by the Single Radio PHY transmission unit 54, subjected to radio frequency processing by the Single Radio RF signal processing unit 55, and transmitted from the antenna.

Similarly, processing of receiving an A-MPDU frame is executed by the data reception block under the control of the Single Radio control unit 56.

That is, the waveform of the received data portion is detected by a Single Radio RF signal detection unit 69 from a signal received by the antenna, and on a baseband signal extracted from the detected waveform, reception processing for a predetermined A-MPDU frame in a channel of Single Radio is executed by the Single Radio PHY reception unit 68. Thereafter, information on a delimiter is analyzed by the Single Radio MAC determination unit 67, and an MPDU portion is separated.

Note that FIGS. 6 and 7 illustrate an example in which the link includes two blocks of Radio1 and Radio2 in order to simplify the description, but actually, a number of Radio blocks are prepared, the number corresponding to the number of links that can be simultaneously processed in the EMLSR.

### <Configuration of Frame of First Embodiment>

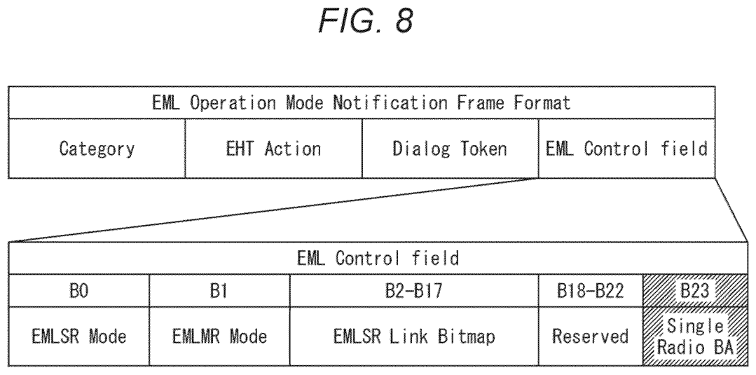

FIG. 8 is a diagram illustrating a frame configuration example of the first embodiment of the present technology.

In FIG. 8, a modified and added portion according to the present technology is indicated by hatching. This similarly applies to the following drawings.

The frame in FIG. 8 is a frame configured as an action frame or a management frame indicating compatibility with a sequence for notification of information on an available link.

Note that the frame in FIG. 8 is defined as an EML Operation Mode Notification Frame. Furthermore, the frame in FIG. 8 is appropriately transmitted in a case where the EMLSR STA performs association operation with the AP, or the like.

In FIG. 8, the EML Operation Mode Notification Frame includes Category, EHT Action, Dialog Token, and EML Control Field.

The EML Control Field includes an EMLSR Mode bit (the 0th bit), an EMLMR Mode bit (the 1st bit), EMLSR Link Bitmap bits (the 2nd bit to the 17th bit), Reserved bits (the 18th bit to the 22nd bit), and a Single Radio BA bit (the 23rd bit).

The Single Radio BA bit is a bit indicating whether or not notification can be performed of information on an available link according to the present technology.

Note that the configuration of the frame including the Single Radio BA bit is not limited to the configuration of the frame in FIG. 8. For example, the Single Radio BA bit may be set in a frame other than the action frame or the management frame, as necessary.

### <First Frame Configuration of Single Radio Block Acknowledgement (ACK) Frame>

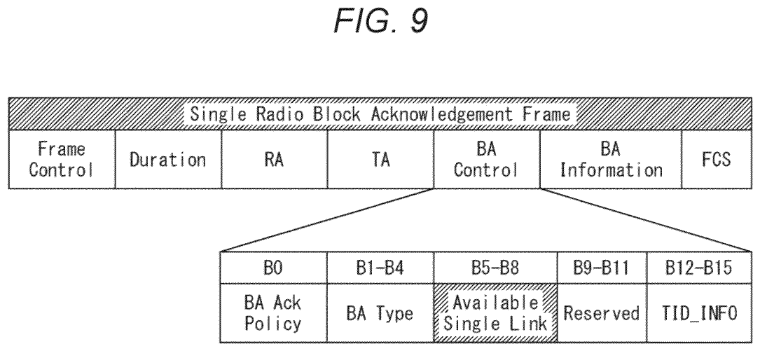

FIG. 9 is a diagram illustrating a first configuration example of the Single Radio Block ACK Frame.

The Single Radio Block ACK Frame in FIG. 9 includes Fields of Frame Control, Duration, Received Address (RA), Transport Address (TA), BA Control, BA Information, and File Check Sequence (FCS).

The Frame Control is information indicating a type and a format of a frame.

The Duration is information indicating a duration of a frame.

The RA is identification information for identifying a device on the reception side.

The TA is identification information for identifying a device on the transmission side.

The BA Control Field includes a BA ACK Policy bit (the 0th bit), BA Type bits (the 1st bit to the 4th bit), Available Single Link bits (the 5th bit to the 8th bit), Reserved bits (the 9th bit to the 11th bit), and TID INFO bits (the 12th bit to the 15th bit).

The Available Single Link bits included in the BA Control Field are Available Single Radio Link information indicating available links.

The BA Information is information regarding the BA.

The FCS is a frame check sequence of error detection.

That is, the Single Radio Block ACK Frame in FIG. 9 is configured so that it is possible to designate one available link by using the 5th bit to the 8th bit, which have been set as the Reserved bits of the BA Control field, as the Available Single Link bits while maintaining the conventional format of the Block ACK Frame. The Reserved bits are bits that are not defined as bits representing specific information on the 802.11 standard.

Note that, in FIG. 9, the 5th bit to the 8th bit that have been set as the Reserved bits of the BA Control Field are used as the Available Single Link bits, but other Reserved bits may be used.

### <Second Configuration of Single Radio Block ACK Frame>

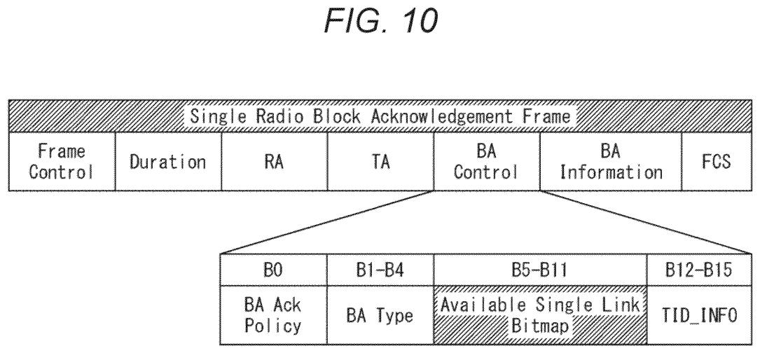

FIG. 10 is a diagram illustrating a second frame configuration example of the Single Radio Block ACK Frame.

The Single Radio Block ACK Frame in FIG. 10 is different from the Single Radio Block ACK Frame in FIG. 9 in the configuration of the BA Control Field.

In FIG. 10, the BA Control Field includes the BA ACK Policy bit (the 0th bit), the BA Type bits (the 1st bit to the 4th bit), Available Single Link Bitmap bits (the 5th bit to the 11th bit), and the TID INFO bits (the 12th bit to the 15th bit).

The Available Single Link Bitmap bits included in the BA Control Field are information indicating available links.

That is, the Single Radio Block ACK Frame in FIG. 10 is configured so that it is possible to designate all the available links except for the current link in Bitmap format by using the 5th bit to the 11th bit that have been set as the Reserved bits of the BA Control field while maintaining the conventional format of the Block ACK Frame.

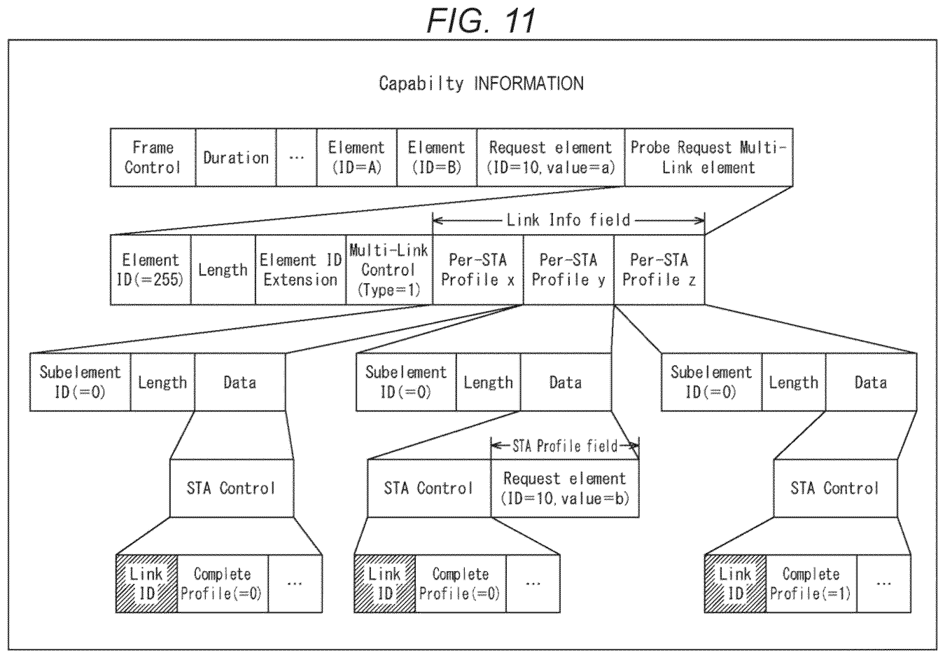

Here, as illustrated in FIG. 10, in a case where information indicating available links is described as information in Bitmap format, for example, when association processing is executed, it is necessary to exchange capability information illustrated in FIG. 11. Note that this similarly applies to a case where other information is described in Bitmap format in FIG. 10 and subsequent drawings.

### <Information in Bitmap Format>

FIG. 11 is a diagram illustrating a configuration of the capability information including a link identifier (Link ID) that needs to be exchanged in a case where information in Bitmap format is described as available links.

In FIG. 11, the capability information includes Frame Control, Duration, . . . , a plurality of Elements, Request Element, and Probe Multi-Link element.

The Probe Multi-Link element includes Element ID, Length, Element ID Extension, Multi-Link Control, and a plurality of Pre-STA Profiles.

Each Pre-STA Profile includes Subelement ID, Length, and Data.

The Data includes STA Control. Note that the Data may include a Request element.

The STA Control includes a Link ID that is a link identifier and Complete Profile that is link attribute information, and the like.

In the capability information configured as described above, information on a frequency channel for operating using multi-link, and the like are described as attribute information (Complete Profile) on each link for each link identifier (Link ID).

Thus, the capability information in FIG. 11 is exchanged, whereby the information on the frequency channel for operating using the multi-link, and the like are acquired for each link identifier (Link ID). As a result, in the information in Bitmap format in FIG. 10, each bit can be assigned and described on the basis of the link identifier (Link ID).

For example, in the information in Bitmap format in FIG. 10, from a link identifier (Link ID) with a smaller numerical value, the first bit is assigned, and a link identifier (Link ID) with a large numerical value is assigned to the last bit. In this case, a required bit size may be set for the link identifier (Link ID) according to the number of multi-links supported by the communication device itself.

Note that information such as a frequency channel and a bandwidth used in each link that performs multi-link operation may be defined by the link identifier (Link ID). Furthermore, determination as to whether or not one link is in use may be performed on the basis of attribute information on the link.

### <Third Configuration of Single Radio Block ACK Frame>

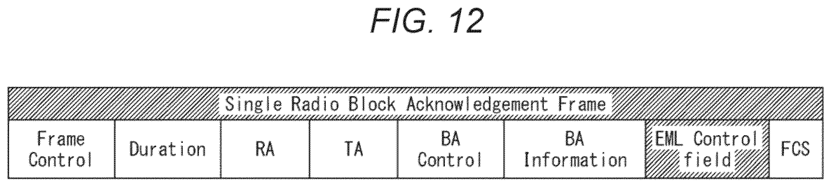

FIG. 12 is a diagram illustrating a third frame configuration example of the Single Radio Block ACK Frame.

The Single Radio Block ACK Frame in FIG. 12 is different from the Single Radio Block ACK Frame in FIG. 9 in that EML Control Field that is a new field is added.

The EML Control Field is an area transmitted after an existing area (BA information in the case of FIG. 12) of the 802.11be standard. The EML Control Field includes information indicating available links, information indicating whether or not operation in the EMLSR mode can be performed, and the like.

That is, the Single Radio Block ACK Frame in FIG. 12 is configured so that it is possible to perform notification including the information indicating the available links and the information indicating whether or not the operation in the EMLSR mode can be performed in addition to the conventional format of the Block ACK Frame.

### <Processing by AP in First Embodiment>

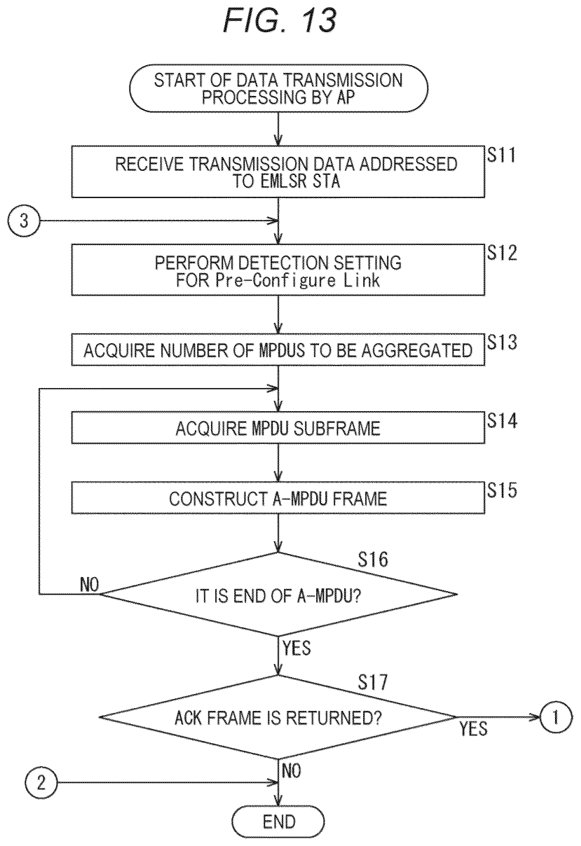

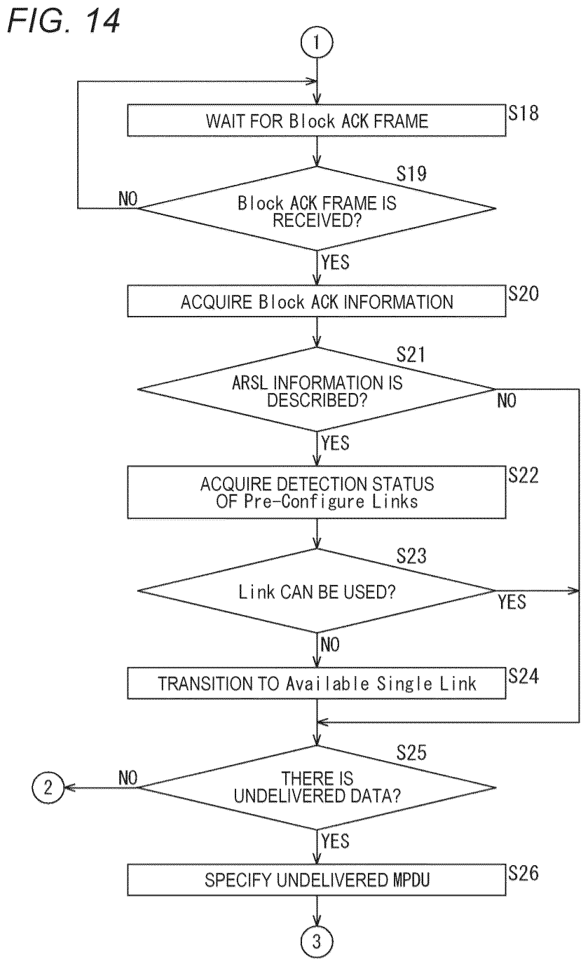

FIGS. 13 and 14 are flowcharts illustrating data transmission processing in the first embodiment.

Although the operation in the AP to which the EMLSR STA is to be connected will be described in FIGS. 13 and 14, the data transmission processing in FIGS. 13 and 14 can also be applied to a case where a communication device (STA) having data to be transmitted to the EMLSR STA determines an available link and transmits the data.

Furthermore, in FIGS. 13 and 14, for example, it is assumed that a link set in advance as a Pre-Configure Link is specified by exchange of a predetermined action frame with the EMLSR STA.

In step S11, the data construction unit 22 (FIG. 6) receives transmission data addressed to the EMLSR STA from the device control module 13 via the Data Buffer 21.

In step S12, the Multi-Link control unit 23 performs detection setting for grasping a usage status of the EMLSR STA in the Pre-Configure Link.

In step S13, the Multi-Link control unit 23 acquires the number of MPDUs to be aggregated (an A-MPDU number) from an acquisition status of a transmission opportunity in Single Radio for transmitting data and a time in which transmission is possible in one access control.

In step S14, the data construction unit 22 acquires an MPDU subframe.

In step S15, the data construction unit 22 constructs an A-MPDU frame.

In step S16, the data construction unit 22 determines whether or not it is the end of the A-MPDU (frame) on the basis of the acquired A-MPDU number. In a case where it is determined in step S16 that it is not the end of the A-MPDU, the processing returns to step S14, and the subsequent processing is repeated.

In a case where it is determined in step S16 that it is the end of the A-MPDU, the processing proceeds to step S17.

The Multi-Link control unit 23 performs collection for the A-MPDU until a predetermined A-MPDU number is reached to set an A-MPDU Frame, and controls the first data transmission block or the second data transmission block to transmit the frame.

After transmitting the A-MPDU Frame, in step S17, the Multi-Link control unit 23 determines whether or not an ACK frame is returned. In a case where it is determined that an ACK frame is not returned, the data transmission processing by the AP ends.

In a case where it is determined in step S17 that an ACK frame is returned, the processing proceeds to step S18 in FIG. 14.

In step S18, the Multi-Link control unit 23 waits for a Block ACK frame.

In step S19, the Multi-Link control unit 23 determines whether or not the Block ACK frame is received. In a case where it is determined in step S19 that the Block ACK frame is not received, the processing returns to step S18, and the subsequent processing is repeated.

In a case where the Block ACK frame is received in the first data reception block or the second data reception block, it is determined in step S19 that the Block ACK frame is received, and the processing proceeds to step S20.

In step S20, the Multi-Link control unit 23 acquires Block ACK information from the Block ACK frame received in the first data reception block or the second data reception block.

In step S21, the Multi-Link control unit 23 determines whether or not Available Single Radio Link (ASRL) information indicating available links is described in the acquired Block ACK information. In a case where it is determined in step S21 that the Available Single Radio Link information is described, the processing proceeds to step S22.

In step S22, the Pre-Configure Link determination unit 31 acquires a detection status of the Pre-Configure Links of the device itself from the Available Single Radio Link information.

In step S23, the Multi-Link control unit 23 determines whether or not an Available Single Radio Link described in the Available Single Radio Link information can be used on the basis of the detection status of the Pre-Configure Links. In a case where it is determined in step S23 that the Link can be used, the processing proceeds to step S24.

In step S24, the Multi-Link control unit 23 transitions to the Available Single Radio Link described in the Available Single Radio Link information, and continues the data transmission. Note that, in the present specification, transitioning to a specified Radio (Link) is synonymous with setting the specified Radio as a link that operates.

In a case where it is determined in step S21 that the Available Single Radio Link information is not described, the processing in steps S22 to S24 is skipped, and the processing proceeds to step S25.

Furthermore, in a case where it is determined in step S23 that the Available Single Radio Link described in the Available Single Radio Link information cannot be used, the processing in step S24 is skipped, and the processing proceeds to step S25.

In step S25, the Multi-Link control unit 23 determines whether or not there is undelivered data on the basis of the Block ACK information acquired in step S20. In a case where it is determined in step S25 that there is undelivered data, the processing proceeds to step S26.

In step S26, the Multi-Link control unit 23 specifies an undelivered MPDU. Thereafter, the processing returns to step S12 in FIG. 13, and the subsequent processing is repeated.

In a case where it is determined in step S25 that there is no undelivered data, the data transmission processing by the AP in FIGS. 13 and 14 ends.

### <Processing by EMLSR STA>

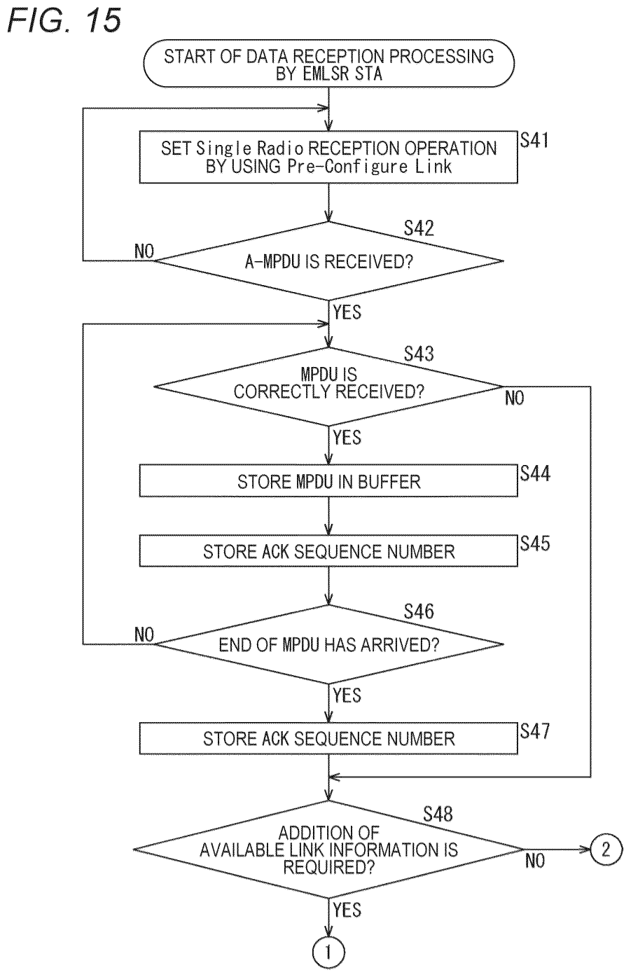

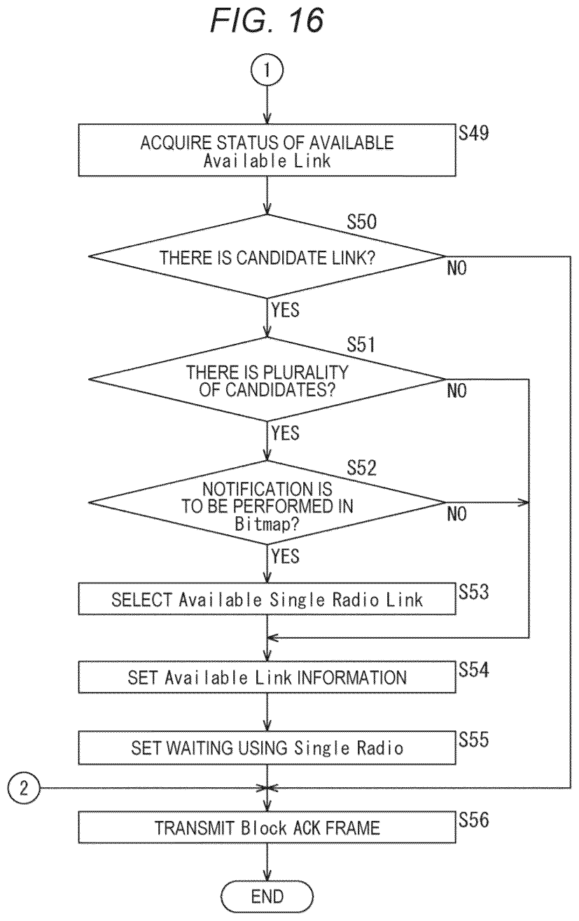

FIGS. 15 and 16 are flowcharts illustrating data reception processing by the EMLSR STA in the first embodiment.

Although the operation in the EMLSR STA will be described in FIGS. 15 and 16, the processing in FIGS. 15 and 16 can also be applied to a case where an AP or a communication device (STA) on the data transmission side determines an available link and performs notification of information on the available link.

In step S41, the Single Radio control unit 56 (FIG. 7) of the EMLSR STA exchanges, for example, a predetermined action frame with the AP or the like to operate a link defined as a Pre-Configure Link, to set Single Radio reception operation.

In step S42, the Single Radio data processing unit 52 determines whether or not an A-MDPU is received. In a case where it is determined in step S42 that an A-MDPU is not received, the processing returns to step S41, and the subsequent processing is repeated.

In a case where it is determined in step S42 that an A-MDPU is received, the processing proceeds to step S43.

In step S43, the Single Radio data processing unit 52 determines whether or not each MDPU is normally received. In a case where it is determined in step S43 that each MDPU is normally received, the processing proceeds to step S44.

In step S44, the Single Radio data processing unit 52 stores the normally received MDPU in the Data Buffer 51.

In step S45, the Single Radio data processing unit 52 stores an ACK sequence number of the normally received MDPU.

In step S46, the Single Radio data processing unit 52 determines whether or not the end of the MPDU has arrived. In a case where it is determined in step S46 that the end of the MPDU has not arrived, the processing returns to step S43, and the subsequent processing is repeated.

In a case where it is determined in step S46 that the end of the MPDU has arrived, the processing proceeds to step S47.

In step S47, the Single Radio data processing unit 52 acquires the stored ACK sequence number and constructs a Block ACK frame. Thereafter, the processing proceeds to step S48.

In a case where it is determined in step S43 that each MDPU is not normally received, the processing in steps S44 to S47 is skipped, and the processing proceeds to step S48.

In step S48, the Single Radio control unit 56 determines whether or not addition of available link information is required. In a case where it is determined in step S48 that the addition of the available link information is required, the processing proceeds to step S49 in FIG. 16.

In step S49, the Pre-Configure Link determination unit 64 acquires a status of Available Links on the basis of the received field strength, noise level, and the like of the Pre-Configure links at the present time.

In step S50, the Pre-Configure Link determination unit 64 determines whether or not there is a candidate link. In a case where it is determined in step S50 that there is a candidate link, the processing proceeds to step S51.

In step S51, the Pre-Configure Link determination unit 64 determines whether or not there is a plurality of candidate links. In a case where it is determined in step S51 that there is a plurality of candidate links, the processing proceeds to step S52.

In step S52, the Single Radio control unit 56 determines whether or not notification of information regarding the plurality of candidate links is to be performed in Bitmap (in Bitmap format). In a case where it is determined in step S52 that the notification of the information regarding the plurality of candidate links is not to be performed in Bitmap, the processing proceeds to step S53.

In step S53, the Pre-Configure Link determination unit 64 selects one link desired to operate as the Available Single Radio Link. In this case, in step S54, the Single Radio control unit 56 sets the Available Single Radio Link information in which information indicating the desired link is described.

In a case where it is determined in step S51 that there is no plurality of candidates, the processing in steps S52 and S53 is skipped, and the processing proceeds to step S54. In this case, in step S54, the Single Radio control unit 56 sets the Available Single Radio Link information in which information indicating the candidate link is described.

In a case where it is determined in step S52 that notification is to be performed in Bitmap, the processing proceeds to step S54. In step S54, the Single Radio control unit 56 sets the Available Single Radio Link information in Bitmap format.

In step S55, in order to perform Single Radio operation, the Single Radio control unit 56 transitions to the link described in the Available Single Radio Link information and sets waiting using Single Radio. That is, the link described in the Available Single Radio Link Information is set as a link for which waiting for a data frame using Single Radio is performed.

In step S56, the Single Radio control unit 56 transmits a Block ACK frame to which information indicating an available link (Available Single Radio Link information) is added.

In a case where it is determined in step S48 that addition of the information indicating the available link is not required, or in a case where it is determined in step S50 that there is no candidate link, the processing proceeds to step S56. In this case, in step S56, the Single Radio control unit 56 transmits a normal Block ACK frame.

After the processing in step S56, the processing by the EMLSR STA in FIGS. 15 and 16 ends.

### MODIFICATIONS

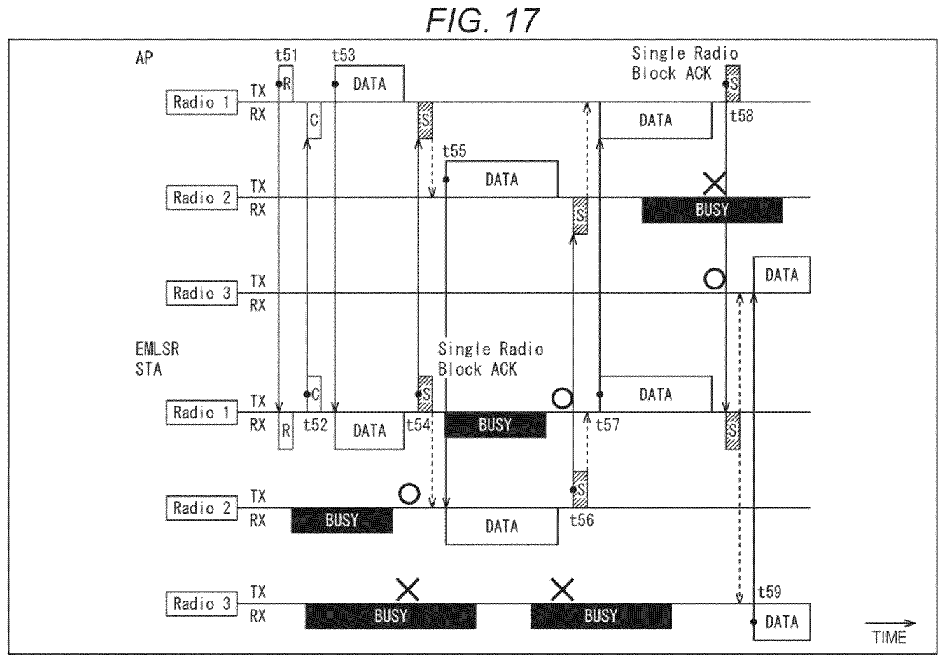

FIG. 17 is a diagram illustrating another operation sequence of the AP or the communication device on the data transmission side (indicated as AP in the figure) and the EMLSR STA in the first embodiment of the present technology.

At timings t51 to t55 in FIG. 17, the same processing is performed as that at the timings t1 to t5 in FIG. 4, and thus the description thereof will be omitted.

In the case of FIG. 17, after the data transmission using Radio2 at the timing t55 ends, at a timing t56, the EMLSR STA determines that it is difficult to use Radio3 and it is possible to use Radio1 at the next transmission timing (timing t57), and includes the Available Single Radio Link information in the Single Radio Block ACK Frame to transmit the frame to the AP.

The AP receives the Single Radio Block ACK Frame including the Available Single Radio Link information, and grasps that the EMLSR STA is in a state where Radio1 is available.

For example, in a case where data transmission from the AP to the EMLSR STA is not required and data transmission from the EMLSR STA to the AP using Radio1 is required, the data transmission from the EMLSR to the AP can be performed here on the basis of a predetermined access control procedure, and thus, the AP waits for data from the STA by using Radio1.

Note that the EMLSR STA may determine whether or not there is undelivered data from the AP or data to be transmitted by the EMLSR STA, and in a case where it is determined that “there is” either data as a result of the determination, the EMLSR STA may transmit the Available Single Radio Link information to the AP. At this time, the EMLSR STA may determine only one of whether or not there is undelivered data from the AP or whether or not there is data to be transmitted by the EMLSR STA.

At the timing t57 after the predetermined access control procedure has elapsed, the EMLSR STA performs data transmission to the AP by using Radio1. In a case where the data transmission using Radio1 ends, at a timing t58, the AP determines that it is difficult to use Radio2 and it is possible to use Radio3 at the next transmission timing (timing t59), and includes the Available Single Radio Link information in the Single Radio Block ACK Frame to transmit the information to the EMLSR STA by using Radio1.

The EMLSR STA receives the Single Radio Block ACK Frame including the Available Single Radio Link information, and grasps that the AP is in a state where Radio3 is available.

At a timing t59, in a case where data transmission to the EMLSR STA is required, the AP performs the data transmission to the EMLSR STA again by using Radio3 on the basis of the predetermined access control procedure similarly.

As described above, for example, in a case where a need occurs for data transmission from the AP to the EMLSR STA, the AP can transmit data by using Radio3, and thus, can transmit the data after receiving the Block ACK Frame.

That is, the EMLSR STA that has received the Available Single Radio Link information from the AP can receive and transmit data from the AP more reliably by waiting using Radio3 described in the Available Single Radio Link information.

### Effects of First Embodiment

As described above, in the first embodiment of the present technology, the EMLSR STA performs notification of the Available Single Radio Link information, so that it is possible to specify a link on which waiting is performed and to reduce redundant information exchange.

In particular, it is possible to immediately perform notification of the latest status of a transmission path at a timing of returning the Block ACK Frame.

That is, by describing the information on Available Radio Link in the Block ACK Frame, it is not necessary to use another Frame for notification of the information.

Furthermore, by selecting an optimum link capable of stable communication on the data reception side, it is possible to immediately designate the link without waiting for an RTS Frame from the data transmission side as in a conventional case.

Since a link for continuing communication of the EMLSR can be selected from the data reception side, data transmission can be reliably performed.

In a case where there is Available Single Radio Link information indicating a plurality of available links, it is possible to perform notification of information on the plurality of links by including the information in Bitmap format in the Single Radio Block ACK Frame. As a result, it is possible to give a room for selection to the data transmission side, and it is possible to select a link that is more reliably used.

Since it is possible to omit a time required for exchanging the RTS frame and the CTS frame, which is redundant, related to a data transmission sequence of the EMLSR of a conventional method, the time required for exchanging the RTS frame and the CTS frame can be effectively utilized for a transmission opportunity (TXOP) for data transmission.

The number of aggregates of the A-MPDU can be optimized in a limited TXOP on a certain link.

Furthermore, in a case where there is undelivered data (that is, retransmission data) or in a case where reception of data needs to be continued, even in a case where all data transmission is not completed in the TXOP of one link, switching to another link can be performed immediately. As a result, seamless data transmission can be performed.

Moreover, it is possible to perform bidirectional data transmission in a short time by performing notification of the Available Single Radio Link also in a case where there is transmission data from the EMLSR STA to the AP.

As described above, since a plurality of links can be continuously used, Real-Time Application data can be seamlessly transmitted.

### 2. Second Embodiment (Next Single Radio Link Information)

In the first embodiment, an example has been described in which notification of link information available for data transmission is performed from the EMLSR STA on the data reception side, and next, as a second embodiment, an example will be described in which notification of link information available for the next data transmission is performed from a communication device (AP) on the data transmission side.

Note that a system configuration of the second embodiment is similar to the system configuration of the first embodiment. Thus, hereinafter, the system configuration of the first embodiment described above with reference to FIG. 1 is also used as the system configuration of the second embodiment.

### <Operation of AP and EMLSR STA in Second Embodiment of Present Technology>

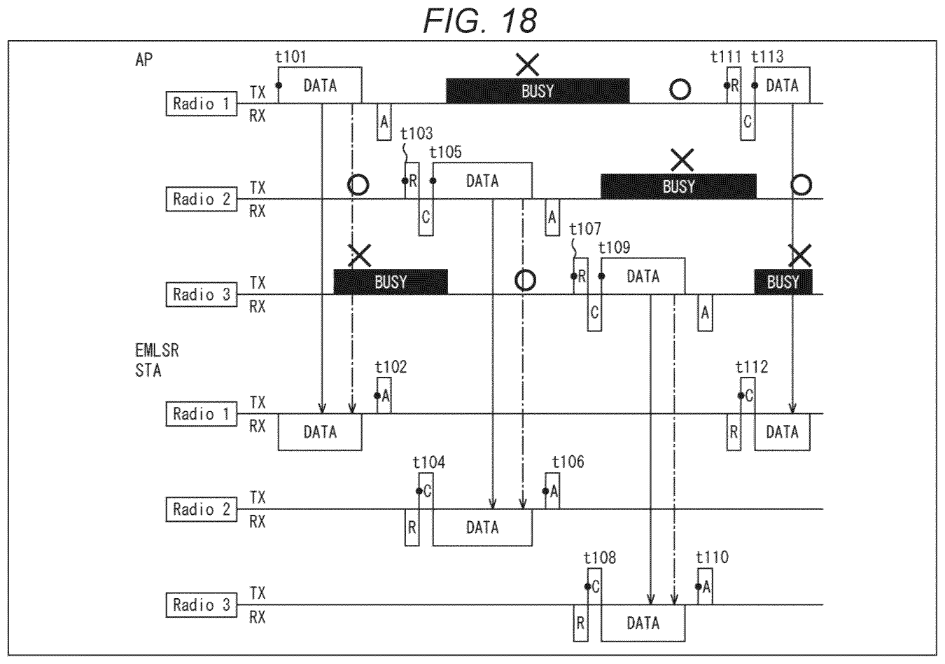

FIG. 18 is a diagram illustrating an operation sequence of the AP or the communication device on the data transmission side (indicated as AP in the figure) and the EMLSR STA in the second embodiment of the present technology.

Note that, in FIG. 18, an arrow of a solid line represents transmission of control information included in a delimiter at the rear of a signal, and an arrow of a one-dot chain line represents transmission of control information included in Padding of the signal.

The processing at a timing t101 in FIG. 18 is the same as the processing at the timing t3 in FIG. 3. That is, for example, a Multi-User RTS frame (hereinafter, an RTS frame) and a CTS frame are exchanged as the control frame, and the AP starts data transmission at the timing t101. The EMLSR STA starts data reception.

Before ending the data transmission using Radio1, the AP acquires states of links immediately before the end of transmission of the A-MPDU by, for example, grasping the usage status of Pre-Configure Links, and determines a link available in the next data transmission.

In FIG. 18, Radio3 is in use (BUSY state) in other transmission, and data transmission using Radio2 can be performed. At this time, if Padding is available at the end of the A-MPDU during data transmission, the AP includes Next Single Radio Link information indicating a link available in the next data transmission in the Padding, and transmits the information as indicated by an arrow of a one-dot chain line.

Note that the fact that the Next Single Radio Link information is included in the Padding is described in a delimiter at the rear in the data, and is transmitted as indicated by an arrow of a solid line.

For example, in the AP on the transmission side capable of performing multi-link operation, there is a possibility that transmission to another STA is performed in any link, and in that case, transmission to the EMLSR STA becomes difficult, and thus, it is necessary to notify the EMLSR STA in advance that the AP is in a BUSY state.

Furthermore, in a case where the Next Single Radio Link information is included at the end (such as Padding) of the received A-MPDU, the EMLSR STA on the data reception side can specify a link (Radio2) used for data transmission to be performed next on the basis of the Next Single Radio Link information. As a result, the EMLSR STA on the data reception side can wait for, for example, the RTS frame by using the set Radio2 link. Here, to be performed next means to be performed after reception of the Next Single Radio Link information in terms of time, and the timing may be immediately after the reception of the Next Single Radio Link information or may not be immediately after as long as the timing is after the reception in terms of time.

After the data transmission ends, the EMLSR STA transmits an ACK frame by using Radio1 at a timing t102. The AP receives the ACK frame by using Radio1.

At a timing t103, the AP transmits an RTS frame by using Radio2 to notify the EMLSR STA of the start of data transmission. The EMLSR STA waits for the RTS frame by using Radio2 based on the Next Single Radio Link information, and receives the RTS frame.

At a timing t104, the EMLSR STA returns a CTS frame to the AP by using Radio2. The AP receives the CTS frame by using Radio2.

Accordingly, the AP can continue the data transmission to the EMLSR STA by using Radio2 at a timing t105. The EMLSR STA continues to receive data by using Radio2.

Before the end of the data transmission on Radio2, the AP grasps the usage status of the Pre-Configure Links, acquires the state of each link immediately before the end of the transmission of the A-MPDU, and determines a link available for the next data transmission.

Here, Radio1 is in use (BUSY state) due to other transmission, and data transmission using Radio3 can be performed. At this time, the AP has data to be transmitted to the EMLSR STA, and in a case where Padding is available at the end of the A-MPDU during data transmission, the AP includes the Next Single Radio Link information in the Padding and transmits the information as indicated by an arrow of a one-dot chain line.

In a case where the end (Padding) of the received A-MPDU includes the Next Single Radio Link information, the EMLSR STA can specify a link (Radio3) on which data transmission is to be continued on the basis of the Next Single Radio Link information. Thus, the EMLSR STA can wait for, for example, the RTS frame by using the Radio3 link.

After the data transmission ends, the EMLSR STA transmits an ACK frame by using Radio2 at a timing t106. The AP receives the ACK frame by using Radio2.

At a timing t107, the AP transmits an RTS frame by using Radio3 to notify the EMLSR STA of the start of data transmission. The EMLSR STA waits for the RTS frame by using Radio3 based on the Next Single Radio Link information, and receives the RTS frame.

At a timing t108, the EMLSR STA returns a CTS frame to the AP on Radio3. The AP receives the CTS frame on Radio3.

Accordingly, the AP can continue the data transmission to the EMLSR STA by using the link (Radio3) at a timing t109. The EMLSR STA continues to receive data by using Radio3.

Before the end of the data transmission using Radio3, the AP grasps the usage status of Pre-Configure links, acquires the state of each link immediately before the end of the transmission of the A-MPDU, and determines a link available for the next data transmission.

Here, Radio2 is in use (BUSY state) due to other transmission, and data transmission using Radio1 can be performed. At this time, if Padding is available at the end of the A-MPDU during data transmission, the Next Single Radio Link information is included in the Padding and transmitted as indicated by an arrow of a one-dot chain line.

In a case where the Next Single Radio Link information is included at the end (Padding) of the A-MPDU, the EMLSR STA can specify a link (Radio1) on which data transmission is to be continued on the basis of the Next Single Radio Link information. Thus, the EMLSR STA waits for, for example, an RTS frame by using the Radio1 link.

After the data transmission ends, the EMLSR STA transmits an ACK frame by using Radio3 at a timing t110. The AP receives the ACK frame by using Radio3.

At a timing t111, the AP transmits an RTS frame by using Radio1 to notify the EMLSR STA of the start of data transmission. The EMLSR STA waits for the RTS frame by using Radio1 based on the Next Single Radio Link information, and receives the RTS frame.

At a timing t112, the EMLSR STA returns a CTS frame to the AP by using Radio1. The AP receives the CTS frame by using Radio1.

At a timing t113, the AP can continue the data transmission to the EMLSR STA by using the link (Radio1). The EMLSR STA continues to receive data by using Radio1.

In this way, by continuing to specify a link available for the next transmission during data transmission, it is possible to use a transmission path seamlessly in a case where real-time data is transmitted.

As described above, a device on the data transmission side performs notification of the Next Single Radio Link information based on the latest usage status of the Pre-Configure Links during data transmission, so that a device on the data reception side can grasp a Pre-Configure Link on which communication subsequent Single Radio communication can be continued. As a result, it is possible to perform data transmission by using a link (Radio) on which data transmission is performed next (later in terms of time).

For example, to a data (A-MPDU) frame being transmitted, the Next Single Radio Link information is transmitted available at that time in the device on the data transmission side among the Pre-Configure Links.

Furthermore, for example, a control frame may be constructed such that the header includes the Next Single Radio Link information, and the latest status may be transmitted at any timing.

In the Next Single Radio Link information, information indicating a link that is selected from Pre-Configure Links set in advance and has the lowest noise level at which interference is received is expressed by about 4 bits.

Alternatively, the Next Single Radio Link information may include, in a bitmap format, information indicating a link that is determined to be available from the Pre-Configure links set in advance and has a noise level at which interference is received is less than or equal to a predetermined threshold.

On the basis of the above description, details of the second embodiment of the present technology will be described below.

### <Configuration of Wireless Communication Device>

A device configuration of the second embodiment is similar to the device configuration of the first embodiment. Thus, hereinafter, the device configuration of the first embodiment described above with reference to FIGS. 5, 6, and 7 is also used as the device configuration of the second embodiment.

Note that, in the configuration (FIG. 6) of the wireless communication module of the device operating as the communication device (AP) on the data transmission side of the second embodiment of the present technology, in particular, processing of receiving the Block ACK Frame is performed by the first data reception block, for example, in a case where the Block ACK Frame is received on the Radio1 link.

In this case, the waveform of the signal is detected by the Multi-Link RF detection unit 27-1, the baseband signal is extracted from the detected waveform by the Multi-Link PHY reception unit 28-1, and the predetermined frame in the channel of the baseband signal is detected by the Multi-Link MAC determination unit 29-1. Through the above processing, the Multi-Link control unit 23 recognizes that the Block ACK Frame is received as one of the control frames.

In a case where the Next Single Radio Link information is included in the Padding of the A-MPDU frame, the Multi-Link control unit 23 constructs (generates) the Next Single Radio Link information on the basis of the information on the available link supplied from the Pre-Configure Link determination unit 31, replaces the Padding, and transmits the Next Single Radio Link information.

Furthermore, in a case where information indicating that the Next Single Radio Link information is included in the Padding is to be described in the last delimiter of the A-MPDU frame, the multi-link control unit 32 constructs the information indicating that the Next Single Radio Link information is included in the Padding, replaces the last delimiter, and transmits the information.

In particular, in the configuration (FIG. 7) of the wireless communication module of the device operating as the EMLSR STA of the second embodiment of the present technology, processing of transmitting the Block ACK Frame is executed by the data transmission block under the control of the Single Radio control unit 56.

That is, the transmission data is constructed as a Control Frame by the Single Radio MAC processing unit 53, converted into a baseband signal by the Single Radio PHY transmission unit 54, subjected to radio frequency processing by the Single Radio RF signal processing unit 55, and transmitted from the antenna.

The processing of receiving the A-MPDU frame is executed by the data reception block under the control of the Single Radio control unit 56.

That is, the waveform of the received data portion is detected by the Single Radio RF signal detection unit 69 from a signal received by the antenna, and on a baseband signal extracted from the detected waveform, reception processing for a predetermined A-MPDU frame in a channel of Single Radio is executed by the Single Radio PHY reception unit 68. Then, information on a delimiter is analyzed by the Single Radio MAC determination unit 67, and an MPDU portion is separated.

Here, in a case where the Next Single Radio Link information is included in the delimiter or the Padding transmitted from the AP, the Next Single Radio Link information is supplied to the Single Radio control unit 56.

### <Configuration of Frame of Second Embodiment>

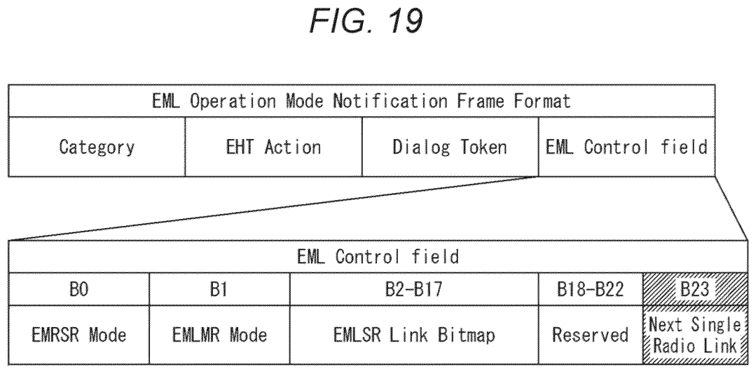

FIG. 19 is a diagram illustrating a configuration example of a frame of the second embodiment of the present technology.

The frame in FIG. 19 is a frame configured as an action frame or a management frame indicating compatibility with a sequence for notification of information on an available link.

Note that the frame in FIG. 19 is defined as an EML Operation Mode Notification Frame. Furthermore, the frame in FIG. 19 is appropriately communicated in a case where the EMLSR STA compatible with the EMLSR performs association operation with the AP, or the like.

In FIG. 19, the EML Operation Mode Notification Frame includes Category, EHT Action, Dialog Token, and EML Control Field.

The EML Control Field includes an EMLSR Mode bit (the 0th bit), an EMLMR Mode bit (the 1st bit), EMLSR Link Bitmap bits (the 2nd bit to the 17th bit), Reserved bits (the 18th bit to the 22nd bit), and a Next Single Radio Link bit (the 23rd bit).

The Next Single Radio Link bit included in the EML Control Field is a bit indicating whether or not notification can be performed of link information available for next data transmission according to the present technology.

Note that the configuration of the frame including the Next Single Radio Link bit is not limited to the configuration of the action frame in FIG. 19. For example, the Next Single Radio Link bit may be set in a frame other than the frame in FIG. 19, as necessary.

### <First Configuration of A-MPDU Frame>

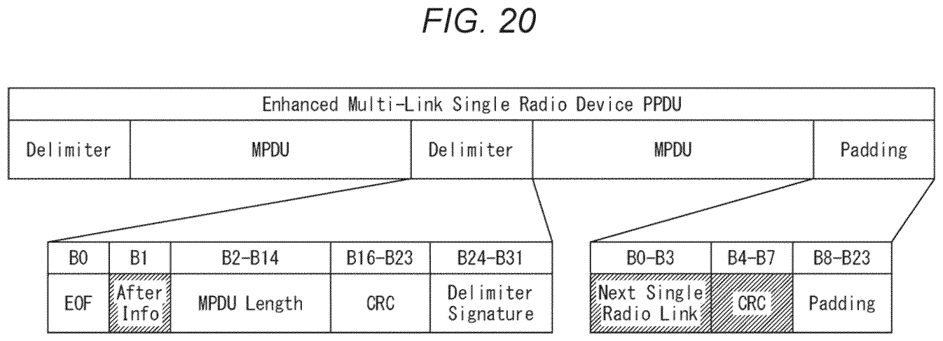

FIG. 20 is a diagram illustrating a first configuration example of the A-MPDU frame of the second embodiment of the present technology.

The A-MPDU frame in FIG. 20 is configured by alternately aggregating (connecting) a delimiter (Delimiter) indicating a frame boundary and a MAC Protocol Data Unit (MPDU) including actual data and adding Padding to the end.

The delimiter includes an EOF bit (the 0th bit), an After Info bit (the 1st bit), MPDU Length bits (the 2nd bit to the 14th bit), CRC bits (the 16th bit to the 23rd bit), and Delimiter Signature bits (the 24th bit to the 31st bit).

The After Info bit is a portion set as Reserved in the conventional delimiter, and is information for identifying that the Next Single Radio Link information is included in the subsequent Padding.

That is, the After Info bit is set to 1, whereby the device on the data reception side can grasp that the Next Single Radio Link information is included in the Padding.

Note that the delimiter including the After Info bit is preferably a delimiter before the last MDPU (that is, the last delimiter) as illustrated in FIG. 20, but the After Info bit may be included in a delimiter at another position.

Since the conventional A-MPDU frames need to be aligned in units of 4 Bytes, the Padding is added to the end of the A-MPDU with 0 Bytes to 3 Bytes.

A new Padding portion according to the present technology includes Next Single Radio Link bits (the 0th bit to the 3rd bit), and CRC bits (the 4th bit to the 7th bit), and further, as necessary, Padding bits (from the 8th bit to the 23rd bit).

The Next Single Radio Link bits are the Next Single Radio Link information.

CRC may be added as necessary to reliably transmit the Next Single Radio Link information.

The normal Padding has a length of 0 Bytes to 3 Bytes as described above, but in a case where the conventional Padding is 0 Bytes or 1 Byte, MPDU Length may be adjusted to extend the length of the Padding, and the Next Single Radio Link information according to the present technology may be included.

Furthermore, the Next Single Radio Link bits may be included in the last delimiter instead of the Padding.

### <Second Configuration of A-MPDU Frame>

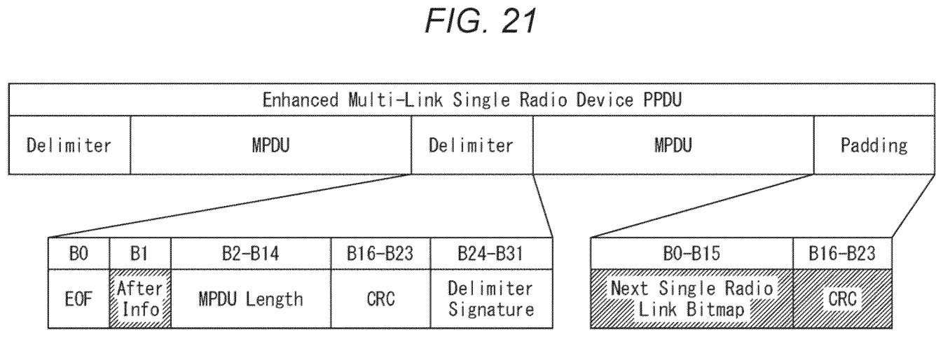

FIG. 21 is a diagram illustrating a second configuration example of the A-MPDU frame of the second embodiment of the present technology.

The A-MPDU frame in FIG. 21 is different from the A-MPDU frame in FIG. 20 in the configuration of Padding.

In FIG. 21, the Padding includes Next Single Radio Link Bitmap bits (the 0th bit to the 15th bit) and CRC bits (the 16th bit to the 23rd bit).

The Next Single Radio Link Bitmap bits in FIG. 21 are Next Single Radio Link information in a bitmap format, and can notify the data reception side of up to 16 links.

That is, according to the configuration in FIG. 21, since notification of all the states of the Pre-Configure links can be performed in the bitmap format, the device on the data reception side that receives the Next Single Radio Link information can optimally select a link.

Note that, similarly to the example in FIG. 20, CRC may be added as necessary in order to reliably transmit the Next Single Radio Link information in FIG. 21.

Furthermore, when the Next Single Radio Link information and the CRC are included, the configuration is made as 24 bits (3 Bytes) information in total. In a case where the information length is longer than the bit length of the conventional Padding, that is, in a case where the conventional Padding is not included, and in a case where the Padding includes 1 Byte to 2 Bytes, the MPDU Length of the delimiter may be added so that the Next Single Radio Link information and the CRC fall within the Padding.

### <First Configuration of A-Control Field of any Frame>

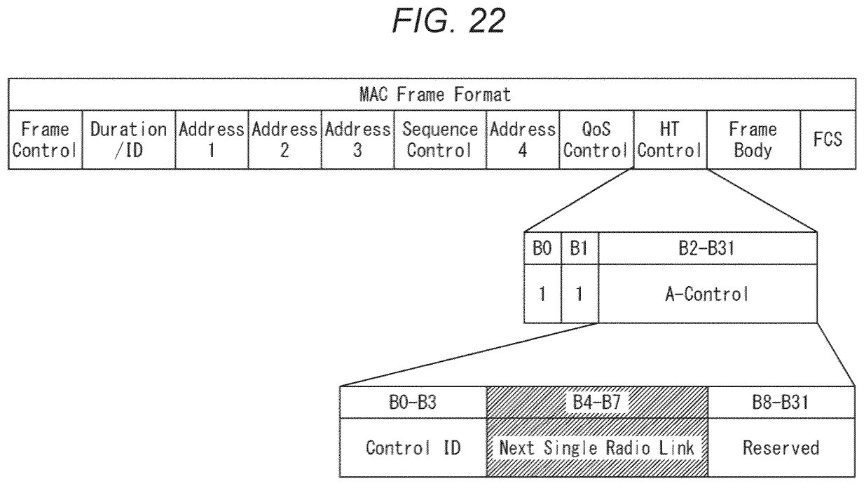

FIG. 22 is a diagram illustrating a first configuration example of an A-Control field of any frame.

FIG. 22 illustrates a configuration example of a frame in a case where notification of Next Single Radio Link information is performed by any frame including control information and the like other than the A-MPDU frame.

The frame in FIG. 22 includes fields of Frame Control, Duration/ID, Address1 to Address4, Sequence Control, QoS Control, HT Control, Frame Body, and FCS. Each field of Frame Control, Duration/ID, Address1 to Address4, Sequence Control, QoS Control, and HT Control is a MAC header portion.

The Frame Control field is information indicating a type of a frame.

The Duration/ID field is information indicating a duration or an identifier of a frame.

The Address1 to Address4 fields are a plurality of address fields indicating a transmission source and a reception destination.

The Sequence Control field is information indicating a sequence number of a frame.

The QoS Control field is a control parameter for QoS guarantee.

The HT Control field is a control parameter for high throughput.

The HT Control field includes the 0th bit, the 1st bit, and A-Control bits (the 2nd bit to the 31st bit).

The A-Control field is defined in the HT Control field for future extension, and in a case where the 0th bit and the 1st bit are 1, the 2nd bit to the 31st bit can be used as the A-Control field.

The A-Control field includes Control ID bits (the 0th bit to the 3rd bit), Next Single Radio Link bits (the 4th bit to the 7th bit), and Reserved bits (the 8th bit to the 31st bit).

The Control ID bit is information indicating that the Next Single Radio Link information is included.

The Next Single Radio Link bit is the Next Single Radio Link information.

Note that the Reserved bits (the 8th bit to the 31st bit), which are other portions, are reserved areas for future extension at the present time.

### <Second Configuration of A-Control Field of any Frame>

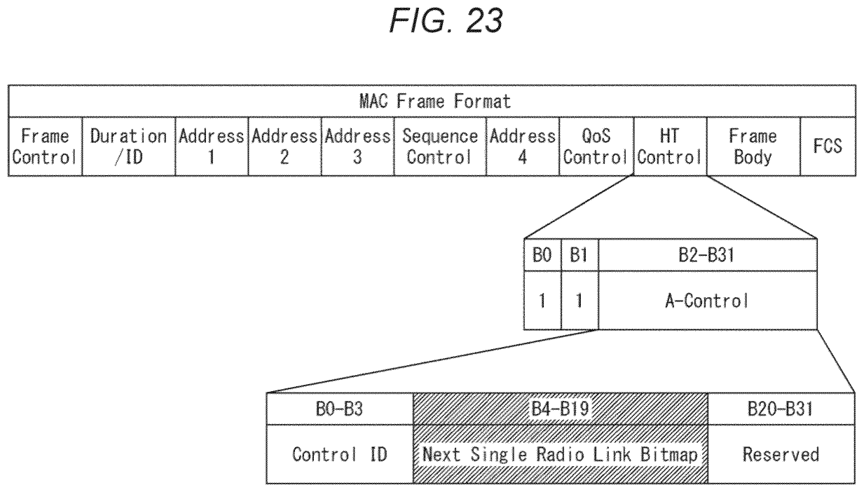

FIG. 23 is a diagram illustrating a second configuration example of the A-Control field of any frame.

The any frame in FIG. 23 is different from the any frame in FIG. 22 in the configuration of the A-Control field.

In FIG. 23, the A-Control field includes Control ID bits (the 0th bit to the 3rd bit), Next Single Radio Link Bitmap bits (the 4th bit to the 19th bit), and Reserved bits (the 20th bit to the 31st bit).

The Control ID bit is information indicating that the Next Single Radio Link information is included.

The Next Single Radio Link bitmap bits are the Next Single Radio Link information in Bitmap format.

Note that the Reserved bits (the 20th bit to the 31st bit) in FIG. 23 are reserved areas for future extension at the present time.

### <Configuration of Action Frame of Second Embodiment>

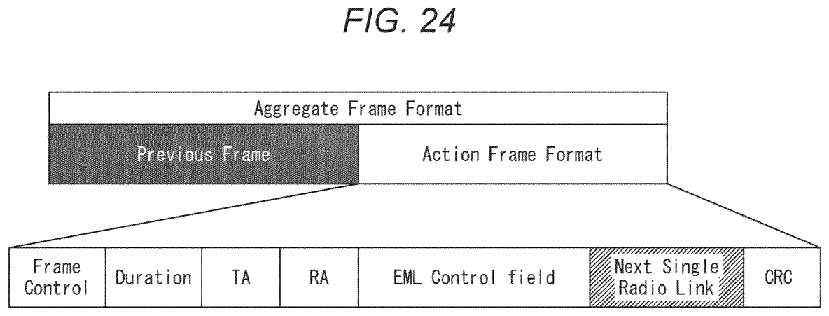

FIG. 24 is a diagram illustrating a configuration example of an aggregation frame of the second embodiment of the present technology.

FIG. 24 illustrates a configuration example of an Aggregation Frame in which, for example, an action frame (Action Frame) is added to any frame (Previous Frame).

The action frame is added to any frame. The frame in FIG. 24 is configured as an aggregation frame in which, for example, an EML Control Field and an action frame including Next Single Radio Link information of the present technology are combined with, for example, a conventional control frame (Control Frame).

The action frame includes fields of Frame Control, Duration, TA, RA, EML Control field, Next Single Radio Link that is a new field, and CRC.

The Frame Control, Duration, TA, and RA are similar to the Frame Control, Duration, TA, and RA included in the Single Radio Block ACK Frame in FIG. 9.

The EML Control field includes EMLSR Pre-Configure Link information.

The Next Single Radio Link is the Next Single Radio Link information of the present technology.

The CRC is an error detection code.

Note that, for the Next Single Radio Link information in FIG. 24, notification may be performed as a format for designating one link as described above, or notification may be performed of all available links in a bitmap format.

Alternatively, notification may be performed as the Next Single Radio Link information in which information on one link as the most likely candidate and information in a bitmap format indicating the other available links are combined.

Note that, in addition to the example in FIG. 24, required information may be appropriately added to configure an action frame.

Furthermore, the Aggregation Frame in FIG. 24 may be added to a data frame including the A-MPDU in a form of an action frame instead of being added to the control frame. Moreover, the action frame may independently perform notification of the Next Single Radio Link information without addition of the action frame to any frame as illustrated in FIG. 24.

### <Processing by AP in Second Embodiment>

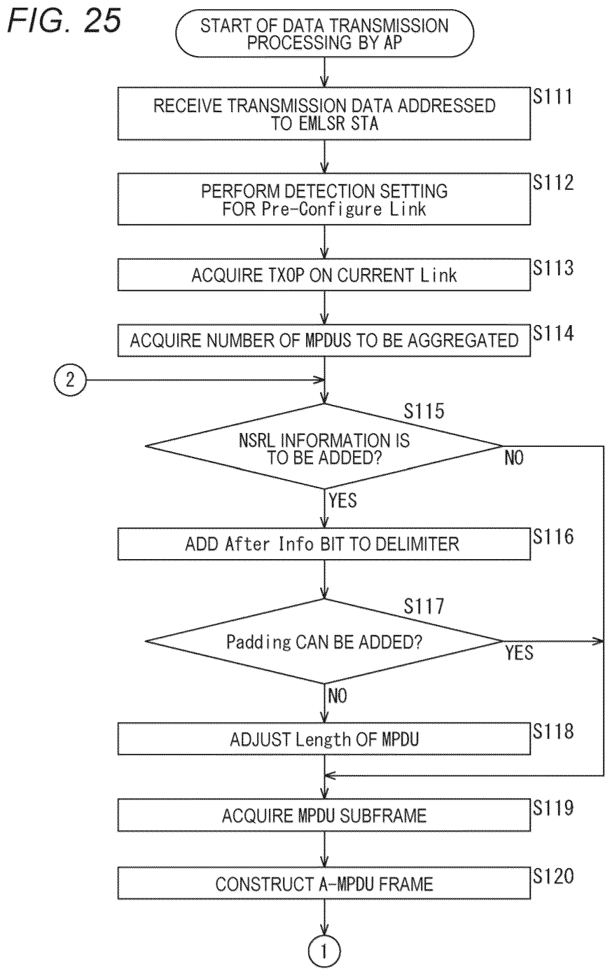

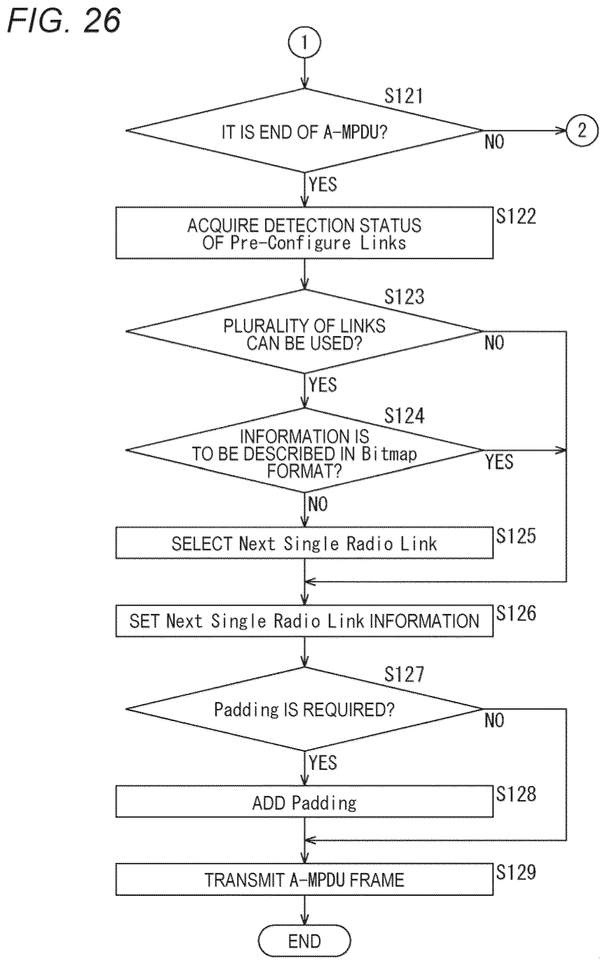

FIGS. 25 and 26 are flowcharts illustrating data transmission processing by the communication device (AP) on the data transmission side in the second embodiment of the present technology.

In step S111, the data construction unit 22 receives transmission data addressed to the EMLSR STA from the device control module 13 via the Data Buffer 21.

In step S112, the Multi-Link control unit 23 performs detection setting for grasping a usage status of the EMLSR STA in the Pre-Configure Link.

In step S113, the Multi-Link control unit 23 acquires a status of a transmission opportunity (TXOP) on the current link for data transmission, and specifies a duration in which transmission can be performed using the acquired link.

In step S114, the Multi-Link control unit 23 acquires the A-MPDU number, which is the number of MPDUS to be aggregated.

In step S115, the Multi-Link control unit 23 determines whether or not Next Single Radio Link (NSRL) information of the present technology is to be added. In a case where it is determined in step S115 that the Next Single Radio Link information is to be added, the processing proceeds to step S116.

In step S116, the data construction unit 22 sets bits that are reserved in the conventional delimiter as After Info bits and adds the bits to the delimiter.

In step S117, the data construction unit 22 determines whether or not Padding can be added. In a case where it is determined in step S117 that the Padding cannot be added, the processing proceeds to step S118.

In step S118, the data construction unit 22 adjusts the Length of the MPDU so that the Next Single Radio Link information can be included in a frame. Thereafter, the processing proceeds to step S119.

Furthermore, also in a case where it is determined in step S115 that the Next Single Radio Link information is not to be added or in a case where it is determined in step S117 that the Padding can be added, the processing proceeds to step S119.

In step S119, the data construction unit 22 acquires one MPDU subframe.

In step S120, the data construction unit 22 constructs an A-MPDU frame. Thereafter, the process proceeds to step S121 in FIG. 26.

In step S121, the data construction unit 22 determines whether or not it is the end of the A-MPDU (frame) on the basis of the A-MPDU number. In a case where it is determined in step S121 that it is not the end of the A-MPDU, the processing returns to step S115, and the subsequent processing is repeated.

In a case where it is determined in step S121 that it is the end of the A-MPDU, the processing proceeds to step S122.

In step S122, the Pre-Configure Link determination unit 31 acquires a detection status of the Pre-Configure Links of the device itself.

In step S123, the Multi-Link control unit 23 determines whether or not a plurality of Single Radio Links can be used on the basis of the detection status of the Pre-Configure Links of the device itself. In a case where it is determined in step S123 that a plurality of Single Radio Links can be used, the processing proceeds to step S124.

In step S124, the Multi-Link control unit 23 determines whether or not information for notification of use of a plurality of Single Radio Links is to be described in Bitmap format. In a case where it is determined in step S124 that the information for notification of the use of the plurality of Single Radio Links is not to be described in Bitmap format, the processing proceeds to step S125.

In step S125, the Multi-Link control unit 23 selects one Next Single Radio Link. In this case, in step S126, the Multi-Link control unit 23 sets Next Single Radio Link information describing information indicating the selected link.

In a case where it is determined in step S123 that the plurality of links is not available, the processing in steps S124 and S125 is skipped, and the processing proceeds to step S126. In this case, in step S126, the Multi-Link control unit 23 sets Next Single Radio Link information describing information indicating one link.

In a case where it is determined in step S124 that the information for notification of the use of the plurality of Single Radio Links is to be described in Bitmap format, the processing proceeds to step S126. In this case, in step S126, the Multi-Link control unit 23 sets the Next Single Radio Link information in Bitmap format.

In step S127, the data construction unit 22 determines whether or not Padding for 4-byte alignment is required at the end of the A-MPDU. In a case where it is determined in step S127 that the Padding is required, the processing proceeds to step S128.

In step S128, the data construction unit 22 adds the Padding so that an alignment length is satisfied.

In a case where it is determined in step S127 that the Padding is not required, the processing in step S128 is skipped, and the processing proceeds to step S129.

In step S129, the Multi-Link control unit 23 controls the first data transmission block or the second data transmission block to transmit the constructed A-MPDU frame, and thereafter, the data transmission processing by the AP in FIGS. 25 and 26 ends.

### <Processing by EMLSR STA>

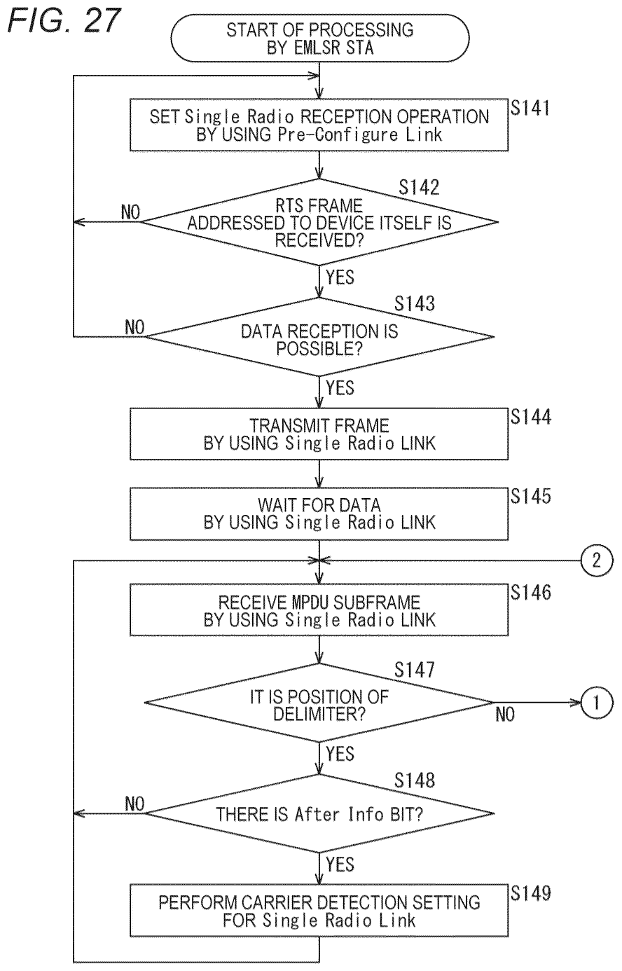

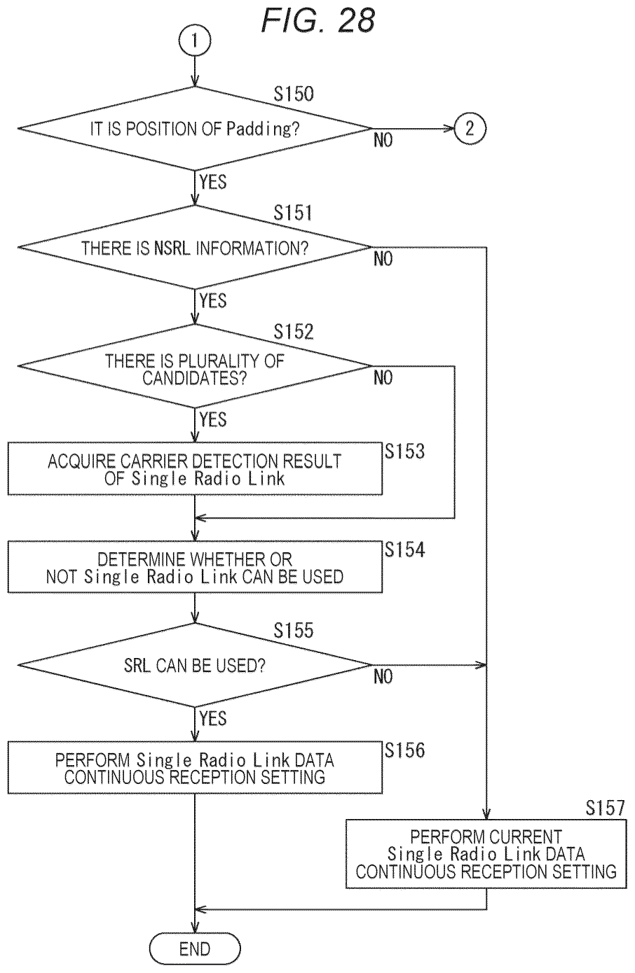

FIGS. 27 and 28 are flowcharts illustrating data reception processing by the EMLSR STA in the second embodiment of the present technology.

In step S141, the Single Radio control unit 56 of the EMLSR STA exchanges, for example, a predetermined frame with the communication device (AP) on the data transmission side to operate a link defined as a Pre-Configure Link, to set Single Radio reception operation.

In step S142, the Single Radio control unit 56 determines whether or not a Multi-User RTS frame (hereinafter, an RTS frame) is received as a control frame addressed to the device itself in any Pre-Configure link. In a case where it is determined in step S142 that the RTS frame addressed to the device itself is not received, the processing returns to step S141, and the subsequent processing is repeated.

In a case where it is determined in step S142 that the RTS frame addressed to the device itself is received, the processing proceeds to step S143.

In step S143, the Single Radio control unit 56 determines whether or not data reception is possible using the Single Radio link on which the RTS frame is received. In a case where it is determined in step S143 that the data reception is not possible, the processing returns to step S141, and the subsequent processing is repeated.

In a case where it is determined in step S143 that the data reception is possible, the processing proceeds to step S144.

In step S144, the Single Radio control unit 56 transmits the control frame (CTS frame) by using the Single Radio link on which the RTS frame is received.

In step S145, the Single Radio control unit 56 waits for data by using the Single Radio link.

In step S146, the Single Radio data processing unit 52 receives an MPDU subframe by using the Single Radio link.

In step S147, the Single Radio control unit 56 determines whether or not it is a position of a delimiter. In a case where it is determined in step S147 that it is the position of the delimiter, the processing proceeds to step S148.

In step S148, the Single Radio control unit 56 determines whether or not the After Info bit is in the delimiter. In a case where it is determined in step S148 that the After Info bit is in the delimiter, the processing proceeds to step S149.

In step S149, the Single Radio data processing unit 52 performs setting for grasping a usage status of the transmission path, such as carrier detection of the Single Radio Link. Thereafter, the processing returns to step S146, and the subsequent processing is repeated.

Also in a case where it is determined in step S148 that the After Info bit is not in the delimiter, the processing returns to step S146, and the subsequent processing is repeated.

On the other hand, in a case where it is determined in step S147 that it is not the position of the delimiter, the processing proceeds to step S150 in FIG. 28.

In step S150, the Single Radio control unit 56 determines whether or not it is a position of Padding. In a case where it is determined in step S150 that it is not the position of the Padding, the processing returns to step S146, and the subsequent processing is repeated.

In a case where it is determined in step S150 that it is the position of the Padding, the processing proceeds to step S151.

In step S151, the Single Radio control unit 56 determines whether or not Next Single Radio Link (NSRL) information is in the Padding. In a case where it is determined in step S151 that the Next Single Radio Link information is in the Padding, the processing proceeds to step S152.

In step S152, the Single Radio control unit 56 refers to the Next Single Radio Link information to determine whether or not there is a plurality of candidates. In a case where it is determined in step S152 that there is a plurality of candidates, for example, the Next Single Radio Link information is described in Bitmap format, or the like, the processing proceeds to step S153.

In step S153, the Pre-Configure Link determination unit 64 acquires a carrier detection result of the Single Radio link of the device itself. Thereafter, the processing proceeds to step S154.

Also in a case where it is determined in step S152 that there is no plurality of candidates, the processing proceeds to step S154.

In step S154, the Single Radio control unit 56 selects the optimum Single Radio Link, and determines whether or not the selected Single Radio Link can be used on the basis of the carrier detection result of the Single Radio Link of the device itself. Note that, also in a case where a specific link is designated instead of the Bitmap format, it is determined whether or not the designated Single Radio Link can be used.

In step S155, the Single Radio control unit 56 determines whether or not the Single Radio Link (SRL) is available. In a case where it is determined in step S155 that the Single Radio Link is available, the processing proceeds to step S156.

In step S156, setting is performed to continuously receive data by using the Single Radio Link that is available.

Furthermore, in a case where it is determined in step S155 that the Single Radio Link is not available, the processing proceeds to step S157.

In step S157, the Single Radio control unit 56 temporarily sets continuous reception of data using the current Single Radio Link, and prepares for next data transmission on the basis of a predetermined access control procedure.

After step S156 or S157, the data reception processing in FIGS. 27 and 28 ends.

### Effects of Second Embodiment

As described above, in the second embodiment of the present technology, by notifying the EMLSR STA of the Next Single Radio Link information, it is possible to specify a Link on which the EMLSR STA performs waiting, and to reduce redundant information exchange.

In particular, by including the Next Single Radio Link information at a timing during transmission of the A-MPDU Frame, it is possible to immediately notify the EMLSR STA on the data reception side of the latest status of the transmission path.

By including the Next Single Radio Link information in the delimiter and the Padding of the A-MPDU Frame, it is not necessary to use another frame for notification of an available link, and notification can be performed during data transmission.

Furthermore, by performing notification of the Next Single Radio Link information by using the A-Control field of the MAC header, it is possible to immediately perform notification of an accurate status of the latest transmission path at a return timing of any frame.

In a case where there is a plurality of available links (Next Single Radio Links), it is possible to give a room for selection to the data reception side by including the information in a bitmap format, and it is possible to select a link that is reliably used.

Since it is possible to omit a time required for exchanging the RTS frame and the CTS frame, which is redundant, related to a data transmission sequence of the EMLSR of a conventional method, the omitted time can be effectively utilized for a transmission opportunity (TXOP) for data transmission.

Moreover, the number of aggregates of the A-MPDU can be optimized in a limited TXOP on a certain link.

Furthermore, in a case where there is retransmission data or in a case where reception of data needs to be continued, even in a case where all data transmission is not completed in the TXOP of one link, switching to another link is performed immediately, whereby seamless data transmission can be performed.

In this way, by continuously using Multi-Link, it is possible to transmit Real-Time Application data seamlessly.

### 3. Third Embodiment (Combination of First Embodiment and Second Embodiment)

Next, as a third embodiment, an example will be described in which the first embodiment and the second embodiment described above are combined.

### <Configuration of System>

A system configuration of the third embodiment is similar to the system configuration of the first embodiment. Thus, hereinafter, the system configuration of the first embodiment described above with reference to FIG. 1 is also used as the system configuration of the third embodiment.

### <Operation of AP and EMLSR STA in Third Embodiment of Present Technology>

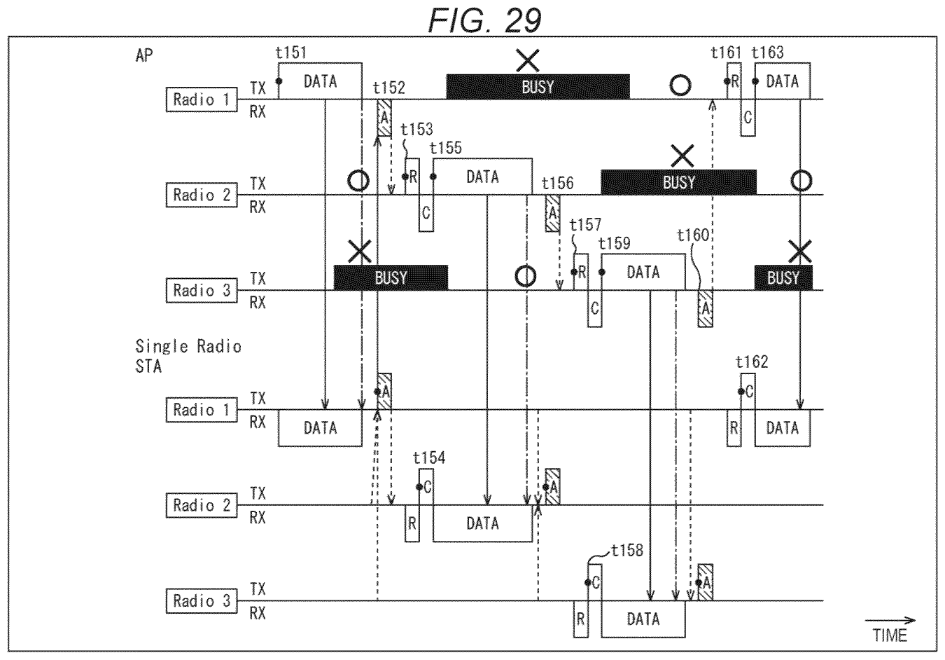

FIG. 29 is a diagram illustrating an operation sequence of the AP or the communication device on the data transmission side (indicated as AP in the figure) and the EMLSR STA in the third embodiment of the present technology.

Note that, in FIG. 29, as in FIG. 18, an arrow of a solid line represents transmission of control information included in a delimiter at the rear of a signal, and an arrow of a one-dot chain line represents transmission of control information included in Padding at the end of the signal.

The processing at a timing t151 in FIG. 29 is the same as the processing at the timing t101 in FIG. 18. That is, the AP acquires a state of the link immediately before the end of transmission of the A-MPDU during data transmission using Radio1, and determines a link available in the next data transmission. The AP describes Next Single Radio Link information, which is link information available for the next data transmission, in data being transmitted and transmits the data.

The EMLSR STA receiving data on Radio1 determines an available link of the EMLSR STA on the basis of a detection result of a usage status of Pre-Configure links during reception of the data or immediately after reception of the data. Note that the Next Single Radio Link information included in the data may also be referred to in the determination of the available link of the device itself. For example, in a case where it is determined that usage on Radio2 and Radio3 is possible, the EMLSR STA transmits a Block ACK frame including Available Single Radio Link information indicating Radio2 and Radio3 as available links to the AP at a timing t152.

The AP that has received the Block ACK frame specifies a link (Radio2) to which transition is to be performed next, in consideration of the Available Single Radio Link information included in the Block ACK frame and Next Single Radio Link information on the AP.

Accordingly, in the AP, information is obtained on a link to which the EMLSR STA on the data reception side can reliably transition, and the data transmission can be more reliably performed.

Similarly, also in the EMLSR STA, a link (Radio2) on which data transmission is to be continued can be specified on the basis of the Next Single Radio Link information on the AP on the data transmission side and the Available Single Radio Link information on the EMLSR STA, and for example, an RTS frame can be waited by using the Radio2 link.

At a timing t153, the AP transmits a Multi-User RTS frame (hereinafter, an RTS frame) as a control frame by using the Radio2 link.

The EMLSR STA that has received the RTS frame returns a CTS frame to the AP at a timing t154 in a similar manner as in the conventional method. As a result, the AP can continue data transmission to the EMLSR STA by using the link (Radio2) on which the RTS frame is received.

The AP that has received the CTS frame starts data transmission at a timing t155. The AP includes Next Single Radio Link information, which is link information available for the next data transmission, in data being transmitted and transmits the data.

The EMLSR STA receiving data on Radio2 determines links available to the EMLSR STA during reception of the data or immediately after reception of the data. For example, in a case where it is determined that usage on Radio1 and Radio3 is possible, the EMLSR STA transmits a Block ACK frame including Available Single Radio Link information indicating Radio1 and Radio3 as available links to the AP at a timing t156.

The AP that has received the Block ACK frame specifies a link (Radio3) to which transition is to be performed next, in consideration of the Available Single Radio Link information included in the Block ACK frame and Next Single Radio Link information on the AP.

At a timing t157, the AP transmits an RTS frame by using the Radio3 link.

The EMLSR STA that has received the RTS frame returns a CTS frame to the AP at a timing t158 in a similar manner as in the conventional method. As a result, the AP can continue data transmission to the EMLSR STA by using the link (Radio3) on which the RTS frame is received.

The AP that has received the CTS frame starts data transmission at a timing t159. The AP includes Next Single Radio Link information, which is link information available for the next data transmission, in data being transmitted and transmits the data.

The EMLSR STA receiving data on Radio2 determines links available to the EMLSR STA during reception of the data or immediately after reception of the data. For example, in a case where it is determined that usage on Radio1 and Radio3 is possible, the EMLSR STA transmits a Block ACK frame including Available Single Radio Link information indicating Radio1 and Radio3 as available links to the AP at a timing t160.

The AP that has received the Block ACK frame specifies a link (Radio1) to which transition is to be performed next, in consideration of the Available Single Radio Link information included in the Block ACK frame and Next Single Radio Link information on the AP.

At a timing t161, the AP transmits an RTS frame by using the Radio1 link.

The EMLSR STA that has received the RTS frame returns a CTS frame to the AP at a timing t162 in a similar manner as in the conventional method. As a result, the AP can continue data transmission to the EMLSR STA by using the link (Radio1) on which the RTS frame is received.

The AP that has received the CTS frame starts data transmission at a timing t163. The AP includes Next Single Radio Link information, which is link information available for the next data transmission, in data being transmitted and transmits the data.

As described above, by sharing the link information available to both the data transmission side and the data reception side, it is possible to more reliably specify the link to which transition is to be performed.

Then, the AP can transmit, for example, an RTS frame on the link available to both. Furthermore, the EMLSR STA can continue data transmission in a link on which the RTS frame is received, for example, by returning a CTS frame.

By repeating such operation, for example, even in a case where it is necessary to retransmit undelivered data, the retransmission of the data can be immediately performed using the next available link.

Note that, although an implementation example is described here in which the RTS frame and the CTS frame are exchanged as the control information, in a case where a reliable link is specified by the data transmission side and the data reception side, the data transmission may be performed without exchanging these control frames.

On the basis of the above description, details of the third embodiment of the present technology will be described below.

### <Configuration of Wireless Communication Device>

A device configuration of the third embodiment is similar to the device configuration of the first embodiment. Thus, hereinafter, the device configuration of the first embodiment described above with reference to FIGS. 5, 6, and 7 is also used as the device configuration of the third embodiment.

Note that, in the configuration (FIG. 6) of the wireless communication module of the device operating as the communication device (AP) on the data transmission side of the third embodiment of the present technology, in particular, processing of receiving a Single Radio Block ACK Frame is performed by the first data reception block, for example, in a case where the Single Radio Block ACK Frame is received by using the Radio1 link.

In this case, the waveform of the signal is detected by the Multi-Link RF detection unit 27-1, the baseband signal is extracted from the detected waveform by the Multi-Link PHY reception unit 28-1, and the predetermined frame in the channel of the baseband signal is detected by the Multi-Link MAC determination unit 29-1. Through the above processing, the Multi-Link control unit 23 recognizes that the Single Radio Block ACK Frame is received as one of the control frames.

Furthermore, in a case where information on Available Single Links is included in the Single Radio Block ACK Frame, the Pre-Configure Link determination unit 31 notifies the Multi-Link control unit 23 of the fact, and the Multi-Link control unit 23 specifies a link (Radio) available to the EMLSR STA and controls communication on the specified link (Radio).

In a case where the Next Single Radio Link information is included in the Padding of the A-MPDU frame, the Multi-Link control unit 23 constructs the Next Single Radio Link information on the basis of the information on the available link supplied from the Pre-Configure Link determination unit 31, replaces the Padding, and transmits the Next Single Radio Link information.

Furthermore, in a case where information indicating that the Next Single Radio Link information is described in the Padding is included in the last delimiter of the A-MPDU frame, the multi-link control unit 32 constructs the information indicating that the Next Single Radio Link information is included in the Padding, replaces the last delimiter, and transmits the information.

In particular, in the configuration (FIG. 7) of the wireless communication module of the device operating as the EMLSR STA of the third embodiment of the present technology, processing of transmitting the Single Radio Block ACK Frame is executed by the data transmission block under the control of the Single Radio control unit 56.

That is, the transmission data is constructed as a Control Frame by the Single Radio MAC processing unit 53, converted into a baseband signal by the Single Radio PHY transmission unit 54, subjected to radio frequency processing by the Single Radio RF signal processing unit 55, and transmitted from the antenna.

The processing of receiving the A-MPDU frame is executed by the data reception block under the control of the Single Radio control unit 56.

That is, the waveform of the received data portion is detected by the Single Radio RF signal detection unit 69 from a signal received by the antenna, reception processing for a predetermined A-MPDU frame in a channel of Single Radio is executed by the Single Radio PHY reception unit 68 on a baseband signal extracted from the detected waveform, and information on a delimiter is analyzed by the Single Radio MAC determination unit 67 to separate an MPDU portion.

Here, in a case where the Next Single Radio Link information is included in the delimiter transmitted from the AP, the Next Single Radio Link information is supplied to the Single Radio control unit 56.

### <Fourth Configuration of Single Radio Block ACK Frame>

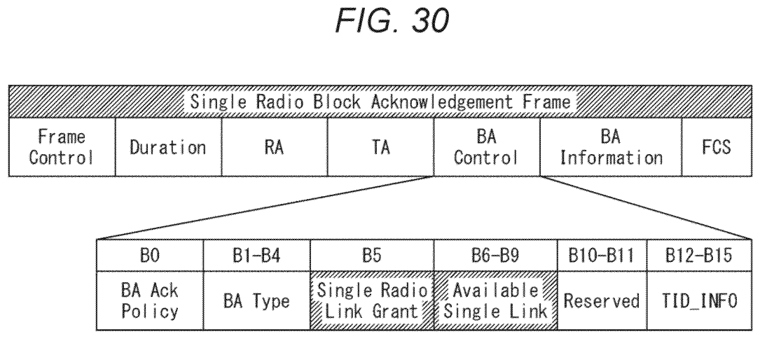

FIG. 30 is a diagram illustrating a fourth configuration example of the Single Radio Block ACK Frame.

The Single Radio Block ACK Frame in FIG. 30 is different from the Single Radio Block ACK Frame in FIG. 9 in the configuration of the BA Control Field.

The BA Control Field includes a BA ACK Policy bit (the 0th bit), BA Type bits (the 1st bit to the 4th bit), a Single Radio Link Grant bit (the 5th bit), Available Single Link bits (the 6th bit to the 9th bit), Reserved bits (the 10th bit and the 11th bit), and TID INFO bits (the 12th bit to the 15th bit).

The Single Radio Link Grant bit is information indicating necessity of the Next Single Radio Link of which notification is performed from the AP on the data transmission side. Note that, in a case where the Block ACK frame has a minimum necessary configuration, the Block ACK frame only needs to include the Single Radio Link Grant bit, but may include the Available Single Link bits.

The Available Single Link bits are Available Single Radio Link information indicating available links.

In other words, in a case where a plurality of links available for the next data frame is designated from the AP on the data transmission side by the Available Single Link bits, it is possible to perform notification of one link as an Available Single Radio Link on which both sides can agree, in consideration of links also available to the EMLSR STA on the data reception side.

### <Processing by AP>

Since data transmission processing by the AP in the third embodiment of the present technology is basically similar to the data transmission processing by the AP in the second embodiment described above with reference to FIGS. 25 and 26, the description thereof will be omitted.

### <Processing by STA>

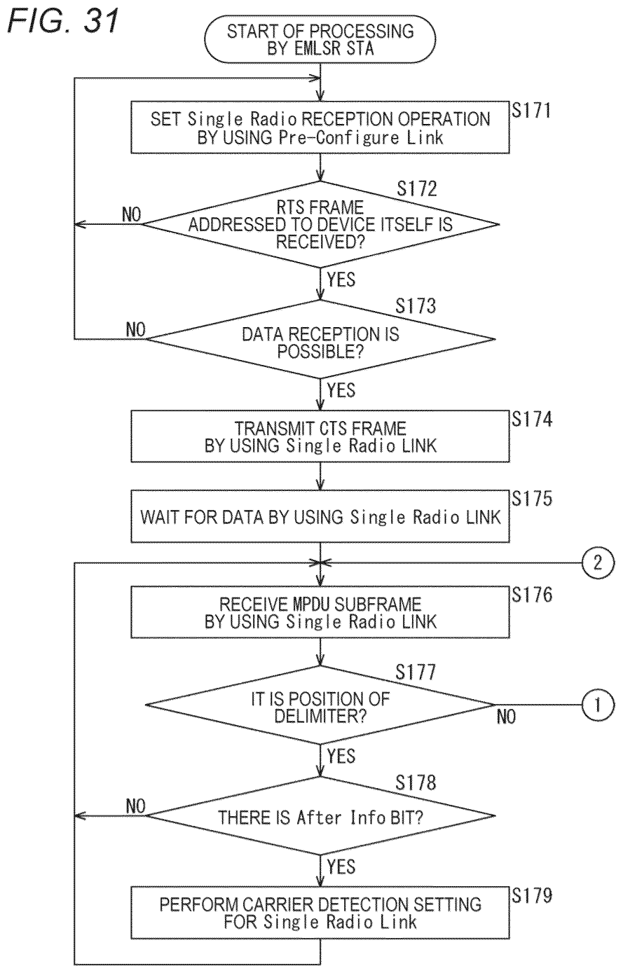

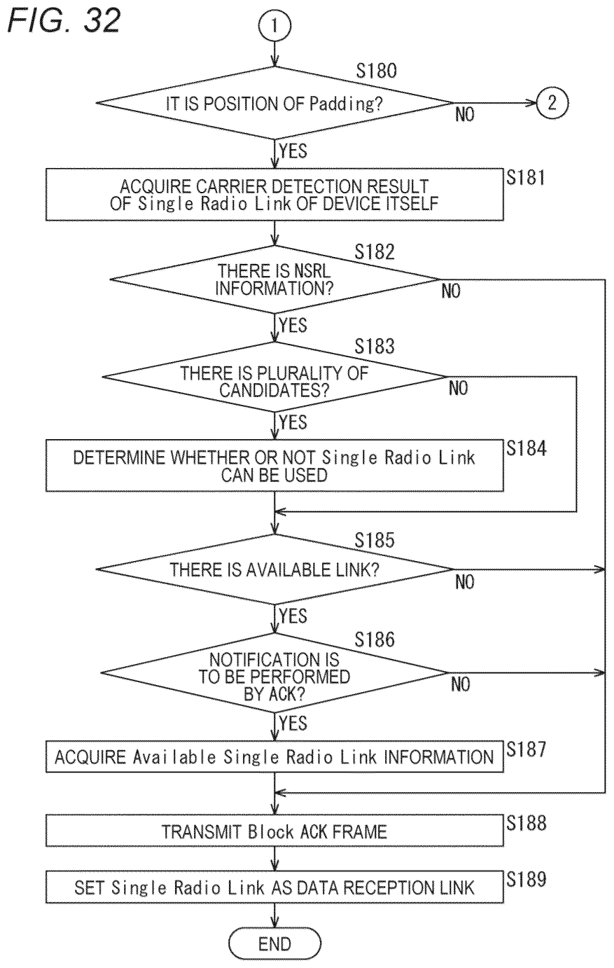

FIGS. 31 and 32 are flowcharts illustrating data reception processing by the EMLSR STA in the third embodiment of the present technology.

Note that the processing in steps S171 to S180 in FIGS. 31 to 32 is similar to the processing in steps S141 to S150 in FIGS. 27 and 28, and thus the description thereof will be omitted.

In step S181 in FIG. 32, the Pre-Configure Link determination unit 64 acquires a carrier detection result of the Single Radio Link of the device itself.

In step S182, the Single Radio control unit 56 determines whether or not Next Single Radio Link information is in the Padding. In a case where it is determined in step S182 that the Next Single Radio Link information is in the Padding, the processing proceeds to step S183.

In step S183, the Single Radio control unit 56 refers to the Next Single Radio Link information to determine whether or not there is a plurality of candidates. In a case where it is determined in step S183 that there is a plurality of candidates, for example, the Next Single Radio Link information is described in Bitmap format, or the like, the processing proceeds to step S184.

In step S184, the Pre-Configure Link determination unit 64 selects an optimum Single Radio Link, and determines whether or not the selected Single Radio Link can be used. Thereafter, the processing proceeds to step S185.

Also in a case where it is determined in step S183 that there is no plurality of candidates, the processing proceeds to step S185.

In step S185, the Pre-Configure Link determination unit 64 determines whether or not there is an available link. Note that, also in a case where a specific link is designated instead of the Bitmap format, it is determined whether or not the designated Single Radio Link can be used. In a case where it is determined in step S185 that there is an available link, the processing proceeds to step S186.

In step S186, the Single Radio control unit 56 determines whether or not to perform notification while including an available link in ACK. In a case where it is determined in step S186 that the notification is to be performed by the ACK, the processing proceeds to step S187.

In step S187, the Single Radio control unit 56 acquires Available Single Radio Link information to perform notification while including the information in the ACK. Thereafter, the processing proceeds to step S188.

In a case where it is determined in step S182 that the Next Single Radio Link information is not in the Padding, the processing in steps S182 to S187 is skipped, and the processing proceeds to step S188.

Also in a case where it is determined in step S185 that there is no available link, or in a case where it is determined in step S186 that the notification while including the information in the ACK is not to be performed, the processing also proceeds to step S188.

In step S188, the Single Radio control unit 56 transmits a Block ACK frame. Note that, in a case where the Available Single Radio Link information is acquired in step S187, the Block ACK frame to be transmitted includes the Block ACK frame.

In step S189, the Single Radio control unit 56 sets the Single Radio Link as a data reception link.

Note that, in a case where an available link is set, transition may be performed to the set link and waiting maybe performed for data transmission by using the link to which the transition is performed, or waiting may be performed for data transmission by using the currently used link. Alternatively, waiting for data transmission may be performed by using any link. Thereafter, the data reception processing in FIGS. 31 and 32 ends.

### Effects of Third Embodiment

As described above, in the third embodiment of the present technology, the technology in the first embodiment and the technology in the second embodiment are combined.

As a result, effects similar to the effects of the first embodiment and the second embodiment described above can be obtained.

In addition, since the link information available to both the data transmission side and the data reception side is shared, it is possible to more reliably specify the link to which transition is to be performed.

### 4. Fourth Embodiment (Quick Reserve Single Radio Control Frame)

Next, as a fourth embodiment, an example will be described in which notification of information for securing a transmission opportunity in advance is performed from the EMLSR STA on the data reception side on an available link.

### <Configuration of System>

A system configuration of the fourth embodiment is similar to the system configuration of the first embodiment. Thus, hereinafter, the system configuration of the first embodiment described above with reference to FIG. 1 is also used as the system configuration of the fourth embodiment.

### <Operation of EMLSR STA in Fourth Embodiment of Present Technology>

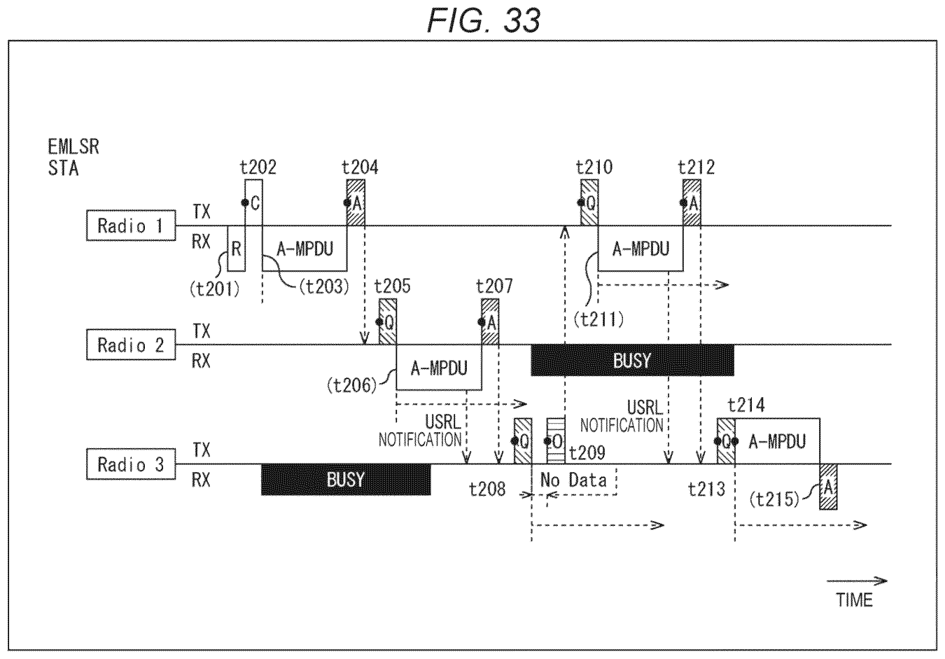

FIG. 33 is a diagram illustrating an operation sequence of the EMLSR STA in the fourth embodiment of the present technology.

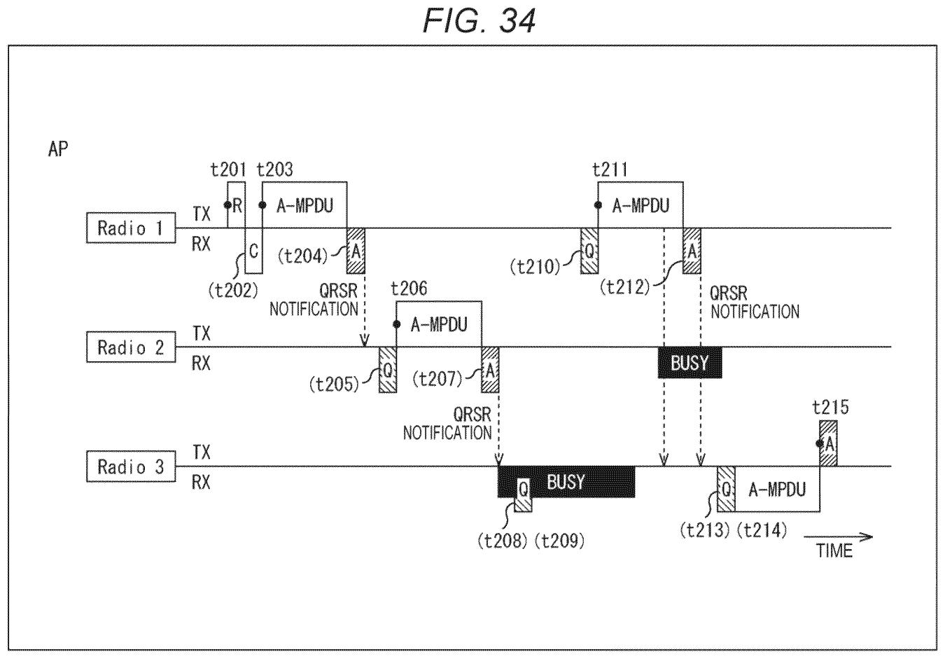

In FIG. 33, operation timings of the AP are indicated with parentheses. Note that, in the description of operation of the EMLSR STA in FIG. 33, operation timings of the communication device (AP) on the data transmission side illustrated in FIG. 34 are appropriately referred to.

At a timing t201, the EMLSR STA receives a Multi-User RTS frame (hereinafter, an RTS frame) as a control frame transmitted by the AP by using Radio1. At a timing t202, the EMLSR STA transmits a CTS frame to the AP by using Radio1.

At a timing t203, the EMLSR STA starts to receive data transmitted by the AP by using Radio1.

After receiving the data, at a timing t204, the EMLSR STA transmits a Block ACK Frame by using Radio1.

At this time, in a case where it is desired to continue data reception, the EMLSR STA transitions to a link (Radio2) for which a use opportunity is desired to be secured in advance at a timing t205, and transmits a Quick Reserve Single Radio Control Frame (Q in the figure) including use reservation information for securing the use opportunity in advance in Radio2 by using Radio2. The link for which the use opportunity is desired to be secured in advance is, that is, a link for which securing the use opportunity in advance is indicated by the use reservation information.

Note that, prior to the transmission of the Quick Reserve Single Radio Control Frame, Quick Reserve Single Radio information indicating that the EMLSR STA operates on Radio2, which is a link for which the use opportunity is desired to be secured in advance, may be added to the Block ACK Frame to be returned by using Radio1, and the AP that has transmitted the data may be notified of the Block ACK Frame.

Here, in a case where the AP on the data transmission side operates in multi-link, since reception can be performed in any link (Radio), the AP can receive the Quick Reserve Single Radio Control Frame by using any link.

As a result, since the operation of Single Radio by the EMLSR STA is continued by using the link (Radio2) for which the EMLSR STA desires to secure the use opportunity in advance, the AP on the data transmission side can transmit a data frame of the A-MPDU at a timing t206 without exchanging control frames.

Note that, as described above, by receiving the Block ACK Frame including the Quick Reserve Single Radio information in advance, the AP can grasp in advance a link (Radio) on which the EMLSR STA operates in Single Radio.

On the other hand, after transmitting the Quick Reserve Single Radio Control Frame, the EMLSR STA can receive the A-MPDU frame by using the same link as the link on which the Quick Reserve Single Radio Control Frame is transmitted. As a result, it is possible to shorten a time required for exchanging the control frames of the RTS frame and the CTS frame, which is necessary in the conventional method.

Furthermore, in the A-MPDU frame transmitted from the AP on the data transmission side, Useful Single Radio Link (USRL) information is included in a delimiter of the last MPDU, or the like.

By acquiring the Useful Single Radio Link information, the EMLSR STA can determine Link information on a valid Single Radio at a time when the Useful Single Radio Link information is acquired. That is, the EMLSR STA can specify a link (Radio) on which the Quick Reserve Single Radio Control Frame is to be transmitted, by the Useful Single Radio Link information.

After receiving the data, at a timing t207, the EMLSR STA transmits a Block ACK Frame to the AP by using Radio2.

On the basis of the Useful Single Radio Link information, it can be grasped that it is possible to transition to Radio3 and continue data transmission after the operation using Radio2, so that the EMLSR STA transmits a Quick Reserve Single Radio Control Frame by using Radio3 at a timing t208.

However, immediately before the transmission by the AP on the data transmission side, in a case where another communication device starts data transmission by using Radio3 and the AP enters the BUSY state, the AP cannot correctly receive the Quick Reserve Single Radio Control Frame. Thus, an A-MPDU frame that is data is not transmitted from the AP.

The EMLSR STA defines in advance Open Duration information in the above-described Quick Reserve Single Radio Control Frame. The Open Duration information is information indicating a valid period of the use opportunity.

If the A-MPDU Frame is not transmitted by the valid period indicated by the Open Duration information, the EMLSR STA generates an Open Reserve Single Radio Control Frame (O in the figure) indicating cancellation of use of Radio3 at a timing t209, and transmits the Open Reserve Single Radio Control Frame to the AP by using Radio3. As a result, it is possible to open the use opportunity for the Radio3 link.

At this time, if another link (Radio1) can be used, the EMLSR STA transitions to Radio1 and transmits a Quick Reserve Single Radio Control Frame at a timing t210.

Accordingly, since the operation of Single Radio by the EMLSR STA is continued on another link (Radio1), the AP on the data transmission side can transmit the A-MPDU frame that is a data frame at a timing t211 without exchanging the control frames.

Immediately after transmitting the Quick Reserve Single Radio Control Frame, the EMLSR STA receives the A-MPDU Frame by using Radio1, and transmits a Block ACK Frame by using Radio1 at a timing t212.

In a case where data transmission is performed to the AP on the data transmission side after receiving the A-MPDU Frame, the EMLSR STA can also transmit a Quick Reserve Single Radio Control Frame by using Radio1 at a timing t213, and transmit an A-MPDU Frame by using Radio1 at a subsequent timing t214.

In this case, at a timing t215 after data reception, the AP transmits a Block ACK Frame to the EMLSR STA by using Radio1.

### <Operation of Communication Device (AP) on Data Transmission Side in Fourth Embodiment of Present Technology>

FIG. 34 is a diagram illustrating an operation sequence of the communication device (AP) on the data transmission side in the fourth embodiment of the present technology, corresponding to the operation sequence of the EMLSR STA in FIG. 33.

In FIG. 34, operation timings of the EMLSR STA are indicated with parentheses. Note that, in the description of operation of the AP in FIG. 34, the operation timings of the EMLSR STA illustrated in FIG. 33 are referred to.

At the timing t201, the AP transmits the Multi-User RTS frame (hereinafter, the RTS frame) as a control frame to the EMLSR STA by using Radio1. At the timing t202, the AP receives the CTS frame transmitted from the EMLSR STA by using Radio1.

At the timing t203, the AP starts to transmit an A-MPDU frame that is a data frame to the EMLSR STA by using Radio1.

After transmitting the data, the AP receives the Block ACK Frame transmitted from the EMLSR STA at the timing t204 by using Radio1.

Here, in a case where the Block ACK Frame transmitted from the EMLSR STA includes information (Quick Reserve Single Radio information) on a link for transmitting the Quick Reserve Single Radio Control Frame, the AP grasps that data transmission continues to be performed by using the link (Radio2).

Accordingly, the AP on the data transmission side can receive the Quick Reserve Single Radio Control Frame transmitted from the EMLSR STA by using Radio2 at the timing t205, and can transmit the A-MPDU Frame by using Radio2 at the timing t206.

As a result, it is possible to immediately continue data transmission without exchanging the control frames of the RTS frame and the CTS frame, which is necessary in the conventional method. As a result, an overhead time can be shortened.

After transmitting the data, the AP receives the Block ACK Frame transmitted from the EMLSR STA at the timing t207 by using Radio2.

Here, in a case where the Block ACK Frame transmitted from the EMLSR STA includes information (Quick Reserve Single Radio information) on a link for transmitting the Quick Reserve Single Radio Control Frame, the AP grasps that data transmission continues to be performed by using the link (Radio3).

However, immediately before reception of the Quick Reserve Single Radio Control Frame, data transmission by another communication device may start, and the AP may enter the BUSY state. In this case, since the Quick Reserve Single Radio Control Frame transmitted from the EMLSR STA cannot be received, the AP cannot transmit the A-MPDU Frame by using Radio3.

On the other hand, since the EMLSR STA can grasp the situation in which the transmission of the A-MPDU Frame is not started, the Open Reserve Single Radio Control Frame (O in the figure) is transmitted by the EMLSR STA at the timing t209. Then, at the timing t210, the Quick Reserve Single Radio Control Frame is transmitted by the EMLSR STA by using another link (Radio1).

Here, in a case where the AP on the data transmission side operates in multi-link, since reception can be performed in any link (Radio), the AP can receive the Quick Reserve Single Radio Control Frame by using any link.

As a result, since the operation of Single Radio by the EMLSR STA is continued by using another link (Radio1), the AP on the data transmission side can transmit the A-MPDU frame by using Radio1 without exchanging conventional control frames at the timing t211.

After transmitting the A-MPDU Frame on the link (Radio1), the AP receives the Block ACK Frame transmitted from the EMLSR STA at the timing t212. Moreover, in a case where there is a desire for a link to be subsequently used by the EMLSR STA, the EMLSR STA includes information (Quick Reserve Single Radio information) on a link for transmitting the Quick Reserve Single Radio Control Frame in the Block ACK Frame.

That is, since it can be seen on the basis of the Quick Reserve Single Radio information that the EMLSR STA desires to subsequently use another link (Radio3), the AP receives the Quick Reserve Single Radio Control Frame transmitted from the EMLSR STA by using Radio3 at the timing t213.

Then, in a case where the AP on the data transmission side does not have transmission data, the AP subsequently receive the A-MPDU frame transmitted from the EMLSR STA at the timing t214.

In this case, at the timing t215, the AP transmits the Block ACK Frame that is a reception confirmation response frame corresponding to the A-MPDU Frame transmitted from the EMLSR.

As described above, by transmitting and receiving the Quick Reserve Single Radio Control Frame, the EMLSR STA can secure a use opportunity for a link (Radio) to be subsequently used for transmission.

That is, a device on the data reception side transitions to one of available Pre-Configure Links immediately after the end of the reception of the data addressed to the device itself, and transmits a control frame indicating that the use opportunity is to be secured in advance before the control frame is transmitted from the device on the data transmission side on the new link. As a result, a link used as Single Radio can be secured in advance.

Note that, in a case where data transmission is not performed when a predetermined time elapses on a desired Pre-Configure Link, a control frame for opening the link of Single Radio secured in advance is transmitted from the device on the data reception side.

That is, surrounding communication devices that have received the control frame for securing the use opportunity in advance and the control frame for opening the secured use opportunity can grasp that Single Radio reception is to be performed, and can also grasp that the Single Radio reception ends or is interrupted.

Moreover, in a case where one of the available Pre-Configure Links is selected, a device that is transmitting data may include information indicating Radio to be used for transmission of next Single Radio in the data frame that is being transmitted.

On the basis of the above description, details of the fourth embodiment of the present technology will be described below.

### <Configuration of Wireless Communication Device>

A device configuration of the fourth embodiment is similar to the device configuration of the first embodiment. Thus, hereinafter, the device configuration of the first embodiment described above with reference to FIGS. 5, 6, and 7 is also used as the device configuration of the fourth embodiment.

Note that, in the configuration (FIG. 6) of the wireless communication module of the device operating as the communication device (AP) on the data transmission side of the fourth embodiment of the present technology, in particular, processing of receiving a Quick Reserve Single Radio Control Frame can be performed on any link as long as the transmission path is not in the BUSY state. For example, in a case where the Quick Reserve Single Radio Control Frame is received on the Radio1 link, the processing is performed by the first data reception block.

In this case, the waveform of the signal is detected by the Multi-Link RF detection unit 27-1, the baseband signal is extracted from the detected waveform by the Multi-Link PHY reception unit 28-1, and the predetermined frame in the channel of the baseband signal is detected by the Multi-Link MAC determination unit 29-1. Through the above processing, the Multi-Link control unit 23 recognizes that the Quick Reserve Single Radio Control Frame is received as one of the control frames.

Furthermore, in a case where Quick Reserve Single Radio information is included in a Block ACK Frame, the Pre-Configure Link determination unit 31 notifies the Multi-Link control unit 23 of the fact, and the Multi-Link control unit 23 specifies a link (Radio) available to the EMLSR STA and controls communication on the link (Radio).

In a case where Useful Single Radio Link information is included in the last delimiter of an A-MPDU frame, the multi-link control unit 32 constructs the information on the basis of information on the available link supplied from the Pre-Configure Link determination unit 31, replaces the last delimiter, and transmits the information.

Furthermore, in the configuration (FIG. 7) of the wireless communication module of the device operating as the EMLSR STA of the fourth embodiment of the present technology, processing of transmitting the Quick Reserve Single Radio Control Frame is executed by the data transmission block under the control of the Single Radio control unit 56.

That is, under the control of the Single Radio control unit 56, transmission data is constructed as a Control Frame by the Single Radio MAC processing unit 53, converted into a baseband signal by the Single Radio PHY transmission unit 54, subjected to radio frequency processing by the Single Radio RF signal processing unit 55, and transmitted from the antenna.

The processing of receiving the A-MPDU frame is executed by the data reception block under the control of the Single Radio control unit 56.

That is, the waveform of the received data portion is detected by the Single Radio RF signal detection unit 69 from a signal received by the antenna, and on a baseband signal extracted from the detected waveform, reception processing for a predetermined A-MPDU frame in a channel of Single Radio is executed by the Single Radio PHY reception unit 68. Thereafter, information on a delimiter is analyzed by the Single Radio MAC determination unit 67, and an MPDU portion is separated.

Here, in a case where the delimiter transmitted from the AP includes the Useful Single Radio Link information, the Useful Single Radio Link information is supplied to the Single Radio control unit 56. In the Single Radio control unit 56, control to determine a link for transmitting the Quick Reserve Single Radio Control Frame is performed, as necessary.

### <Configuration of Quick Reserve Single Radio Control Frame>

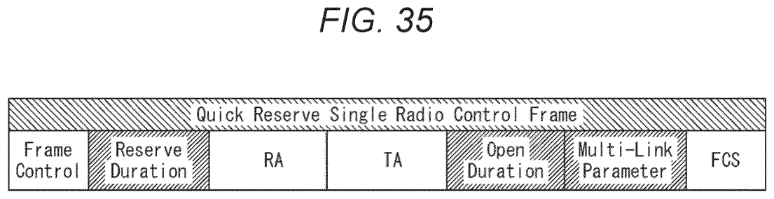

FIG. 35 is a diagram illustrating a configuration example of the Quick Reserve Single Radio Control Frame of the fourth embodiment of the present technology.

The Quick Reserve Single Radio Control Frame in FIG. 35 includes Frame Control, Reserve Duration, RA, TA, Open Duration, Multi-Link Parameter, and FCS.

The Frame Control is information indicating a type and a format of a frame.

The Reserve Duration is information indicating a maximum available time in this link.

The RA is identification information for identifying a device on the reception side.

The TA is identification information for identifying a device on the transmission side.

The Open Duration is information indicating a use opportunity valid period indicating a period until performing determination of opening without using this link.

The Multi-Link Parameter is a parameter required for Multi-Link operation.

The FCS is a frame check sequence of error detection.

Note that, in the Quick Reserve Single Radio Control Frame, the Frame Control to the TA are basic parameters, and the Open Duration and the Multi-Link Parameter are included in the Quick Reserve Single Radio Control Frame, as necessary. Furthermore, the Quick Reserve Single Radio Control Frame may include other parameters.

Moreover, in the RA and the TA, basically, identification information for identifying the RA and the TA of this control frame is described, but identification information for identifying the RA and the TA of a data frame to be transmitted next may be described. Furthermore, the identification information for the RA and the TA of this control frame may be described in the RA and the TA, and the identification information for the RA and the TA of the data frame to be transmitted next may be described in the Multi-Link Parameter.

In a case where the identification information for the RA and the TA of the frame to be transmitted next is described in the Multi-Link Parameter, as the identification information for the RA and the TA of the frame to be transmitted next, for example, information indicating whether the transmission direction is the same as that of the RA and the TA or whether the transmission direction is the reverse transmission direction may be described in the Multi-Link Parameter. Furthermore, in the Multi-Link Parameter, for example, the identification information for the RA and the TA of the frame to be transmitted next may be described as it is. The description method is not particularly limited.

### <Configuration of Open Reserve Single Radio Control Frame>

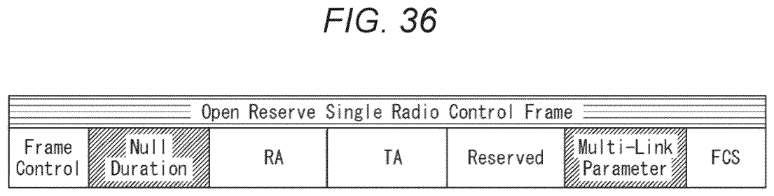

FIG. 36 is a diagram illustrating a configuration example of the Open Reserve Single Radio Control Frame.

The configuration of the Open Reserve Single Radio Control Frame in FIG. 36 is different from the configuration of the Quick Reserve Single Radio Control Frame in FIG. 35 only in that the Reserve Duration is replaced with Null Duration and the Open Duration is replaced with Reserved, and the other points are basically the same.

The Null Duration is information indicating that this link is in an open state.

The Reserved is a reserved area for the future.

### <Configuration of Frame of Fourth Embodiment>

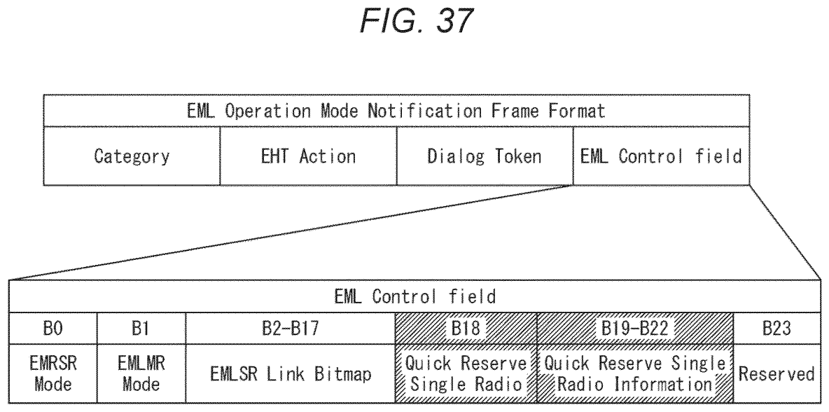

FIG. 37 is a diagram illustrating a configuration example of a frame of the fourth embodiment of the present technology.

The frame in FIG. 37 is a frame configured as an action frame or a management frame indicating compatibility with operation of transmitting a Quick Reserve Control Frame in order to secure a use opportunity in advance.

The EML Operation Mode Notification frame in FIG. 37 is different from the frame in FIG. 8 in the configuration of the EML Control Field.

The EML Control Field includes an EMLSR Mode bit (the 0th bit), an EMLMR Mode bit (the 1st bit), EMLSR Link Bitmap bits (the 2nd bit to the 17th bit), a Quick Reserve Single Radio bit (the 18th bit), Quick Reserve Single Radio Information bits (the 19th bit to the 22nd bit), and a Single Radio BA bit (the 23rd bit).

The Quick Reserve Single Radio bit is a bit indicating whether or not transmission can be performed of the Quick Reserve Control Frame for securing the use opportunity in advance.

The Quick Reserve Single Radio Information bits are information indicating a link (Radio) on which transmission is to be performed.

Note that, in addition to this action frame, the Quick Reserve Single Radio bit indicating whether or not transmission of the Quick Reserve Control Frame can be performed in order to secure the use opportunity in advance, and Quick Reserve Single Radio Information that is information indicating the link (Radio) on which transmission is to be performed may be exchanged between the AP and the EMLSR STA, as necessary.

### <Fourth Configuration of Single Radio Block ACK Frame>

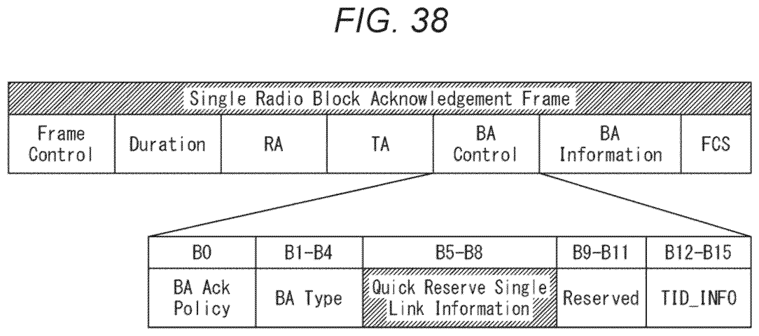

FIG. 38 is a diagram illustrating a fourth configuration example of the Single Radio Block ACK Frame.

The Single Radio Block ACK Frame in FIG. 38 is different from the Single Radio Block ACK Frame in FIG. 9 in the configuration of the BA Control Field.

The BA Control Field includes the BA ACK Policy bit (the 0th bit), the BA Type bits (the 1st bit to the 4th bit), the Quick Reserve Single Radio Information bits (the 5th bit to the 8th bit), the Reserved bits (the 9th bit to the 11th bit), and the TID INFO bits (the 12th bit to the 15th bit).

The Available Single Link bits are information for designating a link for transmitting the Quick Reserve Single Radio Control Frame.

In other words, the Single Radio Block ACK Frame in FIG. 38 is configured to be able to designate a link for transmitting a Control Frame by using the 5th bit to the 8th bit set as the reserved bits of the BA Control field as the Quick Reserve Single Radio Information bits while maintaining the conventional format of the Block ACK Frame.

### <Configuration of A-MPDU Frame>

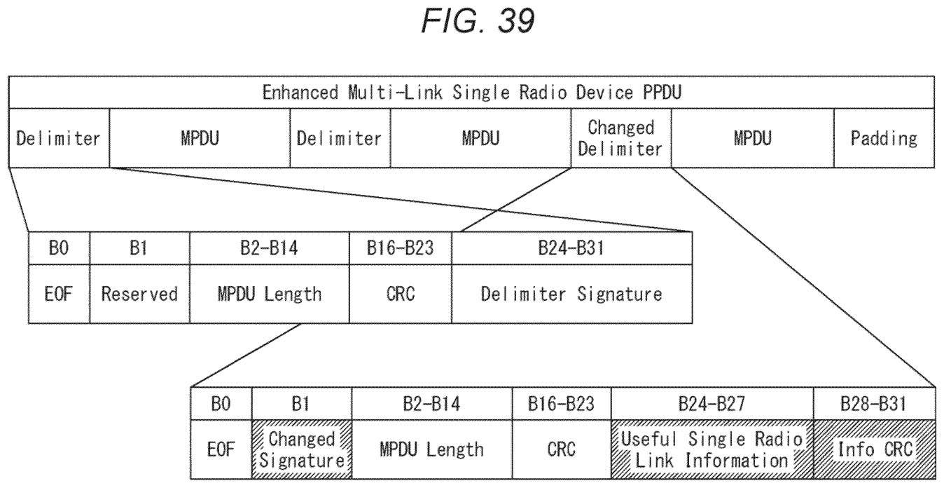

FIG. 39 is a diagram illustrating a configuration example of the A-MPDU frame of the fourth embodiment of the present technology.

Similarly to the A-MPDU frame in FIG. 20, the A-MPDU frame in FIG. 39 is configured by alternately aggregating a delimiter (Delimiter) indicating a boundary of a frame and a MAC Protocol Data Unit (MPDU) including actual data, and adding Padding to the end.

However, the A-MPDU frame in FIG. 39 is different in the configuration of the delimiter (Changed Delimiter in the figure) for the last MPDU.

That is, similarly to the conventional ones, delimiters from the head to one before the last include an EOF bit (the 0th bit), a Reserved bit (the 1st bit), MPDU Length bits (the 2nd bit to the 14th bit), CRC bits (the 16th bit to the 23rd bit), and Delimiter Signature bits (24th bit to 31st bit).

The Changed Delimiter includes the EOF bit (the 0th bit), a Changed Signature bit (the 1st bit), the MPDU Length bits (the 2nd bit to the 14th bit), the CRC bits (16th bit to the 23rd bit), Useful Single Radio Link Information bits (the 24th bit to the 27th bit), and Info CRC (the 28th bit to the 31st bit).

The Changed Signature bit is information indicating that Useful Single Radio Link Information is included in a portion corresponding to Delimiter Signature of the conventional Delimiter, in the Changed Delimiter.

The Useful Single Radio Link Information bits are information for notification of information on available links.

The Info CRC is information added as necessary to reliably transmit the Useful Single Radio Link Information.

That is, the EMLSR STA that has received the data can grasp that Useful Single Radio Link Information, which is additional information, is included in the last Delimiter Signature portion by the fact that the Changed Signature field is set to 1.

Note that, although FIG. 39 illustrates an example in which the Useful Single Radio Link Information bits are included in the last delimiter, the Useful Single Radio Link Information bits may be included in another delimiter.

### <Processing by Communication Device (AP) on Data Transmission Side in Fourth Embodiment of Present Technology>

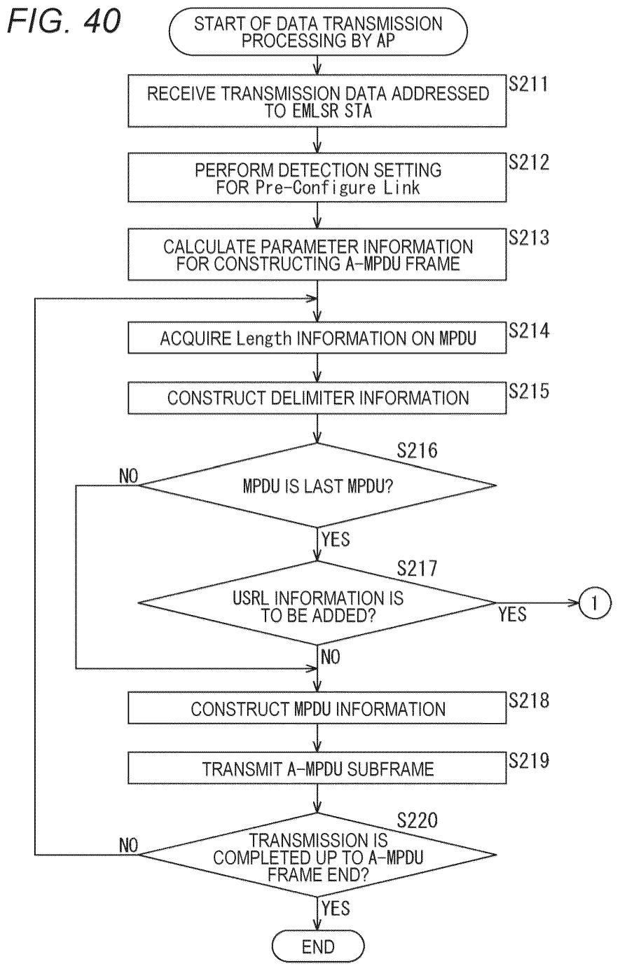

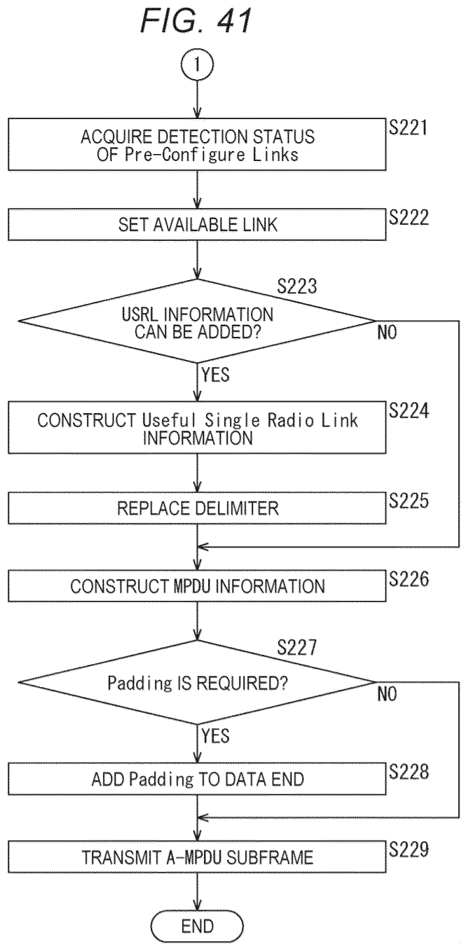

FIGS. 40 and 41 are flowcharts illustrating data transmission processing by the communication device (AP) on the data transmission side in the fourth embodiment of the present technology.

In step S211, the data construction unit 22 receives transmission data addressed to the EMLSR STA from the device control module 13 via the Data Buffer 21.

In step S212, the Multi-Link control unit 23 performs detection setting for grasping a usage status of a Single Radio STA in the Pre-Configure Link.

In step S213, the Multi-Link control unit 23 specifies a duration in which transmission can be performed on the current link on the basis of a status of a transmission opportunity (TXOP) on the current link, and calculates parameter information for constructing an A-MPDU frame. The parameter information is the number of MPDUs that can be aggregated as an A-MPDU, and the like.

In step S214, the data construction unit 22 acquires Length information on each MPDU.

In step S215, the data construction unit 22 constructs delimiter information on the basis of the acquired Length information.

In step S216, the data construction unit 22 determines whether or not an MPDU currently processed is the last MPDU constituting the A-MPDU. In a case where it is determined in step S216 that the MPDU is the last MPDU constituting the A-MPDU, the processing proceeds to step S217.

In step S217, the data construction unit 22 determines whether or not to add Usage Single Radio Link (USRL) information. In a case where it is determined in step S217 that the Usage Single Radio Link information is not to be added, the processing proceeds to step S218.

Also in a case where it is determined in step S216 that the MPDU is not the last MPDU constituting the A-MPDU, the processing proceeds to step S218.

In step S218, the data construction unit 22 constructs MPDU information. In step S219, the Multi-Link control unit 23 causes the first or second transmission block to sequentially perform transmission processing in which the MPDU constructed by the data construction unit 22 is a subframe of the A-MPDU.

Thereafter, in step S220, the Multi-Link control unit 23 determines whether or not transmission has been performed up to the end of the A-MPDU frame. In a case where it is determined in step S220 that transmission has been performed up to the end of the A-MPDU frame, the processing ends.

In a case where it is determined in step S220 that transmission has not been performed up to the end of the A-MPDU frame, the processing returns to step S214, and the subsequent processing is repeated.

In a case where it is determined in step S217 that the Usage Single Radio Link information is to be added, the processing proceeds to step S221 in FIG. 41.

In step S221, the Pre-Configure Link determination unit 31 acquires a detection status of the Pre-Configure Links of the device itself.

In step S222, the Pre-Configure Link determination unit 31 sets an available link from the strength of the noise level or the like on the basis of the detection status of the Pre-Configure Links of the device itself or the like.

In step S223, the Multi-Link control unit 23 determines whether or not the Usage Single Radio Link (USRL) information can be added. In a case where it is determined in step S223 that the Usage Single Radio Link information can be added, the processing proceeds to step S224.

In step S224, the data construction unit 22 constructs the Usage Single Radio Link information.

In step S225, the data construction unit 22 replaces the delimiter by using the constructed Usage Single Radio Link information. Thereafter, the processing proceeds to step S226.

In a case where it is determined in step S223 that the Usage Single Radio Link information cannot be added, the processing in steps S224 and S225 is skipped, and the processing proceeds to step S226.

In step S226, the data construction unit 22 constructs MPDU information.

In step S227, the data construction unit 22 determines whether or not Padding is required. In a case where the 4-octet alignment is not made, it is determined in step S226 that Padding is required, and the processing proceeds to step S228.

In step S228, the data construction unit 22 adds Padding to the end of the data. Thereafter, the processing proceeds to step S229.

In a case where it is determined in step S227 that Padding is not required, the processing in step S228 is skipped, and the processing proceeds to step S229.

In step S229, the Multi-Link control unit 23 causes the first or second transmission block to sequentially perform transmission processing in which the MPDU constructed by the data construction unit 22 is a subframe of the A-MPDU. Thereafter, the data transmission processing by the AP in FIGS. 40 and 41 ends.

### <Processing by EMLSR STA>

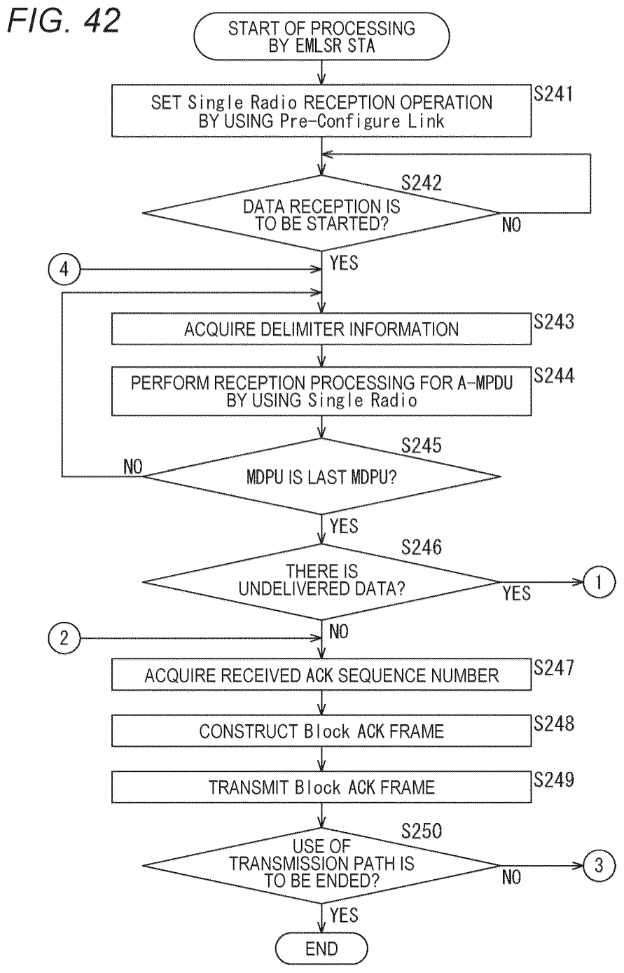

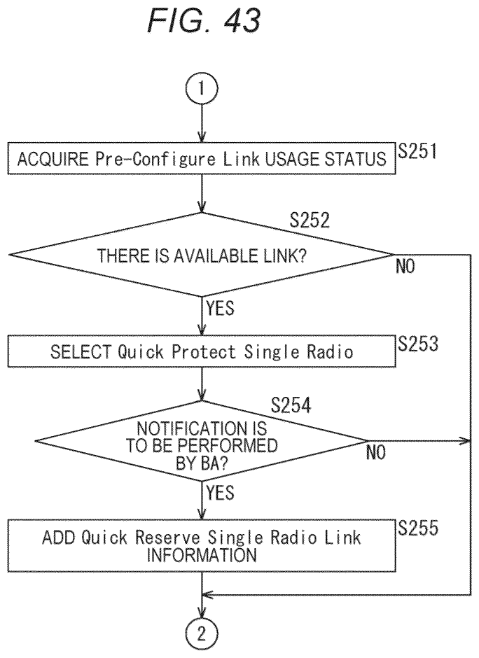

FIGS. 42 to 43 are flowcharts illustrating data reception processing by the EMLSR STA in the fourth embodiment of the present technology.

In step S241, the Single Radio control unit 56 of the EMLSR STA exchanges, for example, a predetermined action frame with the AP to operate a link defined as a Pre-Configure Link, to set Single Radio reception operation.

In step S242, the Single Radio control unit 56 determines whether or not to start data reception.

In step S242, the Single Radio control unit 56 waits until starting data reception. In a case where the Single Radio control unit 56 receives a control frame (RTS frame) on any Pre-Configure Link and then transmits a CTS frame, it is determined in step S242 that the data reception is to be started, and the processing proceeds to step S243.

In step S243, the Single Radio control unit 56 receives an A-MPDU frame and acquires delimiter information.

In step S244, the Single Radio control unit 56 performs reception processing for an A-MPDU by using Single Radio.

In step S245, every time a subframe (MPDU) of the A-MPDU is received, the Single Radio control unit 56 determines whether or not the subframe is the last MPDU. In a case where it is determined in step S245 that the subframe is not the last MPDU, the processing returns to step S243, and the subsequent processing is repeated.

In a case where it is determined in step S245 that the subframe is the last MPDU, the processing proceeds to step S246.

In step S246, it is determined whether or not there is undelivered data. In a case where it is determined in step S246 that there is no undelivered data, the processing proceeds to step S247.

In step S247, the Single Radio control unit 56 acquires a received ACK sequence number (S/N) information.

In step S248, the data construction unit 22 constructs a Block ACK frame on the basis of the acquired received ACK sequence number information.

In step S249, the data construction unit 22 transmits the constructed Block ACK frame.

In step S250, the Single Radio control unit 56 determines whether or not to end the use of the transmission path. In a case where it is determined in step S250 that the use of the transmission path is to be ended, the data reception processing by the EMLSR STA in FIGS. 42 to 44 ends.

On the other hand, in a case where it is determined in step S246 that there is no undelivered data, the processing proceeds to step S251 in FIG. 43.

In step S251, the Pre-Configure Link determination unit 64 acquires a usage status of Pre-Configure Links.

In step S252, the Pre-Configure Link determination unit 64 determines whether or not there is an available link on the basis of the received field strength, noise level, and the like of the Pre-Configure Link at the present time. In a case where it is determined in step S252 that there is an available link, the processing proceeds to step S253.

In step S253, the Single Radio control unit 56 selects a link that operates as Quick Reserve Single Radio.

In step S254, the Single Radio control unit 56 determines whether or not to perform notification by using Block ACK (BA). In a case where it is determined in step S254 that the notification is performed by using the BA, the processing proceeds to step S255.

In step S255, the data construction unit 22 adds Quick Reserve Single Radio Link information to the BA. Thereafter, the processing returns to step S247 in FIG. 42, and the subsequent processing is repeated.

Also in a case where it is determined in step S252 that there is no available link, or in a case where it is determined in step S254 that the notification is not to be performed using the BA, the processing returns to step S247 in FIG. 42, and the subsequent processing is repeated.

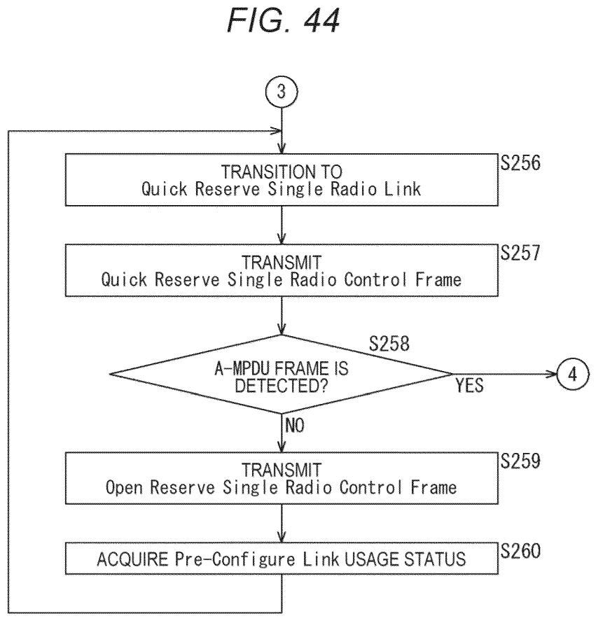

Furthermore, in a case where it is determined in step S250 that the use of the transmission path is not to be ended, the processing proceeds to step S256 in FIG. 44.

In step S256, the Single Radio control unit 56 transitions to a link set as Quick Reserve Single Radio Link.

In step S257, the Single Radio control unit 56 transmits a Quick Reserve Single Radio Control Frame.

In step S258, it is determined whether or not the A-MPDU frame is detected within an arrival time of predetermined Open Duration. In a case where it is determined in step S258 that the A-MPDU frame is detected within the arrival time of the predetermined Open Duration, the processing returns to step S243 in FIG. 42, and the subsequent processing is repeated.

In a case where it is determined in step S258 that the A-MPDU frame is not detected within the arrival time of the predetermined Open Duration, the processing proceeds to step S259.

In step S259, the Single Radio control unit 56 transmits an Open Reserve Single Radio Control Frame.

In step S260, the Single Radio control unit 56 acquires the usage status of the Pre-Configure Links at that time, and selects a newly available Quick Reserve Single Radio Link. Thereafter, the processing step returns to step S256, and the subsequent processing is repeated.

### Effects of Fourth Embodiment

As described above, in the fourth embodiment of the present technology, a control frame (Quick Reserve Single Radio Control Frame) for securing a use opportunity in advance is transmitted in a link to be used next by the EMLSR STA.

As a result, it is possible to transmit and receive data before another communication device uses an available link among Pre-Configure Links.

That is, since it is possible to notify surrounding communication devices that have received the control frame (Quick Reserve Single Radio Control Frame) for securing the use opportunity in advance that the EMLSR STA uses the transmission path in advance, it is possible to secure a use opportunity for a communication device having a restriction.

Furthermore, in a case where data reception is not to be performed on a link on which the control frame (Quick Reserve Single Radio Control Frame) for securing the use opportunity in advance is transmitted, a control frame (Open Single Radio Control Frame) for opening the use opportunity is transmitted. As a result, it does not occur that another communication device is enabled to use the link, and the transmission path is unintentionally occupied.

Furthermore, the control frame (Quick Reserve Single Radio Control Frame) for securing the use opportunity includes information capable of specifying the communication device itself and information capable of specifying a transmission destination of data, and includes information on a time for securing a required use opportunity. As a result, it is possible to perform notification between communication devices of a required occupation time for the transmission path.

A Pre-configure Link to be used by the EMLSR STA is selected from information for notification of the status of the links to be used by the EMLSR STA transmitted by the A-MPDU frame or the like from the AP on the data transmission side. As a result, it is possible to select a reliable link between communication devices that transmit and receive data.

In particular, by using the delimiter of the A-MPDU frame, it is possible to select an optimum link at that time during transmission of the data frame.

Moreover, information on a link for transmitting the control frame (Quick Reserve Single Radio Control Frame) for securing the use opportunity is described in a Block ACK frame returned immediately after data reception, whereby it is possible to specify a link to which the EMLSR STA transitions.

That is, since both devices can share the information on the link to which transition is performed, it is possible to prevent the use opportunity from being acquired by another device in a time required for link transition.

Accordingly, by preferentially permitting transmission for data transmission and reception having a restriction in the EMLSR STA, it is possible to seamlessly use the transmission path at the time of multi-link operation.

### 5. Others

### Modifications

Note that, in the above description, the data transmission between the AP that performs Multi-Link Multi-Radio operation and the STA that performs EMLSR operation has been described as an example; however, the data transmission may be performed between the STA that performs Multi-Link Multi-Radio operation and the AP that performs EMLSR operation.

That is, in the above description, the example has been described in which the device on the data transmission side is the AP that performs Multi-Link Multi-Radio operation, but the device on the data transmission side may be the STA that performs Multi-Link Multi-Radio operation, and moreover, may be the AP or the STA that performs EMLSR operation.

Furthermore, in the above description, the example has been described in which the device on the data reception side is the STA that performs EMLSR operation; however, the device on the data reception side may be the AP that performs EMLSR operation, or may be the AP or the STA that performs Multi-Link Multi-Radio operation.

### <Configuration Example of Computer>

The series of processing steps described above can be executed by hardware and also can be executed by software. In a case where the series of processing steps is executed by software, a program included in the software is installed from a program recording medium on a computer incorporated in dedicated hardware, a general-purpose personal computer, or the like.

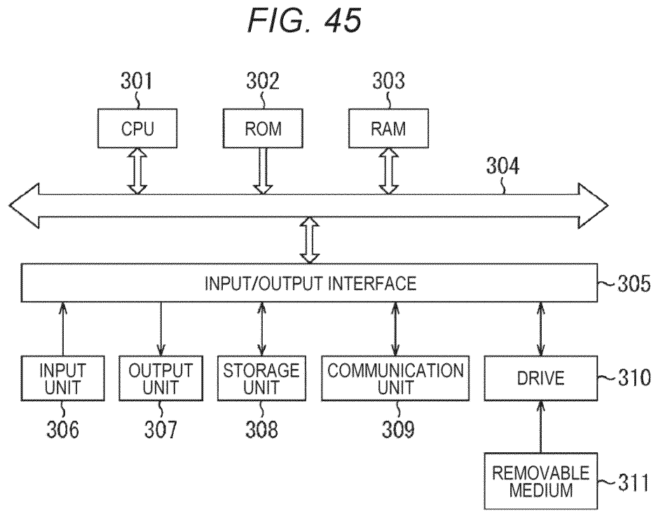

FIG. 45 is a block diagram illustrating a configuration example of hardware of a computer that executes the above-described series of processing steps by a program.

A central processing unit (CPU) 301, a read only memory (ROM) 302, and a random access memory (RAM) 303 are connected to each other by a bus 304.

An input/output interface 305 is further connected to the bus 304. To the input/output interface 305, an input unit 306 including a keyboard, a mouse, and the like, and an output unit 307 including a display, a speaker, and the like are connected. Furthermore, to the input/output interface 305, a storage unit 308 including a hard disk, a nonvolatile memory, and the like, a communication unit 309 including a network interface and the like, and a drive 310 that drives a removable medium 311 are connected.

In the computer configured as described above, the above-described series of processing steps is executed, for example, by the CPU 301 loading the program stored in the storage unit 308 into the RAM 303 via the input/output interface 305 and the bus 304 and executing the program.

The program to be executed by the CPU 301 is provided, for example, by being recorded on the removable medium 311 or via a wired or wireless transmission medium such as a local area network, the Internet, or digital broadcasting, and is installed on the storage unit 308.

Note that the program executed by the computer may be a program in which processing is performed in time series in the order described in the present specification or may be a program in which processing is performed in parallel or at required timing such as when a call is made.

### APPLICATION EXAMPLES

The present technology can be applied to various products. For example, the wireless communication device 1 in FIG. 5 may be implemented as a mobile terminal such as a smartphone, a tablet personal computer (PC), a notebook PC, a portable game terminal, or a digital camera, a fixed terminal such as a television receiver, a printer, a digital scanner, or a network storage, or an in-vehicle terminal such as a car navigation device. Furthermore, the wireless communication device 1 may be implemented as a machine to machine communication (M2M) terminal such as a smart meter, a vending machine, a remote monitoring device, or a point of sale (POS) terminal. Moreover, the wireless communication device 1 may be a wireless communication module (for example, an integrated circuit module configured with one die) mounted on these terminals.

On the other hand, for example, the wireless communication device 1 may be implemented as a wireless LAN AP (wireless base station) having a router function or not having a router function. Furthermore, the wireless communication device 1 may be implemented as a mobile wireless LAN router. Moreover, the wireless communication device 1 may be a wireless communication module (for example, an integrated circuit module configured with one die) mounted on these devices.

### <Configuration Example of Smartphone>

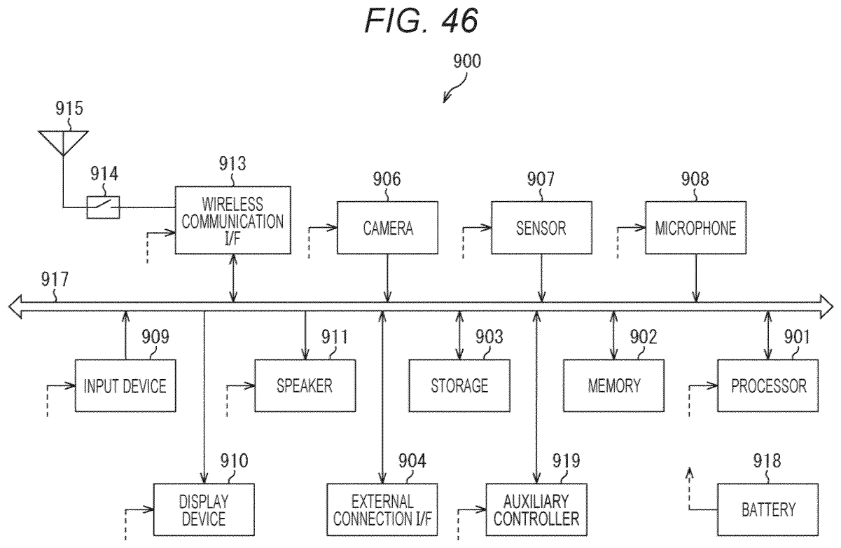

FIG. 46 is a block diagram illustrating a schematic configuration example of a smartphone to which the present technology is applied.

A smartphone 900 includes a processor 901, a memory 902, a storage 903, an external connection interface 904, a camera 906, a sensor 907, a microphone 908, an input device 909, and a display device 910. Furthermore, the smartphone 900 includes a speaker 911, a wireless communication interface 913, an antenna switch 914, an antenna 915, a bus 917, a battery 918, and an auxiliary controller 919.

The processor 901 may be, for example, a CPU or a system on chip (SoC), and restricts functions of an application layer and other layers of the smartphone 900.

The memory 902 includes a RAM and a ROM, and stores a program to be executed by the processor 901, and data.

The storage 903 includes a storage medium such as a semiconductor memory or a hard disk.

The external connection interface 904 is an interface for connecting an external device such as a memory card or a universal serial bus (USB) device to the smartphone 900.

The camera 906 includes an imaging element such as a charge coupled device (CCD) or a complementary metal oxide semiconductor (CMOS), for example, and generates a captured image.

The sensor 907 includes, for example, a sensor group including a positioning sensor, a gyro sensor, a geomagnetic sensor, and an acceleration sensor.

The microphone 908 converts audio input to the smartphone 900 into an audio signal.

The input device 909 includes, for example, a touch sensor that detects a touch on a screen of the display device 910, a keypad, a keyboard, a button, and a switch, and receives an operation by the user or information input from the user.

The display device 910 has a screen such as a liquid crystal display (LCD) or an organic light emitting diode (OLED) display, and converts the audio signal output from the smartphone 900 into audio.

The wireless communication interface 913 supports one or more of wireless LAN standards such as IEEE 802.11a, 11b, 11g, 11ac, and 11ad, and performs wireless communication.

The wireless communication interface 913 communicates with other devices via the wireless LAN AP in an infrastructure mode. Furthermore, the wireless communication interface 913 directly communicates with other devices in an ad hoc mode or a direct communication mode such as Wi-Fi Direct.

Note that, in Wi-Fi Direct, unlike the ad hoc mode, one of two terminals operates as an AP, but communication is directly performed between the terminals.

The wireless communication interface 913 typically includes a baseband processor, a radio frequency (RF) circuit, and a power amplifier. The wireless communication interface 913 may be a one-chip module in which a memory that stores a communication control program, and a processor that executes the program and related circuits are integrated.

In addition to the wireless LAN scheme, the wireless communication interface 913 may support another type of wireless communication scheme such as a short-range wireless communication scheme, a proximity wireless communication scheme, or a cellular communication scheme.

The antenna switch 914 switches a connection destination of the antenna 915 among a plurality of circuits (for example, circuits for different wireless communication schemes) included in the wireless communication interface 913.

The antenna 915 has a single or a plurality of antenna elements (for example, a plurality of the antenna elements forming a multiple input multiple output (MIMO) antenna), and is used for transmission and reception of a wireless signal by the wireless communication interface 913.

Note that the smartphone 900 is not limited to the example in FIG. 46, and may include a plurality of antennas (for example, an antenna for the wireless LAN, an antenna of the proximity wireless communication scheme, and the like). In that case, the antenna switch 914 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 913, and the auxiliary controller 919 to one another.

The battery 918 supplies power to each block of the smartphone 900 illustrated in FIG. 46 through a feed line partially indicated by a broken line in the drawing. The auxiliary controller 919 causes operation of minimum necessary functions of the smartphone 900, for example, in a sleep mode.

In the smartphone 900 illustrated in FIG. 46, the wireless communication module 15 described above with reference to FIG. 6 or 7 may be implemented in the wireless communication interface 913. Furthermore, at least some of these functions may be implemented in the processor 901 or the auxiliary controller 919.

Note that the processor 901 executes an AP function at an application level, whereby the smartphone 900 may operate as a wireless AP (software AP). Furthermore, the wireless communication interface 913 may have the wireless AP function.

Moreover, the smartphone 900 may include a biometric authentication unit (fingerprint authentication, palm-shape authentication, voice authentication, blood vessel authentication, face authentication, iris authentication, and retina authentication). At that time, the wireless communication interface 913 in which the wireless communication module 15 described above with reference to FIG. 6 or 7 is implemented is configured to receive power supply from the same battery 918 as that for at least one of the display device 910, the speaker 911, or the biometric authentication unit.

Furthermore, in the smartphone 900, information is displayed from at least one of the display device 910 or the speaker 911 on the basis of communication with an external device through the wireless communication interface 913. At that time, a result of synchronization according to the present technology may be output as information from at least one of the display device 910 or the speaker 911.

<Configuration Example of in-Vehicle Device>

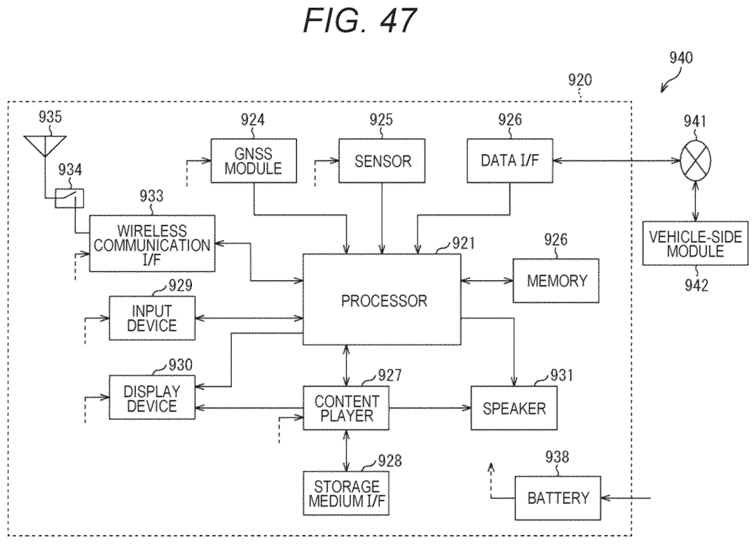

FIG. 47 is a block diagram illustrating a schematic configuration example of an in-vehicle device 920 to which the present technology is applied.

The in-vehicle device 920 includes a processor 921, a memory 922, a global navigation satellite system (GNSS) module 924, a sensor 925, a data interface 926, a content player 927, and a storage medium interface 928. Furthermore, the in-vehicle device 920 includes an input device 929, a display device 930, a speaker 931, a wireless communication interface 933, an antenna switch 934, an antenna 935, and a battery 938.

The processor 921 may be, for example, a CPU or an Soc, and controls a navigation function and other functions of the in-vehicle device 920. Furthermore, the processor 921 can also control a drive system of a vehicle, such as a brake, an accelerator, or a steering, on the basis of information obtained through communication based on the present technology.

The memory 922 includes a RAM and a ROM, and stores a program to be executed by the processor 921, and data.

The GNSS module 924 uses a GNSS signal received from a GNSS satellite to measure a location (for example, latitude, longitude, and altitude) of the in-vehicle device 920.

The sensor 925 includes, for example, a sensor group including a gyro sensor, a geomagnetic sensor, and an air pressure sensor.

The data interface 926 is connected to an in-vehicle network 941 via, for example, a terminal (not illustrated), and acquires data generated on the vehicle side, such as in-vehicle data.

The content player 927 reproduces contents stored in a storage medium (for example, a CD or a DVD) inserted into the storage medium interface 928.

The input device 929 includes, for example, a touch sensor that detects a touch on a screen of the display device 930, a button, a switch, or the like, and receives an operation by the user or information input from the user.

The display device 930 has a screen such as an LCD or an OLED display, and displays an image of a navigation function or contents to be reproduced.

The speaker 931 outputs sound of the navigation function or contents to be reproduced.

Note that, in the in-vehicle device 920, the navigation function and the function of the content player 927 are optional. The navigation function and the content player 927 may be removed from the configuration of the in-vehicle device 920.

The wireless communication interface 933 supports one or more of the wireless LAN standards such as IEEE 802.11a, 11b, 11g, 11n, 11ac, and 11ad, and performs wireless communication. The wireless communication interface 933 communicates with other devices via the wireless LAN AP in the infrastructure mode. Furthermore, the wireless communication interface 933 directly communicates with other devices in the ad hoc mode or the direct communication mode such as Wi-Fi Direct.

The wireless communication interface 933 typically includes a baseband processor, a RF circuit, and a power amplifier. The wireless communication interface 933 may be a one-chip module in which a memory that stores a communication control program, and a processor that executes the program or related circuits are integrated. In addition to the wireless LAN scheme, the wireless communication interface 933 may support another type of wireless communication scheme such as a short-range wireless communication scheme, a proximity wireless communication scheme, or a cellular communication scheme.

The antenna switch 934 switches a connection destination of the antenna 935 among a plurality of circuits included in the wireless communication interface 933.

The antenna 935 has a single or a plurality of antenna elements, and is used for transmission and reception of a wireless signal through the wireless communication interface 933.

Note that the in-vehicle device 920 is not limited to the example in FIG. 47, and may include a plurality of the antennas 935. In that case, the antenna switch 934 may be omitted from the configuration of the in-vehicle device 920.

The battery 938 may be implemented in the in-vehicle device 920 illustrated in FIG. 47 via a feed line partially indicated by a broken line in the drawing, and the wireless communication module 15 described above with reference to FIG. 6 or 7 may be implemented in the wireless communication interface 933. Furthermore, at least some of these functions may be implemented in the processor 921.

Furthermore, the wireless communication interface 933 may operate as the wireless communication device 1 described above and provide wireless connection to a terminal possessed by a user in the vehicle.

Furthermore, the present technology may be implemented as an in-vehicle system (or vehicle) 940 including one or more blocks of the in-vehicle device 920 described above, the in-vehicle network 941, and a vehicle-side module 942. The vehicle-side module 942 generates vehicle-side data such as a vehicle speed, an engine speed, or failure information, and outputs the generated data to the in-vehicle network 941.

### <Configuration Example of Wireless AP>

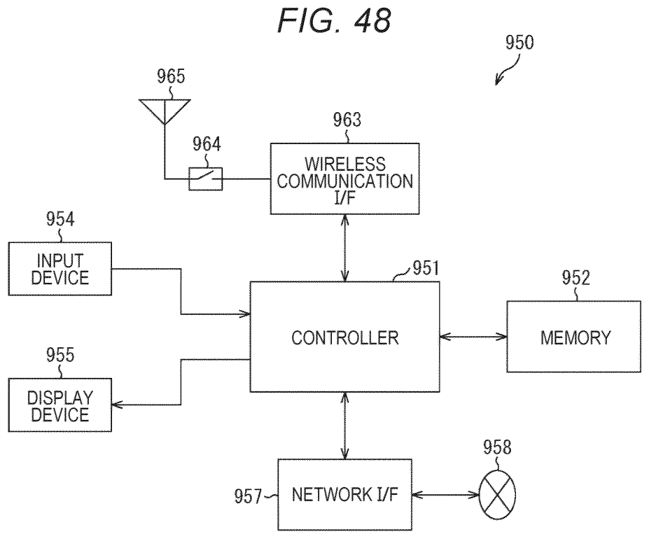

FIG. 48 is a block diagram illustrating a schematic configuration example of a wireless AP 950 to which the present technology is applied.

The wireless AP 950 includes a controller 951, a memory 952, an input device 954, a display device 955, a network interface 957, a wireless communication interface 963, an antenna switch 964, and an antenna 965.

The controller 951 may be, for example, a CPU or a digital signal processor (DSP), and operates various functions (for example, access restriction, routing, encryption, firewall, log management, and the like) of the Internet protocol (IP) layer and higher layer of the wireless AP 950.

The memory 952 includes a RAM and a ROM, and stores a program to be executed by the controller 951 and various control data (for example, a terminal list, a routing table, an encryption key, a security setting, a log, and the like).

The input device 954 includes, for example, a button and a switch, and receives an operation from the user.

The display device 955 includes an LED lamp and the like, and displays an operation status of the wireless AP 950.

The network interface 957 is a wired communication interface for connecting the wireless AP 950 to a wired communication network 958. The network interface 957 may have a plurality of connection terminals. The wired communication network 958 may be a LAN such as Ethernet (registered trademark), or may be a wide area network (WAN).

The wireless communication interface 963 supports one or more of the wireless LAN standards such as IEEE 802.11a, 11b, 11g, 11n, 11ac, and 11ad, and provides wireless connection as an AP to a nearby terminal.

The wireless communication interface 963 typically includes a baseband processor, a RF circuit, and a power amplifier.

The wireless communication interface 963 may be a one-chip module in which a memory that stores a communication control program, and a processor that executes the program or related circuits are integrated.

The antenna switch 964 switches a connection destination of the antenna 965 among a plurality of circuits included in the wireless communication interface 963, and the antenna 965 has a single or a plurality of antenna elements and is used for transmission and reception of a wireless signal through the wireless communication interface 963.

In the wireless AP 950 illustrated in FIG. 48, the wireless communication module 15 described above with reference to FIG. 6 or 7 may also be implemented in the wireless communication interface 963. Furthermore, at least some of these functions may be implemented in the controller 951.

Note that, the above-described embodiments describe an example for embodying the present technology, and there is a correspondence relationship between the matters in the embodiments and the matters specifying the invention in claims. Similarly, there is a correspondence relationship between the matters specifying the invention in claims and the matters in the embodiments of the present technology having the same names. However, the present technology is not limited to the embodiments, and can be embodied by applying various modifications to the embodiments without departing from the scope of the present technology.

Furthermore, the procedures described in the above-described embodiment may be considered as a method including a series of procedures and may be considered as a program for causing this computer to execute the series of procedures and a recording medium that stores the program.

As this recording medium, for example, a compact disc (CD), a MiniDisc (MD), a digital versatile disc (DVD), a memory card, a Blu-ray (registered trademark) Disc, and the like can be used.

Note that, in the present specification, a system means an assembly of a plurality of components (devices, modules (parts), and the like), and it does not matter whether or not all the components are located in the same housing. Thus, a plurality of devices housed in separate housings and connected to each other via a network and one device in which a plurality of modules is housed in one housing are both systems.

Furthermore, the effects described in the present specification are merely examples and not restrictive, and there may also be other effects.

An embodiment of the present technology is not limited to the embodiments described above, and various modifications can be made without departing from the scope of the present technology.

For example, the present technology may be configured as cloud computing in which one function is shared by a plurality of devices via a network and processed in cooperation.

Furthermore, each step described in the flowcharts described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

### <Example of Configuration Combination>

The present technology can also have the following configurations.

(1)

A wireless communication control device including
a communication control unit that performs control of receiving first information from a wireless communication device via one of a plurality of links set in advance with the wireless communication device and transmitting use reservation information indicating that a use opportunity for at least one of the plurality of links is to be secured in advance.
   (2)

The wireless communication control device according to (1), in which
the communication control unit performs control of transmitting the use reservation information by using a link for which it is indicated by the use reservation information that a use opportunity is to be secured in advance.
   (3)

The wireless communication control device according to (1) or (2), in which
the use reservation information includes valid period information indicating a valid period of the use opportunity secured.
   (4)

The wireless communication control device according to any of (1) to (3), in which
the use reservation information includes information regarding a device that transmits a frame including the use reservation information and information regarding a device that receives a frame including the use reservation information.
   (5)

The wireless communication control device according to any of (1) to (4), in which
the use reservation information includes information regarding a device that performs transmission using a link for which a use opportunity is secured and information regarding a device that performs reception using a link for which a use opportunity is secured.
   (6)

The wireless communication control device according to (3), in which
the communication control unit performs control of transmitting use cancellation information indicating that a use opportunity is to be canceled.
   (7)

The wireless communication control device according to (6), in which
the communication control unit generates the use cancellation information on the basis of a fact that transmission is not performed within a period indicated by the valid period information.
   (8)

The wireless communication control device according to (6), in which
after transmitting the use cancellation information, the communication control unit performs control of transmitting the use reservation information for an available link different from a link whose use opportunity is canceled by the use cancellation information among the plurality of links.
   (9)

The wireless communication control device according to any of (1) to (8), further including
a link usage status detection unit that detects a usage status of the plurality of links, in which
the communication control unit specifies a link for which it is indicated by the use reservation information that a use opportunity is to be secured, on the basis of the usage status of the plurality of links detected.
   (10)

The wireless communication control device according to (9), in which
in a case where available link information indicating available links for the wireless communication device is included in a frame received from the wireless communication device, the communication control unit specifies a link for which it is indicated by the use reservation information that a use opportunity is secured, on the basis of the usage status of the plurality of links detected and the available link information for the wireless communication device.
   (11)

The wireless communication control device according to (10), in which
a frame received from the wireless communication device includes a first MAC protocol data unit (MPDU) and a second MPDU received after the first MPDU, and
the available link information for the wireless communication device is received between the first MPDU and the second MPDU.
   (12)

The wireless communication control device according to (11), in which
the second MPDU is an MPDU received last among frames received from the wireless communication device.
   (13)

The wireless communication control device according to any of (1) to (12), further including
a communication unit that sets a link for which it is indicated by the use reservation information that a use opportunity is to be secured, as a link to be used for transmission or reception of a frame.
   (14)

The wireless communication control device according to any of (1) to (13), in which
the communication control unit performs control of including the use reservation information in a reception confirmation response frame corresponding to a data frame as the first information received from the wireless communication device and transmitting the reception confirmation response frame.
   (15)

The wireless communication control device according to any of (1) to (14), in which
the communication control unit transmits information regarding a transmission capability for the use reservation information prior to transmission of the use reservation information.
   (16)

The wireless communication control device according to any of (1) to (15), in which
the wireless communication control device is a device that performs an operation compatible with Extended Multi-Link Single Radio (EMLSR).
   (17)

A wireless communication control method including
performing, by a wireless communication control device,
control of receiving first information from a wireless communication device via one of a plurality of links set in advance with the wireless communication device and transmitting use reservation information indicating that a use opportunity for at least one of the plurality of links is to be secured in advance.
   (18)

A program causing a compute to function as
a communication control unit that performs control of receiving first information from a wireless communication device via one of a plurality of links set in advance with the wireless communication device and transmitting use reservation information indicating that a use opportunity for at least one of the plurality of links is to be secured in advance.
   (19)

A wireless communication control device including
a communication control unit that performs control of transmitting first information to a wireless communication device via one of a plurality of links set in advance with the wireless communication device and receiving use reservation information indicating that a use opportunity for at least one of the plurality of links is to be secured in advance.

### REFERENCE SIGNS LIST

1 Wireless communication device
11 Internet connection module
12 Information input module
13 Device control module
14 Information output module
15 Wireless communication module
21 Data Buffer
22 Data construction unit
23 Multi-Link control unit
24 Multi-Link MAC processing unit
25 Multi-Link PHY processing unit
26 Multi-Link RF signal processing unit
27 Multi-Link RF detection unit
28 Multi-Link PHY reception unit
29 Multi-Link MAC determination unit
30 Data processing unit
31 Pre-Configure Link determination unit
51 Data Buffer
52 Single Radio data processing unit
53 Single Radio MAC processing unit
54 Single Radio PHY signal processing unit
55 Single Radio RF signal processing unit
56 Single Radio control unit
57 Single Radio MAC determination unit
58 Single Radio PHY reception unit
59 Single Radio RF detection unit

1. A wireless communication control device comprising
a communication control unit that performs control of receiving first information from a wireless communication device via one of a plurality of links set in advance with the wireless communication device and transmitting use reservation information indicating that a use opportunity for at least one of the plurality of links is to be secured in advance.

2. The wireless communication control device according to claim 1, wherein
the communication control unit performs control of transmitting the use reservation information by using a link for which it is indicated by the use reservation information that a use opportunity is to be secured in advance.

3. The wireless communication control device according to claim 1, wherein
the use reservation information includes valid period information indicating a valid period of a use opportunity secured.

4. The wireless communication control device according to claim 3, wherein
the use reservation information includes information regarding a device that transmits the use reservation information and information regarding a device that receives the use reservation information.

5. The wireless communication control device according to claim 3, wherein
the use reservation information includes information regarding a device that performs transmission using a link for which a use opportunity is secured and information regarding a device that performs reception using a link for which a use opportunity is secured.

6. The wireless communication control device according to claim 3, wherein
the communication control unit performs control of transmitting use cancellation information indicating that a use opportunity is to be canceled.

7. The wireless communication control device according to claim 6, wherein
the communication control unit generates the use cancellation information on a basis of a fact that transmission is not performed within a period indicated by the valid period information.

8. The wireless communication control device according to claim 6, wherein
after transmitting the use cancellation information, the communication control unit performs control of transmitting the use reservation information for an available link different from a link whose use opportunity is canceled by the use cancellation information among the plurality of links.

9. The wireless communication control device according to claim 1, further comprising
a link usage status detection unit that detects a usage status of the plurality of links, wherein
the communication control unit specifies a link for which it is indicated by the use reservation information that a use opportunity is to be secured, on a basis of the usage status of the plurality of links detected.

10. The wireless communication control device according to claim 9, wherein
in a case where available link information indicating available links for the wireless communication device is included in a frame received from the wireless communication device, the communication control unit specifies a link for which it is indicated by the use reservation information that a use opportunity is secured, on a basis of the usage status of the plurality of links detected and the available link information for the wireless communication device.

11. The wireless communication control device according to claim 10, wherein
a frame received from the wireless communication device includes a first MAC protocol data unit (MPDU) and a second MPDU received after the first MPDU, and
the available link information for the wireless communication device is received between the first MPDU and the second MPDU.

12. The wireless communication control device according to claim 11, wherein
the second MPDU is an MPDU received last among frames received from the wireless communication device.

13. The wireless communication control device according to claim 1, further comprising
a communication unit that sets a link for which it is indicated by the use reservation information that a use opportunity is to be secured, as a link to be used for transmission or reception of a frame.

14. The wireless communication control device according to claim 1, wherein
the communication control unit performs control of including the use reservation information in a reception confirmation response frame corresponding to a data frame as the first information received from the wireless communication device and transmitting the reception confirmation response frame.

15. The wireless communication control device according to claim 1, wherein
the communication control unit transmits information regarding a transmission capability for the use reservation information prior to transmission of the use reservation information.

16. The wireless communication control device according to claim 1, wherein
the wireless communication control device is a device that performs an operation compatible with Extended Multi-Link Single Radio (EMLSR).

17. A wireless communication control method comprising
performing, by a wireless communication control device,
control of receiving first information from a wireless communication device via one of a plurality of links set in advance with the wireless communication device and transmitting use reservation information indicating that a use opportunity for at least one of the plurality of links is to be secured in advance.

18. A program causing a compute to function as
a communication control unit that performs control of receiving first information from a wireless communication device via one of a plurality of links set in advance with the wireless communication device and transmitting use reservation information indicating that a use opportunity for at least one of the plurality of links is to be secured in advance.

19. A wireless communication control device comprising
a communication control unit that performs control of transmitting first information to a wireless communication device via one of a plurality of links set in advance with the wireless communication device and receiving use reservation information indicating that a use opportunity for at least one of the plurality of links is to be secured in advance.
